(19) United States
(12) Patent Application Publication
(10) Pub. No.: US 2017/0017760 A1
(43) Pub. Date: Jan. 19, 2017

(54) HEALTHCARE CLAIMS FRAUD, WASTE AND ABUSE DETECTION SYSTEM USING NON-PARAMETRIC STATISTICS AND PROBABILITY BASED SCORES

(71) Applicant: Fortel Analytics LLC, Maple Grove, MN (US)

(72) Inventors: Rudolph J. Freese, Greeley, CO (US); Allen Philip Jost, Coronado, CA (US); Brian Keith Schulte, New Hope, MN (US); Walter Allan Klindworth, Maple Grove, MN (US); Stephen Thomas Parente, Wayzata, MN (US)

(73) Assignee: Fortel Analytics LLC, Maple Grove, MN (US)

(21) Appl. No.: 15/216,133

(22) Filed: Jul. 21, 2016

Related U.S. Application Data
(63) Continuation of application No. 13/074,576, filed on Mar. 29, 2011.
(60) Provisional application No. 61/327,256, filed on Apr. 23, 2010.
(60) Provisional application No. 61/319,554, filed on Mar. 31, 2010.

(51) Int. Cl. G06F 19/00; G06F 17/30; H04L 29/06

(52) U.S. Cl. CPC G06F 19/328; G06F 19/3406; H04L 63/0428; G06F 17/3053; G06F 17/3066

(57) ABSTRACT

The present invention is in the field of Healthcare Claims Fraud Detection. Fraud is perpetrated across multiple healthcare payers. There are few labeled or “tagged” historical fraud examples needed to build “supervised”, traditional fraud models using multiple regression, logistic regression or neural networks. Current technology is to build “Unsupervised Fraud Outlier Detection Models”.

Current techniques rely on parametric statistics that are based on assumptions such as outlier free and “normally distributed” data. Even some non-parametric statistics are adversely influenced by non-normality and the presence of outliers.

Current technology cannot represent the combined variable values into one meaningful value that reflects the overall risk that this observation is an outlier. The single value, the “score”, must be capable of being measured on the same scale across different segments, such as geographies and specialty groups. Lastly, the score must substantially, monotonically rank the fraud risk and give reasons to substantiate the score.

### CROSS-REFERENCE TO RELATED APPLICATIONS

This application is a continuation of application Ser. No. 13/074,576, filed Mar. 29, 2011, which claims priority to U.S. Provisional Application Nos. 61/319,554 and 61/327,256, filed Mar. 31, 2010 and Apr. 23, 2010, respectively, the entire contents of each of which are hereby incorporated by reference.

### STATEMENT REGARDING FEDERALLY SPONSORED RESEARCH

Not Applicable.

### FIELD OF THE INVENTION

The present invention is in the technical field of Healthcare Claims and Payment Fraud Prevention and Detection. More particularly, the present invention uses non-parametric statistics and probability methods to create healthcare claims fraud detection statistical outlier models.

### BACKGROUND OF THE INVENTION

The present invention is in the technical field of Healthcare Claims and Payment Fraud Prevention and Detection. More particularly, the present invention is in the technical field of Healthcare Claims and Payment Fraud Prevention and Detection where it pertains to claims and payments reviewed by government agencies, such as Medicare, Medicaid and TRICARE, as well as private commercial enterprises such as Private Insurance Companies, Third Party Administrators, Medical Claims Data Processors, Electronic Clearinghouses, Claims Integrity organizations that utilize edits or rules and Electronic Payment entities to process and pay claims to healthcare providers. More particularly, this invention pertains to identifying healthcare fraud, abuse, waste/over-utilization by providers, patients or beneficiaries, healthcare merchants or collusion of any combination of each fore-mentioned, in the following healthcare fields (segments):
1. Hospital
2. Inpatient Facilities
3. Outpatient Institutions
4. Physician
5. Pharmaceutical
6. Skilled Nursing Facilities
7. Hospice
8. Home Health
9. Durable Medical Equipment
10. Laboratories

Healthcare providers are here defined as those individuals, companies or organizations that provide healthcare services in the areas listed in 1-10 above.

In particular, the present invention includes the detection of patient or beneficiary related fraud, as well as provider fraud as a part of healthcare claims fraud and abuse prevention and detection in the above referenced healthcare segments and markets. More particularly, the present invention uses non-parametric statistics and conditional probability methods to create the healthcare claims fraud detection statistical outlier models.

Annual healthcare expenditures in 2009 are expected to exceed 2.5 trillion dollars. (Kaiser Family foundation, Trends in Healthcare Costs and Spending March 2009, Publication (#7692-02) on the Kaiser Family Foundation's website at www.kff.org). No accurate statistics are available to show how much of that spend is fraud, abuse or waste/over-utilization. However, Harvard's Malcolm Sparrow, a specialist in healthcare fraud, estimates that up to 20 percent of federal health program budgets are consumed by improper payments. See also, Carrie Johnson, “Medical Fraud a Growing Problem,” Washington Post, Jun. 13, 2008, p. A1. This means that of the nearly $1 trillion per year spend in Medicare and Medicaid, there could be up to $200 billion a year in fraud. (Malcolm Sparrow, “Criminal Prosecution as a Deterrent to Healthcare Fraud,” Testimony to the Senate Committee on the Judiciary, Subcommittee on Crime and Drugs, May 20, 2009). One indication that there are no sophisticated fraud risk management systems in place is that the fraud that is reported is typically only that which is caught. If there were appropriate risk management systems being used to detect and prevent fraud, projections of fraud rates could be made for all ranges of score categories for all healthcare transactions. Those probabilities could then be multiplied by the healthcare spending in those categories to create reliable fraud estimates. Most healthcare fraud schemes attack multiple payers such as Medicare, Medicaid and private insurance, and multiple industry segments in both government and private insurance markets. Types of fraud schemes include: Unbundling, up-coding, creating false clinics or phantom providers and billing for services not provided, or billing for services to identities that are stolen, falsifying medical records to obtain payment from the payer, and collusion with patients to obtain fees for services not provided. Often, fraud begets fraud in healthcare. Because undetected fraud is so rampant and easy to perpetrate and the loses are so significant, payers are compelled to reduce expenses and therefore reduce payments across the board to all providers, which then compels some providers, even generally honest ones, to submit exaggerated billing claims in order to keep their revenue from declining. Both the government and commercial insurance industry rely on manual review of claims and investigation units, which are often understaffed, lack the proper resources to identify false claims among the hundreds of thousands submitted per month. In fact, most insurance claims review is completed manually or using written policies or static decision rules. This means that many payers perform detailed fraud reviews for less than 1% of all of their claims. Most payers use rules, which are published and therefore well known to fraud perpetrators or out of date or cause thousands of claims to be reviewed with high false-positive rates or include only a few claims with low fraud detection rate (False-positives are here defined as those claims that are selected for fraud review or thought to be possible frauds but, after review, are determined not to be fraud. False-negatives are here defined as truly fraudulent providers, claims or beneficiaries that are not detected or labeled as fraudulent. Fraud detection rate is here defined as the ratio of fraudulent (including abuse) transactions, claims, providers or beneficiaries, to the total number of transactions, claims, providers or beneficiaries in the population. Detection rate is here defined as the number of frauds found divided by the total number of observations analyzed, expressed as a percent).

Fraud is often perpetrated across multiple healthcare payers. Seldom do perpetrators target only one insurer or just the public or private sector exclusively. Because no one payer in the review process has a comprehensive view of all the claims submitted by an individual provider, most violators are found to be simultaneously defrauding public sector payers, such as Medicare or Medicaid, and private insurance companies at the same time. Currently, there is no clearinghouse or centralized organization that processes all healthcare claims that would include, among other processing services, a statistically valid or demonstratively sound fraud detection or prevention system to be applied for claim payers to process and analyze all claims transactions and identify payments for fraud or abuse risk.

Clearly, there is a need in the healthcare industry to take a systematic statistical risk-management scoring based approach to prevent fraud, much as the financial industry did 20 years ago. The staggering loss of money in healthcare is not the only clue to the fact that there is an enormous amount of fraud, abuse and waste/over-utilization. The simple fact is that since no one knows, or can even accurately estimate, the amount of healthcare fraud, abuse and waste/over-utilization indicates that there are no sophisticated risk management controls in place. The credit card industry has effectively reduced transaction fraud through the use of statistical fraud detection scoring models. Companies in the credit card industry can quantify their fraud loses to the nearest one-one hundredth of one percent. Although the healthcare industry has many structural impediments to imitating how the credit card industry lowered fraud loses, such as standardized data file formats, electronic data capture and a central transaction data processing clearinghouse, it can dramatically reduce the amount of fraud by implementing proven statistical risk management technology used in the financial industry. Scoring models have been used in the financial industry since the 1950's when retailers, such as Sears, Wards and Penney's, used them to evaluate credit risk for potential new credit card customers. Then in the early 1990's, the credit card industry pioneered the use of fraud scoring models to detect credit card fraud on individual credit card transactions. These credit and fraud scoring models were built using parametric techniques such as Multiple Regression (MR) or some common form of Multiple Regression such as Logistic Regression or Neural Networks.

In statistics, Multiple Regression refers to any approach to modeling the relationship between one variable, denoted as the dependent variable or outcome variable, and one or more other variables, denoted as independent variables or predictor variables or score variables, such that the model calculates estimates of unknown “population” parameters, or weights, that are determined from a sample of the data (These types of models that have a dependent variable are sometimes also referred to as “supervised” models because the dependent variable acts as a “supervisor” in determining the good or bad outcome, for example, as opposed to models that do not have a dependent variable, which are referred to as “unsupervised” models). Variable is here defined as a symbol that stands for a value that may vary. This term usually occurs as the opposite to constant, which is a symbol for a non-varying value, that is, a value that is fixed and does not change. In Table 1 below, “Name”, “Weight”, “Height”, “Age” and “Gender” are variables because their value changes with each separate individual, or row, in Table 1. Each separate individual, or row, in Table 1 is defined as a single “Observation”.

TABLE 1
Variables and Observations

| | |
|---|---|
| 2010 Class | Variables |

| Observations | Name | Weight | Height | Age | Gender |
|---|---|---|---|---|---|
| 1 | Bob | 126 | 68 | 12 | Male |
| 2 | Jim | 100 | 64 | 11 | Male |
| 3 | Neal | 115 | 66 | 13 | Male |
| 4 | Jenny | 105 | 63 | 12 | Female |
| 5 | Gail | 94 | 62 | 11 | Female |

For the Multiple Regression model the mathematical formula takes the form:

Yᵢ=β₁x₁+Bᵢxᵢ+εᵢ

where Yᵢ is the dependent variable, xᵢ are the independent variables and βᵢ are the parameters, or weights to be estimated. If, for example in Table 1 above, we want to build a multiple regression model to predict Age using Height and Weight, then Age is the “Dependent” Variable and Height and Weight are the independent or predictor or score variables. If we want to predict Gender (Coded as “1” for “Male” and “0” for “Female”) using Weight, Height and Age, then Gender is the Dependent Variable and Height, Weight and Age are independent or predictor or score variables. Multiple Regression models are built using historical data where the outcome, or dependent variable, is known. This historical presence of the known outcome, or dependent variable, enables the mathematical formula to calculate the values for the weights, or parameters, utilizing a supervised modeling method. A Multiple Regression model can be built using the historical data contained in Table 1. This process is termed “Score Model Development”. For example, if we wanted to predict the “Gender” of new incoming applicants, we would formulate a Regression Model with “Gender” as the dependent variable, the variable that we want to be able to predict when we don't know the Gender of new applicants. (Gender can be numerically coded as “1” for “Males” and “0” for “Females”). The independent variables in the Regression Model are “Weight”, “Height” and “Age”. A Multiple Regression model built on historical data such as that in Table 1 might have the following parameter values:

TABLE 2
Score Model Parameters

| Variable | Parameter Value |
|---|---|
| Constant | −1.970 |
| Weight | 0.005 |
| Height | 0.031 |
| Age | 0.008 |

Once the model is built and the parameters, or weights, are calculated, we can use the parameters to estimate or predict the Gender of new applicants, which is unknown, using Weight, Height and Age. This process of scoring new incoming data where the desired outcome, gender in this case, is unknown is termed “Score Model Deployment”. Therefore, the predicted Gender of a new applicant is calculated by multiplying the applicant's Weight times 0.005, their Height times 0.031 and their Age times 0.008 and then adding a constant value of −1.970. The constant is termed the intercept.

Table 3 shows the results of this calculation. Gender (P) is the predicted value. Because Males were coded as “1” and Females as “0”, higher predicted values indicate the applicant is more likely a Male and lower values indicate that the applicant is more likely a Female. If a “Decision Point” or “Cut-off” of 0.5 is used as the decision boundary between predicting males or females, then observations “1” and “5” will be identified as likely Males and observations “2”, “3” and “4” will be identified as likely Females.

TABLE 3
2011 New Applicants to be Scored
(Name and Gender Unknown)

| 2011 | | | | | |
|---|---|---|---|---|---|
| Applicants | Variables | | | | |
| Observations | Name | Weight | Height | Age | Gender (P) |
| 1 | Barry | 122 | 67 | 11 | 0.838 |
| 2 | James | 97 | 60 | 12 | 0.498 |
| 3 | Neal | 88 | 61 | 11 | 0.473 |
| 4 | Jen | 94 | 60 | 12 | 0.482 |
| 5 | Gale | 136 | 68 | 12 | 0.951 |

Financial industry fraud regression models are parametric supervised models, because they are built in a similar manner to the example explained above. The historical outcome, or dependent variable, is Fraud (Most often coded as “1”) and Not Fraud (alternately coded as “0”). The predictor or independent variables in credit card fraud models are information such as Number of Charges in the Last Hour, Number of Charges in Last Day at Risky Merchants, Amount of Last Charge, Merchant Type (Electronics, Jewelry, etc.) or Purchase Type (Cash, Merchandise).

One of the impediments to building traditional statistical fraud scoring models in healthcare is the fact that the industry payers have not detected and labeled, or “tagged”, actual frauds and saved this information from historical claim records on a consistent, universal, statistically sufficient basis in numbers large enough to create statistically valid samples of actual fraud outcomes in order to build “supervised” parametric or regression-type fraud models using Multiple Regression, Logistic Regression or Neural Network methodology. Any labeled, or tagged fraud claims that do exist are generally from a small, and most likely, statistically biased sample. Therefore traditional Multiple Regression models, and their variants such as Logistic Regression or Neural Networks, cannot currently be built to detect Healthcare Fraud.

Current technology used to build Healthcare Fraud Detection Models, until a more stable sample of actual fraud examples is obtained, is unsupervised “Fraud Detection Outlier Models”. An outlier is commonly defined as a data value that is so unusual, extreme or out of range compared to most other data values in a data sample that it is considered not likely to happen by chance or it is a data recording error. For example, an observation is rarely more than three standard deviations away from the mean in a sampled data set. The average, or mean, of a data set is a measure of the central tendency meant to typify or be a representative value from a list of numbers. The arithmetic mean for a given set of “n” numbers, each number denoted by Aᵢ, where i=1, . . . , n observations, is calculated by summing the Aᵢ's and dividing by n observations. The standard deviation of a data set is a measure of the variability, or dispersion, in the data. It is the square root of data set's variance. Standard deviation is expressed in the same units as the data and is therefore, sometimes used to “normalize” statistical measures. For example, standard deviation is used in calculating “Z-Scores” to determine a value's “normalized” distance from the average in a data set. (Z-Score, or “Standard Score”, is here defined as a dimensionless measure that indicates how far a data point, or observation value such as Age, Income, Height or Weight, for example, is above or below the mean, or average value. A Z-Score is derived by subtracting the average value, such as average Age, from the raw data, or individual observation's value and dividing that difference by the standard deviation. In Table 1 above, for example, if the overall average age is 11 years and the standard deviation is 2 years, then a child who is 9 years old has a calculated Z-Score of −1.0 ((9−11)/2). Similarly, a child who is 18 years old has a calculated Z-Score of +3.5, a very rare Z-Score value). Standard deviation is also often used in calculations to measure confidence in statistical conclusions.

Typically, in statistics, an observation is considered to be an outlier, or anomaly, in a “normally distributed” distribution of data if it is greater than plus or minus 3 standard deviations from the mean because there are so few observations that are that far beyond the mean. In fact, in normally distributed data, 99.7% of the observations are within a distance of plus or minus 3 standard deviations from the mean (Hamburg—Statistical Analysis for Decision Making, Second Edition, Morris Hamburg, Harcourt Brace Jovanovich, Inc., New York, 1977). Therefore, it is reasonable to conclude that if some of the data values used as variables in a fraud detection model are greater than 3 standard deviations from the mean, they are likely to be “outliers”.

Outliers can be caused by either measurement error, data input or coding error or they can simply be extreme legitimate values in the data. If the outlier values are legitimate, then it is highly likely that the outlier reflects abnormal or unusual patterns of behavior. For example, a sample of the ages of college students that contains an age value of 205 years old is most likely a data entry error. However, if a sampling of individuals who live in Omaha, Nebraska is done in order to calculate the average net worth of people in Omaha and if the sample includes Warren Buffett's $40 billion net worth, Mr. Buffett would be a legitimate outlier, but abnormal. Similarly, a healthcare provider who submits claims for 500 office visits in one day in order to get paid is an outlier and likely a data entry error or an example of fraudulent behavior.

Outliers can be complex when considering more than just one variable. For example, the data consisting of people's net worth in Omaha can be segmented and analyzed by age and net worth to find outliers by different age groups. Or, the net worth analysis can be expanded to include the entire country. Then segments such as State, Age and Net Worth can detect outliers. Fraud outlier detection models often include many segments and many potential score variables used to detect outliers that reflect numerous types of unusual or abnormal behavior patterns.

### DESCRIPTION OF THE PRIOR ART

Prior art consists of two general categories of statistical techniques that attempt to deal with the presence of outliers. One general category, which includes commonly known methods and classes of robust statistics such as Median Absolute Deviation (MAD), Qn-Estimator of Scale, M-Estimators (Maximum Likelihood Estimators), Winsorising, Trimmed Estimators, Bootstrap Sampling and Jackknifing, attempt to “eliminate” the negative influence of outliers on the distribution parameters, but they are not designed to detect and identify the outliers themselves which are indicative of fraud or abuse. These techniques are therefore not relevant to the present invention. The second general category of statistical techniques is an adaptation of existing procedures to actually detect and identify the presence of outliers. In addition to being outlier detection methods, this second group of techniques is also considered to be “unsupervised” score modeling techniques because there is no dependent variable that is used to “guide” the mathematical algorithm formulation as there is in Multiple Regression, for example. The second group of outlier detection techniques includes Cluster Analysis or Distance and the Quartile Method. A brief description of each follows:

### 1. Cluster Analysis, or Distance Measures (Including Radial Basis Functions).

Cluster analysis, or Clustering, is the assignment of a set of observations into subsets (called clusters) so that observations in the same cluster are similar on the characteristic values, or variable values, in the data. These homogeneous groups might be, for example, people who have similar ages, heights and weights. When used as an outlier detection technique, in clustering a data file, any observation in the data, which does not “belong” to any cluster, is considered to be an outlier.

### 2. Principal Component Analysis (PCA).

PCA is a statistical process that transforms a number of correlated variables into a smaller number of less correlated or uncorrelated variables, sometimes referred to as vectors, called Principal Components. The first principal component accounts for as much of the variability in the data as possible, and each succeeding component accounts for as much of the remaining variability as possible. PCA involves the calculation of the Eigen value decomposition of a data covariance matrix, usually after mean centering the data for each attribute (Harry Harman “Modern Factor Analysis” third edition, University of Chicago Press, Chicago, 1976). When used as an outlier detection technique, PCA transforms the variables in the healthcare data set using a large number of observations into a smaller number of “Principal Components” via the Eigen value decomposition of the covariance matrix. Then the “mathematical reverse” of the Eigen value decomposition is used for each individual observation in a new data file, one that is being “scored” to detect fraud, in an attempt to reconstruct the original variable values for that individual observation. If the reconstructed variable values are close to the original variable values for an individual observation, it is not deemed to be an outlier. However, if the reconstructed variable values are very different from the original variable values for an individual observation, that observation is considered to be an outlier. Other correlation analysis techniques are well known in the art and can also be used to reduce the number of variables in the models.

### 3. Standard Normal Deviates (Deviation) or Z-Scores.

A Standard Normal Deviate, or Z-Score, indicates how many standard deviations an observation is away from the mean value in a data set. The standard deviation is the unit of measurement of the Z-Score. The Z-Score is a dimensionless quantity derived by subtracting the population mean from an individual raw variable value and then dividing this difference by the standard deviation. This conversion process is called standardizing or normalizing. It allows comparison of observations from normal distributions with different measures or metrics, such as age, income, height and weight. For example, if someone is 20 pounds overweight for a particular age, and their Z-Score is calculated to be +1.2, it means that they are 1.2 standard units above the mean weight for people their age. If that same person is 4 inches shorter than average for their age, and their Z-Score is calculated to be −2.1, it means that they are 2.1 standard units below the mean height for their age. Now, that person can be compared for two different measures, pounds and inches, even though the units of measurement are different. When used as an outlier detection technique, the Z-Score is calculated for each variable in a fraud model for each individual observation. If the calculated Z-Score is greater than some commonly accepted value, such as “3.0”, then that variable for that individual observation is considered to be an outlier. Generally in fraud detection outlier models, all variables are “converted” to indicate that values on the High-Side of the data distribution are “bad” (Converted is here defined as the act of changing or modifying a mathematical expression into another expression using a mathematical formula. In this case, variable values are converted so that a “high” value is always bad, or likely to be a fraud, and a low value is not likely to be a fraud. Some variables do not need to be converted). For example, number of patient visits per day or number of dollars billed per patient is kept in their normal measurement because fraud and abuse behavior patterns are exhibited by high values of these variables. A high number of patient visits per day or a high number of dollars billed per patient indicate a higher degree of fraud risk than low values of these numbers. However, a variable, such as the probability of a procedure given a diagnosis must be converted. A procedure performed that has a high probability of accompanying a diagnosis is a “good” or “low fraud probability” occurrence. Rather than using the probability that a procedure is used given a diagnosis, (p[P|D]), most fraud detection outlier scoring systems will use the compliment of the probability of the procedure given the diagnosis, which is the probability the procedure will not be used given the diagnosis (p[P|D]). In this way, the high probability value is consistent with all other measures of risk in the fraud model, where a high value means high risk. This means that the “inconsistent” state is a high probability value for claims containing one or more outliers. In order to have a high value represent a high fraud risk, the probability of a procedure given a diagnosis, (p[P|D]), is converted subtracting the original probability from one (1), (1−(p[P|D]), which is (p[P|D]). As a result, “the probability that the procedure does not go with the diagnosis” is the value used to represent this variable in a healthcare fraud outlier score model. A high value of this converted calculation is a “bad” or “high fraud risk”. Therefore, only “High-Side” Z-Scores, for example, are considered to be risky from a fraud standpoint. If one or more variables for any individual observation are greater than the threshold value, “3.0” in this example, then the observation is considered to be a fraud risk. Both the mean and the standard deviation used in the calculation of Z-Scores include all observations in a data distribution, regardless of the shape, skewness or abnormality of the distribution. Additionally, the mean and standard deviation calculations include any outliers that exist in the data. Both abnormal distributions and outliers adversely affect the value of the mean and standard deviation potentially altering their values significantly.

### Quartile Method.

Although the Quartile Method is not a parametric statistical technique, unlike the previous three techniques above, it has similar deficiencies and fails to meet the needs of healthcare outlier fraud detection because it encompasses both the high and low sides of a data distribution. The Quartile Method calculation is similar to the Z-Score calculation, but it uses the Median and Inter-Quartile Range in the formula. That is, the raw data value is subtracted from the Median and the difference is divided by the Interquartile Range. In healthcare, the focus is on the high side of the distribution (Payers are concerned about provider practices that over-charge or over-service, not under-charge or under-service). The Interquartile Range, used in calculating the non-parametric Quartile Method detection process, uses the values in both the low and high side of the distribution (The Interquartile Range (IQR) is here defined as a measure of data dispersion and it is equal to the difference between the 75^{th} percentile, the third quartile, and the 25^{th} percentile, the first quartile value). A major deficiency of the IQR is that it does not recognize the possibility of “inherent” skewness that distorts both ends of the distribution. One end of the data distribution may be “high” and “bunched”, as shown on the left side of the distribution in the FIG. 2, Healthcare Skewed Distribution while the other side of the distribution is “low” and “stretched out” as shown in the same figure. Using the IQR, which includes both sides of the data distribution from the 25^{th} to the 75^{th} percentiles, includes these very different shapes and distorts the calculations when the IQR is used in normalization. Hence any IQR computations, in general, provide more false positives with skewed and bimodal data because they include the skewness and distorted shapes of both sides of the distribution. Any non-parametric technique used to detect “high side” healthcare claims fraud, abuse or waste/over-utilization, must address the non-normal skewed and bimodal distributions for the high side of the distribution only. High side outliers are most likely to cause even non-parametric measures of dispersion, that include both sides of the data distribution, to be abnormal and therefore result in lower fraud detection rates, higher false-positive rates or higher false-negative rates.

One method to deal with non-normal distributions, in order to identify outliers, is by substituting the median, a statistic that is more robust in the presence of outliers, in place of the arithmetic mean, to better describe the “center” of a non-normal distribution. In Table 4, for example, the median remains the same when an outlier is added to the data. In an attempt to identify outliers in non-normal distributions, Tukey (John W. Tukey. “Exploratory Data Analysis”. Addison-Wesley, Reading, M A. 1977) developed the “box plot” methodology, sometimes referred to as “box and whisker plots” or the “Quartile Method” to describe variables, data distributions and to identify outliers. These techniques are similar to the parametric Z-Score method, only these methods use non-parametric measures such as the Median and Interquartile Range (difference between the 75^{th} and 25^{th} percentiles). These non-parametric techniques are used to determine if an observation data point is far enough away from the “center” of the distribution to be termed an “outlier”. Where the parametric Z-Score technique uses the mean and standard deviation to calculate and normalize the distance an observation is from the mean of the distribution, the quartile method uses the Interquartile Range. Tukey suggested that a “mild” outlier on the “high-side” of a distribution is any observation that is greater than 1.5 times the Interquartile Range plus the value of the third quartile. He also suggested that an observation is an extreme outlier on the “high-side” if it is greater than 3.0 times the Interquartile Range plus the value of the third quartile (“high-side” of a distribution is here defined as observations that have values that are greater than the third quartile value. “low-side” of the distribution is here defined as observations that have values less than the 25^{th} percentile). Other methods to identify outliers have proved to be not as robust or effective as the Tukey quartile method. Bernier and Nobrega discuss and test the “Sigma Gap” method, for example (Proceedings of the Survey Methods Section, SSC Annual Meeting, June 1998, “Outlier Detection in asymmetric Samples: A Comparison of an Interquartile Range Method and a Variation of a Sigma Gap Method”, Julie Bernier and Karla Nobrega).

However, regardless of the technique used, including non-parametric statistics, if the measure of dispersion includes the entire range of the distribution, as does the Standard Deviation, or “most” of the range of the distribution, as does the Interquartile Range, the presence of outliers or highly skewed or bimodal distributions nearly always causes the measure of dispersion to be negatively influenced by the outliers and the skewness. This “skew and outlier” distortion of the standard deviation and the Interquartile Range in data distributions cannot be discounted.

In Table 4, for example, by adding one outlier, the standard deviation was increased ten-fold. Increasing the absolute value of the measure of dispersion causes the statistic calculated to measure the presence of an outlier to be smaller because the measure of dispersion is located in the denominator. If the objective is to identify outliers, achieve high detection rates, avoid an abundance of false-positives and not tolerate excessive false-negatives, the issue of skew-distortion must not be “assumed away” whether parametric or non-parametric statistical methods are used. Both the Z-Score and Tukey's Quartile methods are unpredictable as to their validity for diverse, non-normal, skewed and outlier-ridden data.

To summarize, the Z-Score is negatively influenced by the presence of non-normal distributions and outliers and the IQR or Quartile Method is negatively influenced as well, although to a lesser extent. In illustration, consider the following for Z-Score and IQR methods.

### Assume:

Z-Score→Z[score]=(x−mean)/(standard deviation)

Quartile Method→IQR[score]=(x−median)/(IQR/2)

In naturally positively and negatively skewed data the Z-Score and IQR measures of dispersion are always adversely affected. In positively skewed data, the following is always true:

Q2−Q1<Q3−Q2

Then

Q3+Q2−Q1<2Q3−Q2

Q3+Q2−Q1−Q2<2Q3−Q2−Q2

Q3−Q1<2(Q3−Q2)

(Q3−Q1)/2<Q3−Q2
Thus when positive skew is present the Z-Score and the Interquartile Method (Using Interquartile Range) denominator (IQR/2) are always smaller, so both the Z-Score and the Interquartile Method will lead to misclassification of potentially fraudulent observations. This conclusion and accompanying analysis can be summarized algebraically in the following manner:

### Given:

A=(x−Q2)/IQR; B=(x−Q2)/(2·UR)

For A and B to be jointly unbiased measures of standardization, examine the relationship between IQR and 2·UR (Q2 is the Median, UR is the Upper Range expressed as the value of the 75^{th} percentile minus the value of the Median and LR is the Lower Range expressed as the value of the Median minus the value of the 25^{th} percentile).

And so define:

IQR=Q3−Q1

UR=Q3−Q2

LR=Q2−Q1

IQR=UR+LR

A nonparametric definition of skewness ((p) can be:

φ:=UR/LR=(Q3−Q2)/(Q2−Q1);{(p=1}?=?{symmetric}

::LR=UR/φ

Then

IQR=UR+LR=UR·(1+1/φ)

If φ=1 there is symmetry and so

IQR=2·UR

and A and B are unbiased and equivalent. But clearly as 1<φ ?=? large this approaches the limit

IQR?=?UR·(1+1/large)?=?UR

The IQR shrinks as skewness increases positively and so there will always be more false positives reported with A than with B. The opposite is true (more false negatives) if the data are negatively skewed, but that condition is rarer with positively-defined data where the objective is to find outliers on the positive skew side of the distribution.

In summary, it makes little sense to use the IQR when attempting to find legitimate high-outliers if the data is naturally positively skewed, since that very skewness deflates the typical but now inaccurate estimate of spread (the IQR), creating a resulting unrealistically large outlier statistic.

The following is a summary of the deficiencies with each of the general parametric statistical techniques used in prior art healthcare fraud detection outlier models. The first and most significant deficiency affects all three categories of traditional techniques described above. Most of these techniques rely on parametric statistics in their calculations. Parametric statistics are based on important mathematical assumptions about the data. One of the most important of these assumptions is that the data are “normally distributed”. A “normal” distribution, as presented in FIG. 1, is here defined as a continuous probability distribution of data that clusters about the mean and has a “bell” shape probability density function with data centered about the mean. Another important parametric statistical assumption is that there are no outliers or extreme values in the data to adversely influence the parameters, the mean and standard deviation. When outliers are present, they negatively influence the accuracy and performance of the distribution parameters, especially the mean and standard deviation. Specifically, outliers can lead to rejection of a false null hypothesis that “there are no outliers present in the data”. Also, the assumption of normality about the data is often not the case, especially in healthcare data. Data in healthcare are seldom “normally distributed”. Most data are typically highly skewed both positively and negatively, bimodal or in some other way not normally distributed, as presented in FIG. 2.

It is obvious that the distributions shown in FIG. 2 are not similar to “normal” distributions. Violation of the normality assumptions cannot be discounted as inconsequential. Although the mean is the optimal estimator of the central tendency of the normal distribution, a single outlier or extreme value can significantly influence it. Because skewed distributions dramatically affect the value of the arithmetic mean, they can make it an inaccurate descriptor of the data distribution's measure of central tendency. Skew in a data distribution is here defined as measure of the asymmetry of a data distribution.

Positive skew occurs when the right tail of a data distribution is elongated. Negative skew occurs when the left tail of the distribution is elongated. Likewise, skewed and other non-normal distributions and outliers significantly affect the standard deviation. It therefore can also be an inaccurate descriptor of the dispersion of a distribution in the presence of non-normality and outliers.

Parametric statistical techniques that assume normality are dramatically negatively influenced by skewed distributions. For example, the mean of the numbers in Table 4, Column 1 “Normal” is 54.5, which, in this case, is an accurate descriptor of the “central” measure of the data. The Standard Deviation, 3.03, is also an accurate measure of the “dispersion” in the data in the column labeled “Normal”. However, by changing one number, the number 59 for observation 10, with another number, an outlier of 159 (Column 2), the mean and standard deviation are no longer representative of the centrality or dispersion of the 10 numbers. In fact, the mean is not even within the range of the first 9 numbers and the standard deviation is 10 times as great as that of the 10 numbers in Column 1 defined as “Normal”.

Note that the Median does not change between the two columns of numbers (Median is here defined as the numeric value in a distribution of numbers that separates the higher half of a sample from the lower half of the numbers. The median of a distribution of numbers is found by arranging all the observations from lowest value to highest value, and determining the middle number).

TABLE 4
Outlier Impact

| Observations | Normal | Outlier |
|---|---|---|
| 1 | 50 | 50 |
| 2 | 51 | 51 |
| 3 | 52 | 52 |
| 4 | 53 | 53 |
| 5 | 54 | 54 |
| 6 | 55 | 55 |
| 7 | 56 | 56 |
| 8 | 57 | 57 |
| 9 | 58 | 58 |
| 10 | 59 | 159 |
| Mean | 54.5 | 64.5 |
| Std Dev | 3.03 | 33.30 |
| Median | 54.5 | 54.5 |

When the objective is to detect outliers in healthcare fraud detection scoring models, it is counterproductive to use parametric statistical techniques that are severely, adversely influenced by the presence of outliers and non-normal data distributions and may, therefore, result in unreliable or inaccurate results. In general, when a distribution is skewed or has outliers, parametric statistical tests, in the direction of the skew, or tail of the distribution toward the outliers, lead to reduced detection rates and increased false-positives whereas parametric tests away from the skew, or the tail and the outliers, lead to increased false-negatives. These parametric statistical approaches perpetuate the already present error caused by the lack of normality in the distributions and the presence of outliers present for each variable.

A more extensive data example illustrates how outliers can affect data parameters, such as the mean and standard deviation, when using parametric statistical techniques such as Cluster Analysis, Principal Component Analysis and Z-Scores. Table 5 below has 34 observations and two variables, X1 and X2. These variables could represent two variables in a fraud detection outlier model, for example. Note that variable X1 has four outliers, observations 31-34. These values are more than 5 times greater than any of the other values for observations 1-30. Variable X2 does not have any outliers, but all the values for observations 1-30 are exactly the same as those for variable X1. The four outliers for variable X1 caused the mean of X1 to be twice as large as the mean of X2 and the standard deviation of X1 is about 6 times greater than the standard deviation of X2. This disparity in the parametric measures of central tendency and dispersion, the mean and standard deviation, will cause significant problems for any parametric statistical technique that is used to detect outliers. In this case, because the analysis is in the direction of the skew, or tail of the distribution, the outliers will not be detected, thereby lowering the fraud detection rate.

TABLE 5
Mean and Standard Deviation Affected by Outliers

| Observation | | |
|---|---|---|
| Number | X1 | X2 |
| 1 | 1 | 1 |
| 2 | 1 | 1 |
| 3 | 1 | 1 |
| 4 | 1 | 1 |
| 5 | 1 | 1 |
| 6 | 1 | 1 |
| 7 | 1 | 1 |
| 8 | 1 | 1 |
| 9 | 2 | 2 |
| 10 | 2 | 2 |
| 11 | 2 | 2 |
| 12 | 2 | 2 |
| 13 | 2 | 2 |
| 14 | 2 | 2 |
| 15 | 3 | 3 |
| 16 | 3 | 3 |
| 17 | 3 | 3 |
| 18 | 3 | 3 |
| 19 | 3 | 3 |
| 20 | 4 | 4 |
| 21 | 4 | 4 |
| 22 | 4 | 4 |
| 23 | 4 | 4 |
| 24 | 4 | 4 |
| 25 | 5 | 5 |
| 26 | 5 | 5 |
| 27 | 5 | 5 |
| 28 | 5 | 5 |
| 29 | 6 | 6 |
| 30 | 6 | 6 |
| 31 | 33 | 7 |
| 32 | 45 | 7 |
| 33 | 43 | 7 |
| 34 | 45 | 7 |
| Mean | 7.44 | 3.38 |
| Standard | 12.83 | 2.03 |
| Deviation | | |

An illustration of a positively skewed distribution, like the one for variable “X1” in Table 5, is shown in FIG. 3.

For Cluster Analysis, not only are the calculations used to develop the clusters adversely impacted by the presence of outliers, the outliers themselves can cause misleading results. For example, the illustration in FIG. 4 shows two clusters, Cluster 1 and Cluster 2 developed from the data distribution of the two variables, F1 and F2. FIG. 4 also shows that there are three outliers in the data distribution, Outliers A, B and C. Note that Outlier B is also the overall Mean of the distribution of both variable F1 and F2. Note also that Outlier A is on the “Low-Side” of the F1 distribution of data values and in the middle of the distribution of F2 data values, but it is considered to be an outlier. If variable F1 is average dollars billed per patient and variable F2 is average number of patients treated in one day, then, for a healthcare fraud detection model, Outlier A would be a provider who sees an average number of patients per day, but has a very low average dollar amount billed per patient. This combination may be an outlier, but it is not a potentially fraudulent outlier. The subsequent detailed examination would result in labeling this observation as a “false-positive”.

Prior art outlier fraud detection techniques generally do not automatically deal with the fact that outliers are considered “bad” in only one direction. That is, Cluster Analysis, Principal Components Analysis, Standard Normal Scores (Z-Scores) and the Quartile Method must be modified in order to account for “bad side” outliers, those that are in the direction of too many procedures or too many patients or too many dollars and are all on the “wrong side” of the data spectrum. If the objective is to detect fraud, it is counter productive to include observations in mathematical and statistical calculations for benign values, or even outliers in the “good side” direction of the distribution, for the score model variables. When trying to find a provider who sees too many patients in one day, it adversely affects the parametric Cluster Analysis, Principal Components Analysis and Standard Normal techniques, and even the non-parametric Quartile Method, to include outliers on the low end of the distribution, just as it does to include outliers on the high end of the data value spectrum.

Additionally, in Table 5 above, if we were to sum the Z-Score for all (both) the variables in the fraud score model, X1 and X2 to get “one total” score, the fact that this model does not detect outliers, even when they exist, would only be worsened. In cases where there are multiple variables in a model and the multiple variables need to be combined into a single value, the individual Z-Scores, in this example, are summed in an attempt to represent the overall fraud risk with one number. If a provider, for example, had a raw data value of “45” for X1 and a raw data value of “1.0” for X2 and we were to “add” the corresponding Z-Scores (2.93 Z-Score for a raw data value of “45” and −1.17 Z-Score for a raw data value of “1”) to get a “Total Fraud Score” (One number that represents the overall risk of all the variables in the model when taken in combination), that Provider's total score would be 1.76 (2.93+−1.17) an even lower score than the X1 variable by itself. Often in a multi-variable model, such extreme values can be masked by several “normal” ones when using traditional averaging procedures. Several moderate values can appear more severe than a single very-far-extreme value that is combined with several smaller values. For example, the average value of (0.7, 0.7, 0.7, 0.7, 0.7) is 0.7 while the average value of (0.99, 0.99, 0.99. 0.1, 0.1) is 0.63. If these five individual values in each group are the probabilities that the associated variable is an outlier, using the average as an indicator of risk, it would appear that the first group of numbers has a higher likelihood of outlier risk, or likelihood of fraud. However, the second group of numbers has a higher likelihood that there are outliers present based on the individual variable values.

As described in the paragraph above, these general techniques, Clustering Analysis, Principal Components Analysis, Standard Normal deviates and the Quartile Method, do not, by themselves, address the issue of providing an indication of the overall outlier risk as represented by one number. Therefore, using these techniques, it is not possible to “monotonically rank” the relative risk of the observations so that all the observations can be rank ordered and evaluated in terms of highest risk to lowest risk when there are multiple variables in a score model. (Monotonic is here defined a sequence of successive numbers which either generally increases or decreases in relative value for each successive observation when ranked from either high to low or low to high. Each successive observation “score” value in an increasing sequence is greater than or equal to the preceding observation score value and each observation score value in the decreasing sequence is less than or equal to the preceding observation score value. In this case, the increasing observation value is likelihood of fraud risk as represented by the fraud detection score. Therefore, the score should generally represent a higher fraud risk as the value of the score increases, for example). This monotonic ranking by risk is critical to the evaluation of a fraud detection score's performance and to managing a fraud detection business operation and investigation staff.

The statistical techniques currently used in fraud detection outlier models cannot automatically or accurately approximate a monotonically increasing or decreasing score value in the presence of multiple variables when used by themselves without further ‘transformations”. Transformation is here defined as the act of changing or modifying a mathematical expression, such as a Z-Score or group of Z-Score values, Quartile Method results, Cluster Analysis Outcomes, or Principal Component Analysis Output, into another single, scalar expression, such as a “fraud detection score”. This transformed value, the fraud detection score, would be one value that represents the overall risk of fraud, according to a mathematical rule or formula. For example, a Z-Score transformation is the converting or transforming the value of the Z-Scores for 10 variables in a fraud detection outlier model into one single value, which represents overall fraud risk. Common transformations also include collapsing multiple Z-Scores (variables) into individual clusters or dimensions, utilizing Principal Components Analysis, in order to reduce false-positives. Both of these approaches further perpetuate the error caused by skewed or non-normal distributions. Note that all cluster techniques do not, by themselves as part of their output, monotonically rank the relative risk of one outlier, in terms of potential fraud likelihood, compared to another outlier. Additionally, cluster techniques, do not automatically provide detailed, score model variable explanations, or Score Reasons, for why an observation was selected as a potential outlier, other than the fact that the observation is not part of Cluster 1 and it is not part of Cluster 2, for example. This negative reference would not be adequate information to evaluate the performance of the fraud detection score or to communicate to a healthcare provider as a legitimate reason for denying a claim payment. Additionally, as seen in FIG. 4, a provider who has a score equal to the average of all the variables in the score model could actually be an “outlier” using cluster techniques.

In the two variable example presented in FIG. 4, it may be easy to explain why an observation is an outlier, it is not part of Cluster 1 or Cluster 2, but it has no practical application in business for explaining to a provider why their claim was denied. Also, in fraud models with 5 or 10 variables it may be impractical to create an explanation that makes sense. This failure to automatically and systematically provide a detailed, variable specific reason, such as, for example, the provider claimed too many patient visits in one day or billed too many charges per patient, makes verifying the performance of the fraud detection model impractical. It is also problematic to explain to a provider, who would have an average value on all the variables, why the provider is an outlier or suspected fraud.

The shortcomings of using parametric statistics are best shown by a detailed example using the Z-Score. Table 5 previously presented two variables, X1 and X2. Those same variables, X1 and X2 are shown in Table 6 below along with the parametric Z-Score value calculated for each observation in the 34 rows of the table. Note that even though it appears that there are four outliers, observations 31-34, the Z-Score values indicate that there are no outliers in the 34 observations of data, if a Z-Score greater than 3.0 is the cut-off for being defined as an outlier. Based on the general consensus in statistics that observations that are more than 3 standard deviations from the mean are highly likely to be outliers, there are no outliers in the distribution of values of X1 and X2. The largest Z-Score is 2.93. This example shows that using parametric statistical techniques in fraud detection outlier models are highly likely to fail to detect many frauds and very likely to cause the fraud detection score model to lead to a rejection of a false null hypothesis (The null hypothesis is “this observation is NOT a fraud”. A false null hypothesis is the condition where the statement “this observation is not a fraud” is false, therefore the observation is, in fact, a fraud. Rejection of the false null hypothesis (there is a fraud) means we assume there are no frauds in the data distribution, which is the wrong assumption).

This action of rejecting a false null hypothesis means that many true frauds go undetected (lower detection rate and higher false positive rate) when the fraud detection model uses these statistical techniques in the presence of outliers or when the distribution is non-normal, or when techniques are used that include observations on “both sides” of the measure of central tendency, such as the mean or the median, as to the parametric statistical techniques as well as the non-parametric Quartile Method.

TABLE 6
Parametric Z-Scores Affected by Outliers

| Observation | | | Parametric | Parametric |
|---|---|---|---|---|
| Number | X1 | X2 | X1 Z-Score | X2 Z-Score |
| 1 | 1 | 1 | −0.50 | −1.17 |
| 2 | 1 | 1 | −0.50 | −1.17 |
| 3 | 1 | 1 | −0.50 | −1.17 |
| 4 | 1 | 1 | −0.50 | −1.17 |
| 5 | 1 | 1 | −0.50 | −1.17 |
| 6 | 1 | 1 | −0.50 | −1.17 |
| 7 | 1 | 1 | −0.50 | −1.17 |
| 8 | 1 | 1 | −0.50 | −1.17 |
| 9 | 2 | 2 | −0.42 | −0.68 |
| 10 | 2 | 2 | −0.42 | −0.68 |
| 11 | 2 | 2 | −0.42 | −0.68 |
| 12 | 2 | 2 | −0.42 | −0.68 |
| 13 | 2 | 2 | −0.42 | −0.68 |
| 14 | 2 | 2 | −0.42 | −0.68 |
| 15 | 3 | 3 | −0.35 | −0.19 |
| 16 | 3 | 3 | −0.35 | −0.19 |
| 17 | 3 | 3 | −0.35 | −0.19 |
| 18 | 3 | 3 | −0.35 | −0.19 |
| 19 | 3 | 3 | −0.35 | −0.19 |
| 20 | 4 | 4 | −0.27 | 0.30 |
| 21 | 4 | 4 | −0.27 | 0.30 |
| 22 | 4 | 4 | −0.27 | 0.30 |
| 23 | 4 | 4 | −0.27 | 0.30 |
| 24 | 4 | 4 | −0.27 | 0.30 |
| 25 | 5 | 5 | −0.19 | 0.80 |
| 26 | 5 | 5 | −0.19 | 0.80 |
| 27 | 5 | 5 | −0.19 | 0.80 |
| 28 | 5 | 5 | −0.19 | 0.80 |
| 29 | 6 | 6 | −0.11 | 1.29 |
| 30 | 6 | 6 | −0.11 | 1.29 |
| 31 | 33 | 7 | 1.99 | 1.78 |
| 32 | 45 | 7 | 2.93 | 1.78 |
| 33 | 43 | 7 | 2.77 | 1.78 |
| 34 | 45 | 7 | 2.93 | 1.78 |
| Mean | 7.44 | 3.38 | | |
| Standard | 12.83 | 2.03 | | |
| Deviation | | | | |

The fact that the techniques described above, such as Clustering Analysis, Principal Components Analysis, Z-Scores and the Quartile Method use the entire spectrum of data values, or a large number of the values on either side of the median, when calculating the statistical measures of dispersion cannot be discounted. (Statistical measures of dispersion are here defined as the standard deviation and the Interquartile Range of a data distribution). These adverse characteristics will cause a lower fraud detection rate and a higher false positive rate. Not only are these statistical measures of dispersion adversely influenced by non-normal distributions and outliers, as previously described, their upper and lower data value boundaries (the lowest value to highest value) often cannot safely be adjusted to reflect stricter or more lenient criteria for the degree of “outlier-ness” (Outlier-ness is here defined as the extent to which an observation is an outlier. An outlier that is 5 standard deviations from the mean is more extreme than an outlier that is 3.5 standard deviations from the mean and therefore has a higher degree of “outlier-ness”). Normally a “boundary” adjustment is made by setting a higher value for the number of standard deviations about the mean to qualify as being labeled as an outlier. However, if the distribution is skewed or has outliers and is not “normally distributed”, then setting higher criteria for outlier-ness using standard deviations becomes progressively less accurate as the extremes of the distribution are reached. This inaccuracy causes the fraud model to fail to detect the outliers and to underestimate the number of outliers, or frauds, thereby resulting in rejection of a false null hypothesis (The null hypothesis in this case would be “there are no fraud outliers”). For example, if a healthcare payer wants to review providers who bill for “too many” patient visits in one day, the payer is typically not interested in providers that bill for too few patients in one day. Yet, traditional, statistical measures of dispersion and the techniques that rely on these measures of dispersion such as Cluster Analysis, Principal Component Analysis, Z-Scores and the Quartile Method, include data values on both the low end of the data distribution and the high end of the distribution.

True frauds that the fraud score detection model fails to identify as frauds, by using the above-described statistical techniques, are termed “false-negatives”. Additionally, the above described statistical techniques result in a lower fraud detection rate, a very undesirable result in fraud detection score modeling. If the distribution parameters are distorted by skewed data and outliers, then any unsupervised statistical models based on dispersion, normality and outlier assumptions that are used to build fraud detection scoring systems are similarly affected. Future supervised parametric models refined or built upon only the currently, limited numbers of identified frauds, where the false-negatives are not detected, also will be subject to the same risk of false-negatives.

Although the Quartile Method is not a parametric statistical technique, unlike the three other techniques described above (Z-Scores, Principal Component Analysis and Cluster Analysis), it has similar deficiencies and fails to meet the needs of healthcare outlier detection because it encompasses data on both the high and low sides of a data distribution. The Quartile Method relies on the IQR, which is analogous to the standard deviation measure of scale in parametric statistics. Although the IQR spans the distribution values from only the 25^{th} to the 75^{th} percentile, which is less than all the values that are included in the standard deviation calculation, the IQR can still be adversely affected by non-normal distributions and outliers. In healthcare, the focus is on the high side of the distribution (Payers are concerned about provider practices that over-charge or over-service, not under-charge or under-service).

Because skewed distributions and outliners can adversely influence observations that fall within the span of the IQR, used in the Quartile Method, using the IQR in the Quartile Method can result in lower fraud detection rates, higher false-positive rates and higher false-negative rates. Statistics based on upper and lower data value boundaries of a variable's distribution adversely affect fraud detection outlier models where the focus is only on the extreme “bad”, high boundary or “risky” behavior of the subjects analyzed. The causal-dynamics of less extreme outliers tend to be functionally different from those of more extreme outliers. Since, in decision-making, it is assumed that a claim is valid until shown to be invalid, by including the low end of the distribution it causes progressive inaccuracy in detecting true high side outliers and often results in the fraud detection model excessively classifying truly fraudulent transactions as being “non-frauds”.

An additional challenge in the field of healthcare fraud detection outlier modeling is the problem of representing the combined groups of multiple variable values, into one single meaningful “number” that represents the overall risk that an observation includes an outlier or likely fraud. Additionally, the single, scalar value, termed a “score”, should be capable of being measured on the same scale across different geographies and different specialty groups. The Quartile Method and Z-Scores, in addition to the statistical shortcomings, make poor fraud detection outlier scoring models because they do not “summarize” to one value and they are not conducive to making comparisons across different geographies and specialties. If comparing two states, Minnesota and Wisconsin, for example, the average Z-Score in Minnesota might be +1.60 and the average Z-Score in Wisconsin might be −1.6, if the average of the two states is calculated, then the calculated value is “0”. Worse, the range of Z-Scores in Minnesota might be from +4.5 to −5.2 while the range of Z-Scores in Wisconsin might be +3.1 to −3.6, thus the relative variability between the Z-Scores in the two states is significantly different. This problem is compounded by the fact that there may be 10 or 15 variables in each model and when these variables are combined to get one overall Z-Score, the unique individual information from each variable is lost.

Therefore, there must be a method for “summing” or “rolling up” the individual fraud score variable values into one number that represents the overall risk that one or more of the variables is an outlier. This cannot be achieved by simply averaging the individual score model variable probabilities, for example, because low values tend to offset high values, thereby “hiding” the fact that one or more variables might be outliers. For example, in a two variable fraud detection outlier model, if one variable has a 0.9 probability of being an outlier and another has a 0.1 probability, their average is 0.5. Whereas if two variables each have only a 0.6 probability of being an outlier, their average probability of being an outlier is 0.6. The observation with the single 0.9 probability of outlier is more severe and more likely to have one variable that is an outlier. The observation with the 0.9 probability variable and the 0.1 probability variable should be ranked higher than the observation with two variables with a probability of 0.6 each, for example. Thus it becomes a challenge to make this summary variable sensitive to the desired level of outlier risk, but not so sensitive as to be erratic, unstable and misleading.

The present invention first calculates a non-parametric “G” value that represents the “raw data” value's likelihood of being an outlier with the following formula:

“G”-Value→g[vₖ]=(vₖ−Medᵥ)/(2*(β·Q3ᵥ−Medᵥ))

Where “vₖ” is the raw data value, “Med” is the distribution Median, β is a weight value, Q3 is the third quartile of the distribution. Then the “G” value is converted to a probability of being an outlier, “H”, by the following formula:

H[g[v]≦g]=1/(1+e^{-λ·g})

Where “e” is Euler's constant, “λ” is a constant and “g” is the “G-Value”.

Then the “H” outlier probability values for all of the variables in the score model are converted to a single probability estimate that represents the overall probability that one or more of the variables in the model is an outlier. This process is termed the Sum-H calculation. This technique is a generalized procedure that calculates one value to represent the overall values of a group of numbers or probabilities. It converts, for a set of k numbers, such as probabilities p1, p2, . . . , pk, for example, into a single generalized summary variable that represents the values of these numbers with emphasis on larger probabilistic values. This calculation then isolates the higher probability variable values and gives them more emphasis or weight in the calculation. In the fraud detection models, it effectively ranks the overall risk of an outlier variable being present for an individual observation. The Sum-H is the final fraud score and it is defined for control-coefficients φ and δ, as follows:

Sum-H[P]=(Σ_{t=1,k}Pₜ^{φ+δ})(Σ_{t=1,k}Pₜ^{φ}); 0≦P≦1, −∞<φ,δ<∞

Note that phi φ and delta δ do not need to be integers. For this invention the numerator powers are always greater than the denominator powers for the Sum-H function. Smaller φ values emphasize the smaller individual probability values over the larger ones, and larger φ values emphasize the larger individual probability values over the smaller. These probability estimates can then be used to compare the relative performance, or risk, among different geographies and across multiple provider specialties.

Prior art does not address this problem of relative risk ranking of observations. In fact, with Cluster Analysis and Principal Component Analysis, and in some cases with the Quartile Method and Z-Scores, it cannot be done or it simply is not done. These prior art method's failure to automatically rank observations by relative fraud risk illustrates another shortcoming in existing statistical fraud detection outlier models. If these procedures are used to select which observation is a higher risk of being an outlier, it is not feasible to rank the observations in any meaningful way according to their relative risk of being an outlier. Yet this sort of ranking is essential in order to use the fraud model in a business environment, demonstrate the validity and measure the financial effectiveness of the fraud detection score model. Ranking individual variables as to their importance also aids in providing Score Reasons so the model results can be analyzed and validated on an individual observation basis.

Most prior art healthcare fraud scoring models that are “Outlier Detection” models rely on parametric statistical techniques. These models generally rely on non-robust parametric statistics as their statistical foundation (A robust statistic is here defined as a statistic that is resistant to errors in the results, produced by deviations from assumptions, for example normality. This means that if the assumptions are only approximately met, the robust estimator will still have a reasonable efficiency, and reasonably small bias, as well as being asymptotically unbiased, meaning having a bias tending towards 0 as the sample size tends towards infinity).

### OTHER PRIOR ART

The following is a review of other issues related to prior art in the field of fraud detection outlier scoring models.

| Patent/Patent | | Issue Date/ |
|---|---|---|
| Application | Inventors | Publication Date |
| U.S. Pat. No. 6,330,546 | Gopinathan et al | Dec. 11, 2001 |
| U.S. Pat. No. 7,379,880 | Pathria et al | May 27, 2008 |
| U.S. Pat. No. 6,826,536 | Forman | Nov. 30, 2004 |
| US 20090094064 | Tyler et al | April 2009 |
| U.S. Pat. No. 6,070,141 | Houvener | May 30, 2000 |
| PCT US0021298 | Luck, Ho Ming et al | Jul. 16, 2000 |
| U.S. Pat. No. 5,991,758 | Ellard | Nov. 23, 1999 |
| U.S. Pat. No. 6,058,380 | Anderson et al | May 2, 2000 |
| U.S. Pat. No. 5,995,937 | DeBusk et al | Nov. 30, 1999 |
| US 2008/0172257 | Bisker et al | Jul. 17, 2008 |

### NON-PATENT PRIOR ART

### A Statistical Model to Detect DRG Up-Coding

| | |
|---|---|
| Journal | Health Services and Outcomes Research |
| | Methodology |
| Publisher | Springer Netherlands |
| ISSN | 1387-3741 (Print) 1572-9400 (Online) |
| Issue | Volume 1, Numbers 3-4/December, 2000 |
| DOI | 10.1023/A: 1011491126244 |
| Pages | 233-252 |
| Authors | Marjorie A. Rosenberg, Dennis G. Fryback |
| | and David A. Katz |
| Subject Collection | Medicine |
| Date | Thursday, Oct. 28, 2004 |

### Outlier Detection in Asymmetric Samples

| | |
|---|---|
| Title | “Outlier Detection in asymmetric Samples: |
| | A Comparison of an Interquartile Range Method |
| | and a Variation of a sigma Gap Method” |
| Presentation Section | Proceedings of the Survey Methods Section |
| Authors | Julie Bernier and Karla Nobrega |
| Meeting | SSC Annual Meeting |
| Date | June 1998 |

Among related patents which describe attempts to monitor medical provider billing while preventing fraud and abuse include:

1. U.S. Pat. No. 6,070,141 of Houvener assesses the quality of an identification transaction to limit identity-based fraud during on-line transaction. It does create a database but does not appear to use non-parametric scoring techniques. Houvener '141 uses quality indicators to determine the level fraud risk and further analysis. It adjusts historical data as a function of current transaction data. This process is similar to many commercial applications and is related to survey research.
2. Luck, Ho Ming et al., HNC Software Inc, PCT US0021298, Detection of Insurance Premium Fraud or Abuse using a Predictive Software System, Dialog: 00779712/9 File #349. Luck uses nine unique triggers that respectively comprise data processing filters for flagging fraud-suspect data within claims submitted for payment by providers. The triggers, or data processing filters, appear to be similar to flags in a rule(s) based system, however they are more like variables in a scoring system. Luck does not specify using non-parametric statistics to create a fraud outlier score. However, Luck does combine data from some different claim formats and appears to cross some insurance industry payers, such as automobile insurance and workers compensation insurance.
3. U.S. Pat. No. 5,991,758 of Ellard involves a system and method for indexing information about entities from different information sources. In this way, an entity may be related to records in one or more databases. Ellard's objective is to compare hospital billing records to those of a physician, but does not appear to use non-parametric scoring methods. Ellard uses a master entity index, MEI. andd confidence levels for matching attributes to compare to a threshold level for selecting data records for display, which may be construed as data processing filter triggers, similar to Luck.
4. U.S. Pat. No. 6,058,380 of Anderson describes a system for processing financial invoices for billing errors. Anderson '380 describes in a table the use of “reasonability” criteria and historical data to determine the presence of billing errors. This system is more closely related to a rule(s) based system and it does not use non-parametric statistics to create a fraud outlier score.
5. U.S. Pat. No. 5,995,937 of DeBusk. DeBusk '937 describes a software method for creating a healthcare information management system. DeBusk uses NODE, MODULE, CONTAINER, RESOURCE AND DATA to describe its software system. DeBusk's examples of fraud relate more to auditing of inventory supplies and does not use non-parametric statistics to create a fraud outlier score.
6. Gopinathan, Pathria and Forman, for example, create “Profiles” which are individual variables, such as total # “transactions”, # claims per day, average number of physician claims per day or average number of physician claims per month. These “simple profiles”, such as total and # of transactions or claims, are just standard data variables similar to those used in Financial Industry scoring models for more than 50 years. The more sophisticated “Profiles”, such as average # transactions and “standardized” variables (Z-Scores), and decayed averages use traditional parametric statistics (such as the arithmetic mean and standard deviation) whenever averages or dispersion are included in the calculation. These profile variables are then correlated with the “dependent variable” in a supervised, traditional regression or neural network scoring model. This process, aside from relying on parametric statistics and the associated assumptions, is quite different from fraud detection outlier models where there is no dependent variable. Not only are these techniques deficient because they rely on parametric statistical techniques, they also do not focus on the area of interest when used in “fraud detection outlier models”. Outlier detection techniques typically use data variables such as the number of patients a provider bills in one day or one week, average amount billed per patient or per week or per month, total amount billed per month, etc. If the provider submits claims for significantly more billed patient visits than some “expected” value, such as the arithmetic mean for similar providers in the same geographic area, the providers peer group, it is considered an “outlier” and causes the score to be “high” or “risky”. It is then sent to analysts for review or investigation. One common problem in outlier detection models is how to measure the likelihood that the number and kind of procedures submitted on a claim are appropriate and reasonable, given the diagnosis of the patient illness. There can be a large number of procedures associated with one patient diagnosis. For example, the diagnosis “kidney disease” may involve multiple procedures to treat the disease including dialysis, tests for diabetes, etc. This situation makes it difficult to assess the appropriateness and reasonableness of the co-occurrence of the procedures with the diagnosis. So, a table is generally constructed that lists the co-occurrence of the different procedures that are associated with individual diagnoses. This co-occurrence is then used to create one variable in the scoring model. Pathria and Tyler, for example, use a type of probability calculation in an attempt to solve this problem. Tyler calculates the conditional probability of a procedure-diagnosis relationship “in both directions”. That is, the table is constructed listing the procedure given the diagnosis and the diagnosis given the procedure. They appear to calculate the probability of a procedure given a particular diagnosis and the probability of the diagnosis given a procedure. They then calculate the square root of the product of the two conditional probabilities. This square root calculation is apparently completed to account for near zero values. However, Tyler's probability calculation does not appear to be a standard Bayesian statistical solution but rather appears to be the geometric mean of the prior and posterior conditional probabilities relating Procedure (P) with Diagnosis (D) and a Diagnosis with a Procedure. Clearly these two probabilities represent probabilistic relationships based on different reduced sample spaces (Procedure space versus Diagnosis space), thus implying very different events. It is not clear then what the objective is to take the square root of their product. If the medical procedures “do not match” the diagnosis on a claim, then that characteristic is considered an outlier in the scoring model and it is sent to human analysts for review. Tyler also does “smoothing”, presumably to deal with zero and near-zero values and to avoid the undesirable effects of zero as a multiplier or divisor. Tyler's final probability value is then used as an indicator of unusual or “normal” combinations of events depending upon its value. It is not clear that if there are a large number of paired events, what techniques are used to determine what the “cut-off” or critical value is to designate if the co-occurrence of the two events as “outliers”. That is, if twenty events are tested for co-occurrence on one claim, what is the value for any one given event to be designated as an outlier and what is the value for what number of events that exceed that threshold for any one claim to designate that claim as an outlier? Some existing techniques (Rosenberg, Fryback and Katz, 2004) appear to use a hierarchical Bayesian estimation approach to this problem where the prior probability estimates have multiple supporting levels of conditional variable dependencies, a tier-like structure of variables. These methods typically assume normal distributions in the data in order to use maximum likelihood estimates. The problems encountered using a tiered approach are, that in addition to the shortcomings of parametric techniques, it adds additional levels of complexity, instability, and possible nonlinear dependence into the model, and it does not easily accommodate a controlled feedback loop of actual validity/non-validity results from previous claim adjudications. The objective of this type of table is to detect unusual combinations of procedures and diagnoses such as a diagnosis of “flu” and an accompanying procedure of “Hip Surgery”. However, none of the prior art suggests using this probability table to detect providers who submit claims for a large number of unusual procedures or a large number of unusual procedures given a particular diagnosis. None of the prior art addresses the fact that a single occurrence of a unique procedure or combination of procedure with a diagnosis may be a data entry or coding error. There may be a large number of these “single occurrence” codes because, aside from the risk of data entry and encoding errors, office staff, other than the medical doctor, often enters the codes. The result may be a code or code combination that has never before been seen or that does not make sense. A primary challenge that is yet unresolved in the field of healthcare fraud detection outlier modeling is the problem of representing the combined interactions of related multiple events, either as groups of probabilities or variable values, into one meaningful monotonic scalar variable that is also sensitive to extreme values. For example, if there are eight variables, each with an associated likelihood of being an outlier, associated with one claim, each describing a different aspect or dimention of that claim, how can these risk probabilities be reasonably combined and represented by one number? Or, if a provider submits five claims related to one patient, how can the overall risk of these five claim records be summarized, in terms of likelihood of fraud risk associated with that patient, into one number? Or, how can all the claim records for one provider be ranked or rated for fraud risk by one composite number? The claim, beneficiary or provider fraud risk must be represented by one number in order to rank the claims, beneficiaries or providers by relative risk so they can be reviewed in order to determine if they are in fact fraudulent. One obvious, but unusable, recommendation is to calculate the average or arithmetic mean value of all the variables associated with one claim, beneficiary or provider. For example, if there are two variables associated with one claim, and one variable has a high Z-Score or Quartile deviation value, such as 4.0, while another variable for the same claim has a low, negative Z-Score or Quartile deviation value of −4.0 (Assume that a high value indicates a high likelihood that this observation for this variable is an fraud outlier), the average of the two variable values for this observation is “0”. The “0” value would then mean that this observation is NOT likely to be an outlier, when in fact it has one variable that is highly likely an outlier and fraud. Using an unbounded number, like a Z-Score, to represent an individual observation's fraud risk is not only sub-optimal, it also presents a more serious problem when aggregating Z-Scores by some other value, such as provider specialty or geography. For example, suppose a claim payer wants to compare the relative fraud risk in one county versus another county. With Z-Scores or Quartile Scores, this is not possible because the Z-Scores and Quartile Scores are unbounded on the high value side. One extreme outlier observation for one county could have a Z-Score of 10 while in another county the highest Z-Score might be 3.5. This disparity in high end values would lead to misleading comparison results. A partial solution to this problem of combining Z-Scores across variables and aggregating Z-Scores by geography, for example, is to convert the Z-Score or Quartile deviation score into a probability of being an outlier. This conversion then solves the problem of negative numbers in calculating the combined variable “score” and it is bounded on the High-Side by “1.0”. Then a claim payer could compare relative fraud risk across counties, or different segments, by averaging the score probabilities. For example, the overall risk in one county might be 0.78 while the overall risk in another county might be less at 0.61. On a scale from “0” to “1.0”, these numbers have meaning in terms of making comparisons. However, the problem of combining multiple variable values into one scalar to represent the overall risk of a single observation being an outlier still remains. For example, if there are five variables associated with one claim, and one variable has a high probability of being an outlier, 0.9 for example, and the other variables have a low probability of being an outlier, less than 0.5 for example, the average of the variable outlier probabilities may be a low value such as 0.38 ((0.9+0.4+0.3+0.2+0.1)/5). So here is an observation with a very risky variable, the 0.9 value, but the claim itself has a low “score”, or scalar value, which is intended to represent overall claim risk. Even if two variables have a high probability of being an outlier, 0.95 each for example, and the others have a low probability, 0.1 for example, (0.95, 0.95, 0.1, 0.1, 0.1) the average is 0.44 which is still a relatively “low” overall value. One alternative is to use a “weighted mean”. Each of the variable probabilities can be weighted by relative importance. This weighting can be based on simulations of the test data even though there is not enough information from prior experience on which to base sound decisions about the weight values. That is, the variable with the highest probability can be given a weight value of “10” and the next highest weight value could be given a value of “8” and so on down to the smallest variable probability. Then the total sum of the weights times the probabilities would be divided by the sum of the weights to derive the “Weighted Mean”. For example, if the variable values are 0.9, 0.4, 0.3, 0.2, and 0.1 and the highest value is weighted by 10 and so on, then 0.9 by 10, 0.4 by 8, 0.3 by 6, 0.2 by 4 and then 0.1 by 2, and multiply these values yields 9, 3.2, 1.8, 0.8, 0.4 and 0.2 totals 15.4. Then divide 15.0 by 30 (the sum of the weights) to get 0.50. The result is the overall weighted average risk score. This “human judgmentally” weighted 0.50 score value is an improvement over the simple average of 0.38, calculated above. However, aside from still not representing the appropriate level of risk of the claim record described above, because one of the variables has a high probability of being an outlier, shows that this technique involving subjective human judgment, often fails to monotonically rank the overall risk of fraud.

In summary, the shortcomings of prior art and the major obstacles to building sophisticated, stable, meaningful, unbiased, statistical based fraud, abuse and waste/over-utilization detection or prevention score modeling systems in healthcare industry are:

### 1. Outlier Detection Models—

There are very few “tagged” fraudulent or abusive claims in healthcare. Because the healthcare industry is highly fragmented and because there have not been any large scale effective fraud detection solutions, there is no central resource of historical claims that can serve as examples of fraud. In order to build traditional supervised parametric models such as multiple linear regression, neural network or logistic regression scoring model, there needs to be a dependent variable, in this case, tagged frauds. This lack of tagged frauds is the reason why the first stage of fraud and abuse models used in healthcare are “fraud detection outlier models” models. As the healthcare industry detects and labels more claims as fraud and abuse, traditional parametric, regression based, scoring models can be utilized with existing outlier methods to further refine procedures to more effectively identify frauds, and measure and rank risk more effectively. Lowering the fraud risk and limiting abusive practices may even help to “normalize” data distributions of the variables in healthcare. If this is not the case, non-parametric equivalents of the traditional parametric regression models need to be built to effectively improve the fraud detection rate and lower the false-positive and false-negative rates of these “second generation” regression fraud detection models. Non-parametric statistical tools (based on ordinal rank or categorical characteristics and include such measures as the median and percentiles) avoid many of the restrictive and limiting assumptions of parametric statistics, and are therefore more robust. This robustness is very important with respect to outliers in the data and data instability. When the objective is to detect outliers, as it is in nearly all “early stage” healthcare scoring models, it is counterproductive to use statistical techniques such as parametric statistics that are unpredictably influenced by the presence of outliers and often provide unreliable or inaccurate results.

### 2. Parametric Statistical Techniques—

Parametric statistical distribution parameters, such as the mean and standard deviation are based on important mathematical assumptions about the data. The two most important data assumptions are that the data are “normally distributed” and that there are no outliers in the data that will adversely affect the distribution parameters. Both the measure of central tendency, most often used in parametric statistics the mean, and the measure of dispersion, the standard deviation, are distorted when the data are not normally distributed or in the presence of outliers. When the objective is to find outliers, it is counter-productive to use statistical techniques that rely on the assumptions that the data is normally distributed and that there are no outliers in the data. If the statistical parameters are distorted by non-normal distributions, such as skewness, and the presence of outliers, then any parametric statistical techniques, such as Clustering Analysis, Principal Component Analysis and Z-Scores, which are based on the normality and outlier assumptions, used to build fraud detection scoring systems are similarly affected.

Prior art parametric statistical techniques such as Clustering, Principal Component Analysis and Z-Scores are deficient because these techniques rely on important mathematical and statistical normality distribution assumptions and these assumptions are violated in medical data. Even if these models do detect some frauds that are outliers, the violations of the underlying assumptions make their use as fraud detection models inadequate and unstable because they have low detection rates, high false-positive rates, high false-negative rates or they cannot deliver reasons for why an observation scored as it did. Existing healthcare fraud detection systems are not adequate or are inappropriate for handling the diverse nature and multiple industry segments or dimensions in the healthcare industry. Prior art in the field of healthcare fraud detection consists mainly of rule(s) based, human judgment methods or the three parametric techniques, Clustering Analysis, Principal Component Analysis and Z-Scores. With Cluster Analysis and Principal Component Analysis, representing the overall risk of fraud with one variable is virtually impossible. Yet this sort of risk ranking is essential in order to demonstrate the validity and measure the performance of the score model. Ranking individual variables as to their importance also aids in providing “Score Reasons” so the model results can be analyzed and validated on an individual observation basis. Even the introduction of supervised model development variable weighting will not improve these methods, because they are based upon the assumption of normality.

### 3. Unreliable Parametric and Non-Parametric Measures of Dispersion—

Another shortcoming in fraud detection outlier models is that the boundary or cut-off criteria for labeling an observation as an outlier often cannot safely be adjusted to reflect stricter or more lenient degrees of “outlier-ness”. Statistical measures of dispersion that use both sides of a variable's distribution, that is the low values less than the average as well as the high values greater than the average, should not be used in outlier models when the focus is only on the extreme “bad” or “risky” behavior at one side of the distribution, greater than the average for example, because nearly all variable distributions in healthcare data are highly skewed or bimodal. In most healthcare models, the data is adjusted so that “high values” are generally high fraud risk and low variable values are low fraud risk. For example, a very high number of claims in one day might indicate fraud, or a very high-billed dollar amount in one month might indicate fraud, whereas a very low-billed amount would not indicate fraud. Therefore, a fraud outlier model should only be focused on the “high-side” of the score model variable distributions to focus on the fraud risk. The entire range of values in a distribution, from the lowest value to the highest value is used to calculate the standard deviation, which in turn is used to calculate the parametric statistical Z-Score.
Even the Interquartile Range, used in calculating the non-parametric Quartile “Scores”, uses most of the values in a distribution, including all observations from the 25^{th} percentile to the 75^{th} percentile. Because skewed distributions and outliners can adversely influence observations that fall within the span of the IQR, used in the Quartile Method, using the IQR in the Quartile method can result in lower fraud detection rates, higher false-positive rates and higher false-negative rates.

### 4. Single, Scalar Value to Represent Risk—

It is a necessary condition, but not sufficient, for a healthcare claim fraud detection system to be able to detect “some of the” fraud. In order to accurately and comprehensively detect the most fraud and to mathematically and statistically validate that a fraud detection scoring system actually works, and that it ranks the relative risk of individual observations that are evaluated, a scoring system must be able to substantially, monotonically rank fraud risk using one numeric value so the score system can be validated. The score must also be able to provide reasons why the observation was ranked as a potential fraud. Only then can a fraud detection score be reliably used in claim fraud review, investigation and risk management numerical performance tracking and validation process. A complete, statistical and demonstrably sound fraud detection system means that fraud models must:
a. Provide one number, a “score” that represents the likelihood across all the observation's behavior variables or patterns, that this particular claim or provider or patient being analyzed is a high fraud risk outlier. There should be at least one characteristic or variable in an observation that is an outlier and therefore the individual observation is likely to be fraudulent,
b. Have a monotonically decreasing likelihood of fraud as the score decreases so the healthcare payer using the score can:
   Rank the relative fraud risk of all transactions that are being reviewed
   Validate that the model is statistically sound and that it ranks fraud risk,
   Calculate the False-Positive Rate/Ratio by fraud risk segments
   Calculate a Detection Rate by score range to measure the model detection rate and performance
   Compare model performance across different specialties, geographies and business segments
c. Have the capability to summarize the overall risk of claims, providers or patients who have characteristics or variables that are outliers by geography or by specialty so it can be demonstrated that the fraud detection score effectively and consistently ranks risk by these categories of geography and specialty.
d. Be mathematically repeatable,
e. Be computationally efficient in order to reduce the possibility of process errors when the scores are validated,
f. Measure multiple behavior patterns, represented by variables in the fraud detection outlier model, of healthcare providers being analyzed, in order to provide for a statistically broad sample of observations in the fraud models,
g. Measure fraud risk on the same scale across differing geographies, provider specialties and industry segments.
h. Accumulate differing healthcare providers and patients into similar, relatively homogeneous fraud risk groups so they are being measured and compared to other providers or patients with similar specialties, services or demographics, to measure score consistency and validity,
i. Be statistically robust and focus on the “Bad Side”, or fraud risk side or “High-Side” of the data distribution.
j. Be able to explain the exact fraud score variable or variables that represent the behavior that caused this claim, provider or patient to have a high-risk fraud detection outlier score.

### 5. Convert Outlier Value to a Probability—

The Healthcare Industry is segmented by category such as physician, hospital, etc. and by specialty Family Practice, Ambulance, Physicians Assistant, etc., and it is diverse across geographies such as state, county and city. Because the healthcare industry is so fragmented, it is important that a fraud detection score not only is represented by one number, but it also is meaningfully comparable across healthcare segments. For example, a Z-Score generally ranges from about −3.0 to +3.0, but if an observation is an outlier, the Z-Score could be +6.4 or +5.9. Comparing the “average” or “typical” fraud risk, from one county to the next or from one specialty to another using Z-Scores is virtually meaningless. The scale may differ across geography or specialty. That is, in one county, the Z-Scores may range from −3.2 to +4.1 while in another county, they may range from −3.7 to +5.3. Because the ranges are different, it would be misleading to compare the two counties. Additionally, in order for regulatory agencies to compare fraud detection scores developed using differing techniques, the scores themselves must be compared on the same metric. If an agency or company wanted to compare the relative fraud risk across two different geographies and the fraud detection scores were developed using two different techniques, Z-Score and the Interquartile Method, for example, comparing the actual raw Z-Scores with IQR-scores would be misleading because they come from different distributional assumptions (Normality, symmetry, non-normality, etc).

### 6. Conditional Probability Tables to Detect Unusual Diagnosis Procedure Combinations—

Existing fraud detection models in other industries, such as Financial Services, use conventional data preparation techniques that are well known and have been used in business and industry for more than fifty years. For example, Forman and Pathria discuss “Profiles” which are nothing more than data pre-processing steps often used in traditional score modeling technology in the Financial Services Industry. They use parametric statistics such as averages and standard deviations to summarize the data and obtain historical data measures of central tendency and dispersion. They then use parametric statistics to compare the current claim information under review to the historical summary data of prior claims or for the provider in prior time periods. These prior claims and provider data can be historical information from sources such as hospitals, physicians, government payers and private insurance companies. Some of these systems even rely on published “normative” rules and quantities from these agencies. Existing solutions (Tyler and Pathria) discuss the use of co-occurrence tables in healthcare to uncover unusual patterns of procedures billed as part of a claim. Pathria uses a “modified version” of conditional probability calculations based on dividing the joint probability of two events by the product of the marginal probabilities of two events in order to determine the likelihood of co-occurrence of these two events. It appears that they actually have Q=p[DP]/(p[D]·p[P])=p[P|D]/p[P], or the ratio of two probabilities—a conditional probability divided by a marginal probability. It is not clear what this ratio reveals but it's not a probability itself since it can easily exceed one because: p[P|D]>p[P] (i.e., Procedure (P) is a rarely used procedure but is usually required for diagnosis (D). If this is the case, then Q is simply a numeric measure. Tyler attempted an enhanced version of this technique by calculating the joint probability of two events divided by the square root of the product of the two conditional probabilities (Q=p[DP]/√(p[D]·p[P])=√/(p[D|P]·p[P|D]). It is not clear what the square root of their product represents, however it appears to attempt to compensate for near zero values. Other than being merely a numeric measure, the outcome of this formula is questionable for model building purposes. It may be a predictor variable, but it is not clear how this variable would be explained as a reason code. He then appears to rely on “smoothing” (adding a small number to marginal probabilities that are near zero) in order to avoid potentially distorted results and to avoid dealing with division by zero. Functionally, it is puzzling why Pathria and Tyler use the forward and reverse conditional probabilities together in the same expression. It appears that they are considering medical procedures and diagnosis “both ways”, procedure given diagnosis and diagnosis given procedure. The Pathria and Tyler techniques account for both the probability of a procedure code given a diagnosis and the probability of diagnosis given a procedure code, which does not seem to make sense in the healthcare industry or environment. If for example event-A is an abnormally high fever and event-B is the Ebola virus disease then for a patient p[A|B] would be close to 1 but p[B|A] would be close to zero (imagine all the other conditions that induce a high fever). They are calculating the two-way event likelihood of those procedures without consideration of the fact that the medical diagnosis determines the procedures used to cure it, but that the procedures do not typically determine the medical diagnosis. These two conditional probabilities represent probabilistic relationships based on different reduced sample sizes (Procedure space versus Diagnosis space), thus implying very different events. Finally, it is not clear how the Pathria and Tyler methodology provides for the hierarchical summation from one level of the claim to another higher level, from trailer, or line record to the higher-level header record for example, or from Claim to Provider. These deficiencies, several in number, potentially make the Pathria and Tyler solutions unstable, inaccurate, untenable, incomplete and inflexible. Although the prior art discusses the objective of discovering rare or unusual combinations of procedure and diagnosis, there is no evidence that the prior art deals with two important related issues:
a. Discovering providers that submit unusually high numbers of unusual combinations of procedures and diagnoses.
b. Discovering providers that submit unusually high numbers of unusual or rare procedures, by themselves, compared to others in their specialty group or geography.

### BRIEF SUMMARY OF THE INVENTION

Multiple Model Overview

The invention includes multi-dimensional capabilities that gauge the likelihood of unusual patterns of behavior, including but not limited to, healthcare claims, providers or of the beneficiary (individual/patient).

The invention is a predictive scoring model, which combines separate predictive model dimensions for claims fraud, provider fraud and beneficiary fraud. Each dimension is a predictive model in itself, with further models created and segmented by additional dimensions, including but not limited to, provider specialty and geography. Each sub-model provides a probabilistic score, which summarizes the likelihood that either separately or combined one or more of the dimensions has claim, provider or beneficiary characteristics with unusual, abnormal or fraudulent behavior. Separately, within the claim dimension, provider dimension or the beneficiary dimension, a separate model for patient health and co-morbidity compares the health of the patient to the relative work or financial effort expended to further refine each model probability estimate.

Each dimension, claim, provider and beneficiary, has a predictive model created using the non-parametric statistical technique called the “Modified Outlier Technique”. This modification, developed as part of this patent, corrects for the dispersion and Interquartile Range inaccuracies resulting from non-normal skewed distributions and the presence of outliers in the underlying heath care data.

The claim model dimension, with further segmentation such as specialty group and geography, ascertains the likelihood that a specific claim has a likelihood of unusual or abnormal behavior that is potentially fraud or abuse. Several example characteristics that are a part of the claims predictive model include, but are not limited to:
1) Beneficiary health
2) Beneficiary co-morbidity
3) Rare uses of procedures
4) Dollar amount submitted per patient to be paid
5) Distance from provider to beneficiary

The provider model dimension, with further segmentation such as specialty group and geography, determines the likelihood that a specific provider has a likelihood of unusual, abnormal or fraudulent behavior as compared to that provider's specialty, or peer, group. Examples of a specialty, or peer groups, are pediatrics, orthopedics and anesthesiology.

Example characteristics that are a part of the provider predictive model include, but are not limited to:
1) Beneficiary health
2) Beneficiary co-morbidity
3) Zip centroid distance, per procedure, between patient and provider compared to peer group
4) Number of providers a patient has seen in a single time period
5) Proportion of patients seen during a claim day (week/month) that receive the same procedure versus their peer group
6) Probability of a fraudulent provider address
7) Probability of a fraudulent provider identity or business

The beneficiary model dimension, with further segmentation such as specialty group and geography, defines the likelihood that a specific beneficiary has a likelihood of unusual, abnormal or fraudulent behavior as compared to that beneficiary's peer group. An example of a beneficiary peer group is males, between ages 65-71 years old with a common treatment history. Example characteristics that are a part of the beneficiary predictive model include, but are not limited to:
1) Beneficiary health
2) Beneficiary co-morbidity
3) Time since visit to same provider
4) Time since visit to other/different provider
5) Percent of office visit or claim cost paid by beneficiary
6) Probability of a fraudulent beneficiary address
7) Probability of a fraudulent beneficiary identity

A predictive modeling schematic can be presented graphically, as shown in FIG. 5.

The score values range from zero to one hundred, with higher values indicating higher fraud risk and lower values indicating lower fraud risk. Therefore, the highest-score values have a high probability of fraud, abuse or over-servicing/over-utilization.

Model Development Overview

Fraud models, based upon the invention, are built using both external data sources (and/or link analysis) and historical data from past time periods, such as 1 to 2 years ago. Data is summarized, edited and “cleaned” by dealing with missing or incorrect information for each characteristic. In addition to the raw variables being used in the invention, a large number of variables are also created, through transformations, such as number of patients seen by a provider in one day, one week, one month or beneficiary co-morbidity and number of claims per patient.

For each dimension, variables used to create models in the invention are compared to peer group behavior, including but not limited to healthcare claims, providers or of the beneficiary (individual/patient), to determine if their behavior is “typical” of other participants in their peer group or if they are “abnormal” (A “peer group” is here defined as a group of members of the same dimension, including but not limited to healthcare claims, providers or of the beneficiary. For example, a peer group for providers might be their medical specialty, such as pediatrics or radiology).

Score models from the invention are built using variables that can be used in a production environment when the score is deployed. Variables used in the score model must be adaptable to changing fraud trends or new conditions. For example, score models in production must be able to calculate a score for a new provider, versus an existing provider. This means that no variables that are specific only to the providers that were known to the data at time of score development, 1 to 2 years ago, can be used in the model development. Or, for example, if one of the variables in the model is number of claims for a provider 6 to 12 months ago, there must be provision for how to handle a new provider that just started accepting this payer's patients one month ago. One scenario, for example, to treat this condition is to assign new providers the average number of claims for the variable that includes number of claims 6 to 12 months ago.

Data reduction, in the form of reducing the number of variables in a score model, generally leads to performance improvement in models. At the beginning of score model development, there are several hundred potentially eligible variables for a particular score model. These variables are analyzed statistically for their relevance and narrowed down to the number of variables that are eventually included in the final score model. The process of reducing the number of variables in the invention for the unsupervised models for each dimension is accomplished using accepted and proven standard statistical techniques. While several techniques are possible to use for analysis, Principal Components Analysis is the most common method. It identifies variables that are highly correlated with one another and builds new uncorrelated dimensions, referred to as factors. Then, one variable is selected from each factor to be a part of the score model and the others are removed from the model. Suppose, for example, five similar variables such as claim dollars allowed, claim dollars billed, claim dollars paid, claim dollars declined and total claim dollars expended are available to enter the provider model dimension. Using Principal Components Analysis, these highly correlated variables can be represented through one of the variables for this dimension that represents the concept of “cost”, and the other four variables can be eliminated from the model. This process is repeated until the best, most parsimonious model is finished and ready for deployment.

Predictive models are monitored, validated and optimized regularly. Models are optimized or redeveloped as experience is gained regarding the value of existing variables or the introduction of new ones, model performance deteriorates or new information or new patterns for fraud or abuse is identified, providing the opportunity for improvement.

Model Deployment Overview

The final model is then put into production in a model deployment process where it is used to score separate predictive model dimensions, including but not limited to, claims fraud, provider fraud and beneficiary fraud. The model can be deployed on a “real time” or “batch mode” basis. Real time scoring occurs as a claim is received and processed by the payer. The score can also be calculated in “batch mode” where it is calculated on all claims received in regularly scheduled batches, for example hourly or daily batches.

Example Results

Example results the invention can identify include:
1) Identifying a surgeon that charges separately for a suture closure, when actually it is covered in the overall surgery charge, allowing the provider to charge more for a single patient.
2) Identifying a provider that repeatedly submits claims for the same patient for appendix removal.
3) Identifying a provider where every patient is seen weekly for 3 months even though diagnosis does not justify the level of effort.

The present invention uses non-parametric statistics and probability-based methodology and variables to develop fraud detection outlier scoring models for the healthcare industry. The invention is intended for use by both government and private healthcare payer organizations. The invention uses historical databases to summarize peer group performance and compares current claim transactions to the typical performance of the peer group to identify healthcare providers who are likely submitting fraudulent or incorrect claims. The invention can be applied within healthcare industries such as Hospital, Inpatient Facilities, Outpatient Institutions, Physician, Pharmaceutical, Skilled Nursing Facilities, Hospice, Home Health, Durable Medical Equipment and Laboratories. The invention is also applicable to medical specialties, such as family practice, orthopedics, internal medicine and dermatology, for example. The invention can be deployed in diverse data format environments and in separate geographies, such as by county, metropolitan statistical area, state or healthcare processor region.

The fraud detection scoring models enable the collection and storage of legitimate historical claims data and historical claim data that is tagged as fraudulent, incorrect, wasteful and abusive in order to validate the score and to provide a “feedback loop” to enable future regression based score model development. The score provides a probability estimate that any variable in the data is an outlier. The score then ranks the likelihood that any individual observation is an outlier, and likely fraud or abuse. Finally, the score provides Score Reasons corresponding to why an observation scored as it did based on the specific variables with the highest probabilities of being outliers.

### BRIEF DESCRIPTION OF THE DRAWINGS

FIG. 1 shows a bell shaped “normal” distribution.

FIG. 2 shows the typical kinds of data distributions common to healthcare data.

FIG. 3 shows a Population Distribution Example.

FIG. 4 shows Cluster Outlier Examples.

FIG. 5 shows a graphical representation of a predictive modeling schematic.

FIG. 6 is high-level block diagram showing the score probability calculation process.

FIG. 7 shows an overview of the Fraud Prevention Process.

FIG. 8 (8A-8D) shows a more detailed block diagram of the end-to-end fraud prevention process.

FIG. 9 is a block diagram of the Historical Data Summary Statistical Calculations.

FIG. 10 is a block diagram of Score Probability Calculation and Deployment Process.

FIG. 11 is a score performance evaluation diagram.

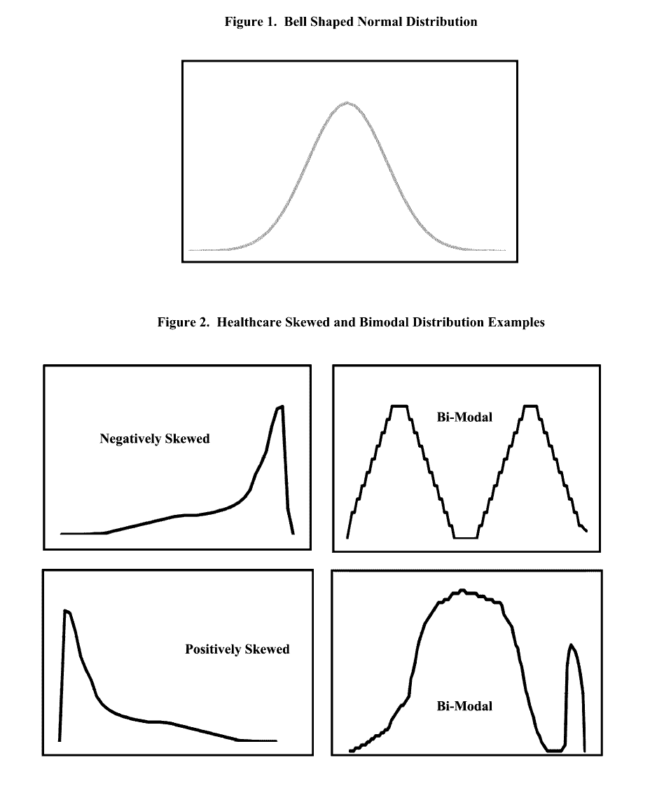

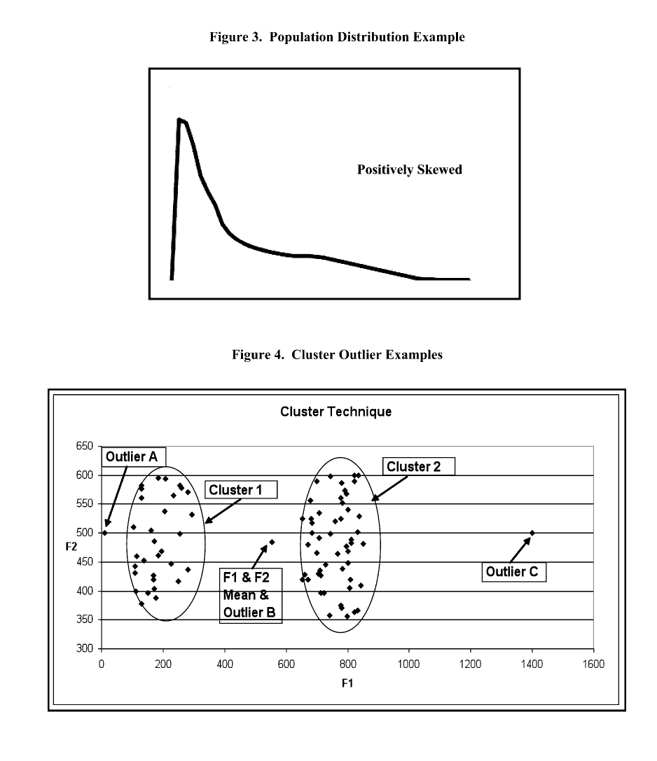

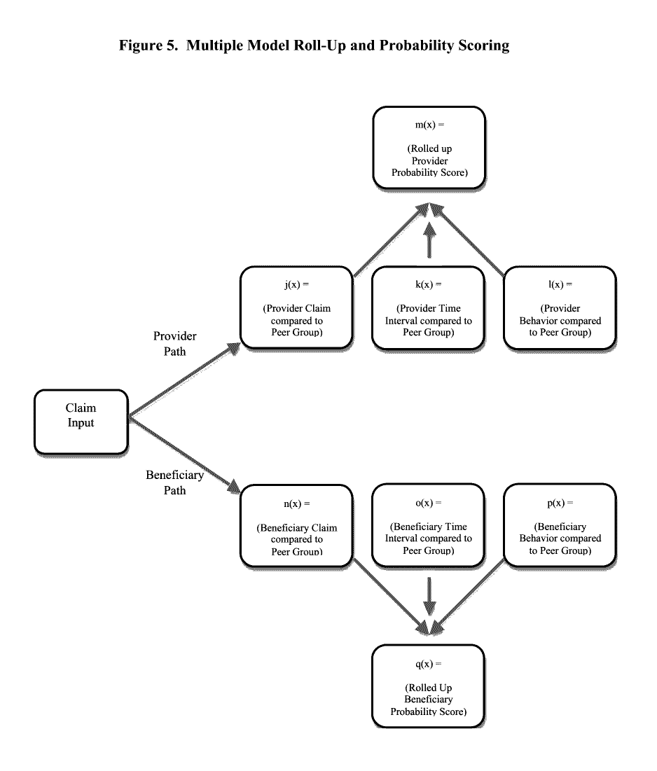

### DETAILED DESCRIPTION OF THE PREFERRED EMBODIMENTS

While this invention may be embodied in many different forms, there are described in detail herein specific preferred embodiments of the invention. This description is an exemplification of the principles of the invention and is not intended to limit the invention to the particular embodiments illustrated.

The present invention is a “Fraud detection outlier scoring model” that is designed to focus primarily on extreme values at the “high” or “unfavorable” end of the variable distributions in the model. The fraud detection outlier score is hereby defined as the value that represents the overall probability that one or more of the claims, provider or beneficiary characteristics, as measured on a scale of zero (0) to one (1.0), and are likely fraud, abuse or waste/over-utilization. The higher the value between zero and one, the more likely that the claim, provider or beneficiary characteristics are fraudulent. At some value on the scale between zero and one, the likelihood of being an outlier is so great that the observation can be labeled as “potential fraud”. This value, which can be defined by the fraud detection management personnel and prior experience, is here defined as the “Tipping Point”. The “Tipping Point” is the value above which it is unlikely that this claim, provider or beneficiary is exhibiting a “normal” behavior pattern. Therefore, a very high score, 0.9 or 0.95 for example, means that one or more of the claim's, provider's or beneficiary's characteristics have abnormal or unusual values. The present invention provides a system and method for non-parametric statistical score techniques to detect and prevent healthcare fraud, abuse or waste/over-utilization. The invention is adaptable for use in both government and private healthcare payer organizations and within healthcare industries such as Hospital, Inpatient Facilities, Outpatient Institutions, Physician Pharmaceutical, Skilled Nursing Facilities, Hospice, Home Health, Durable Medical Equipment, and Laboratories. The present invention is also applicable to medical specialties, such as family practice, orthopedics, internal medicine, dermatology, and approximately 50 other medical specialties. The present invention can also be deployed in diverse data format environments and in separate geographies, such as by state or healthcare processor region. The present invention enables the collection and storage of historical claims data including those that have been flagged as valid or invalid fraud (fraud, abuse, waste, etc).

The present invention uses a special type of non-parametric statistical technique, the “Modified Outlier Technique”, a significant modification of the Interquartile Method. This modification, developed as part of this patent, corrects for the dispersion and Interquartile Range inaccuracies resulting from non-normal skewed distributions and the presence of outliers in the underlying heath care data. Traditional healthcare characteristics, such as historical number of visits per day, per week and per month, for example, are used as score model variables.

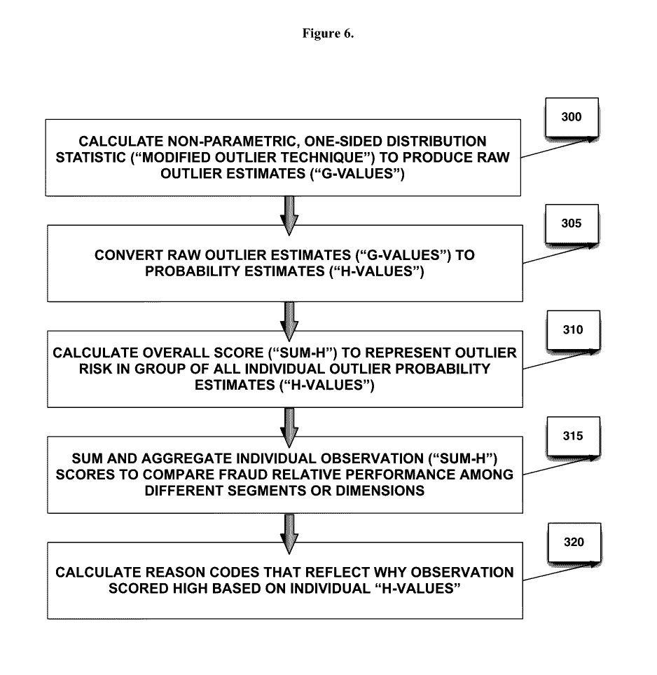

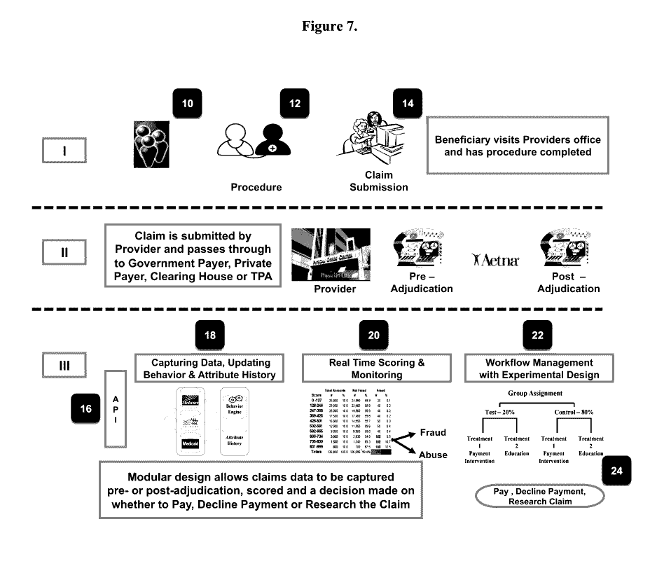

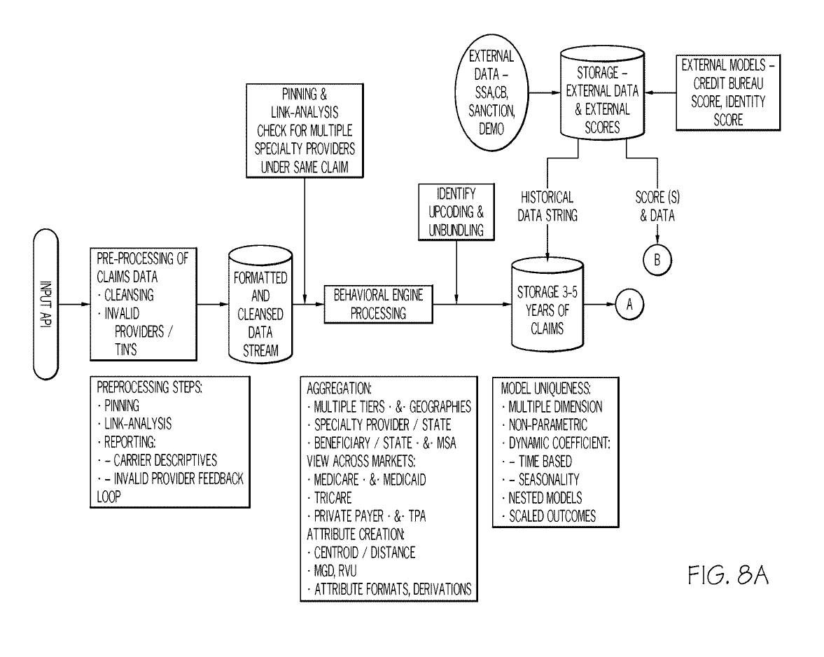

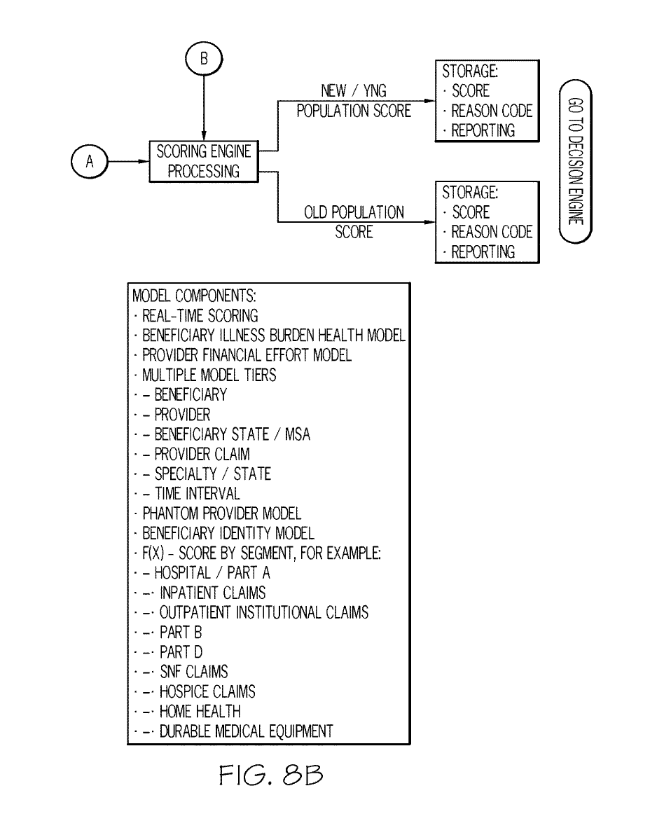

Referring now to FIG. 6, the present invention uses the following procedures to calculate the likelihood that any of these characteristics in the scoring model is an outlier and likely fraud. The first step 300 in this process in the present invention is the calculation of a non-parametric, one-sided distribution statistic, termed the “Modified Outlier Technique”. The “Modified Outlier Technique” calculates, for the “High-Side”, or risky side of the data distribution, the difference between the Median and the third quartile, (75^{th} percentile) as the measure of dispersion to normalize the outlier calculation by using the formula (distance between an observation's value and the Median) divided by (the difference between the 75^{th} percentile and the Median) in order to limit inaccuracies introduced by broader dispersion measures such as the Interquartile Range and the standard deviation. The result of this calculation is a normalized transformation of the raw data variable and it is termed the “G-Value”. The assumptions and mathematical formulae creating the G-Value are as follows:

G-Value High-Side of distribution: g[vₖ]=(vₖ−Medvₖ)/(βQ3−Q2);

G-Value Low-Side of distribution: g[vₖ]=(vₖ−Medvₖ)/(βQ2−Q1)

where for each observation in the data, vₖ represents the raw data value for the “kth” variable “v” and (Q3 vₖ−Med vₖ) represents the value of the 25% of the distribution between the 75^{th} percentile and the median (75th percentile minus the 50th percentile) and (Q1 vₖ−Med vₖ) represents the value of the 25% of the distribution between the 25^{th} percentile and the median (25th percentile minus the 50th percentile). Beta, β, is a weighting constant that allows the expansion or contraction of the g[vₖ] equation denominator to reflect estimates of the importance or criticality of variable vₖ. Then Q1, Q2, and Q3 are used to establish the projected 0 and 100 percentile points, the acceptance boundaries, by

P[0%]=2·Q1−Q2; P[100%]=2·Q3−Q2

Because these bounds are in the dimensions of the metric, the individual variable values, they are scaled so that they are non-dimensional (facilitating comparisons and accumulations). For the raw data, initial outlier fraud risk estimates can be made by determining if the raw G-Value is outside the bounds of the estimated zero percentile or the estimated 100^{th} percentile. The 0 and 100 percentile boundary estimates are calculated below. If the raw G-Value is outside the bounds of these estimates, it is an indication that the variable “vₖ” for this observation is likely an outlier.

Estimated 0 percentile→g[0%]=(2Q1−Q2−Q2)/(Q2−Q1)=−2(Q2−Q1)/(Q2−Q1)=−2

Estimated 100th percentile→g[100%]=(2Q3−Q2−Q2)/(Q3−Q2)=2(Q3−Q2)/(Q3−Q2)=+2

### Therefore:

Note that 0% and 100% boundaries are then g-scored as

g[0%]=(2Q1−Q2−Q2)/(Q2−Q1)=−2(Q2−Q1)/(Q2−Q1)=−2

g[100%]=(2Q3−Q2−Q2)/(Q3−Q2)=2(Q3−Q2)/(Q3−Q2)=+2

And their boundary H-Values are:

H[g[v]≦g]=1/(1+e^{-λ·g});

H-Value Lower Bound→H[g[0%]=1/(1+e^{-1.1·-2})=˜0.1

H-Value High Bound→H[g[100%]=1/(1+e^{-1.1·2})=˜0.9

Therefore:

G-Value High Bound→g[v]≦2→ok, g[v]>2 questionable-high-outlier

G-Value Low Bound→g[v]≧−2→ok, g[v]<−2 questionable-low-outlier

The next step in the present invention process 305 converts the raw outlier estimates, termed the “G-Values”, to probability estimates, termed the “H-Values”. These probability estimates range between zero and one. These “H-Values” represent the probability that the associated individual variable in the model is likely an outlier. Low values, near zero, indicate low likelihood of this individual variable being an outlier and high values, near one, indicate a high likelihood of the variable being an outlier.

The calculations and formulae for the H-Values are as follows: (Looking at the high-end of the distribution—the algebra is the same for the low-end):

H[g[v]≦g]=1/(1+e^{-λ·g})

Scale λ so that H[g=1]→0.75(low end: H[g=−1]=0.25)

0.75=1/(1+e^{-λ})

e^{-λ}=1/3→λ=Ln [3]

and so

H[g[v]≦g]=1/(1+3^{-g})

The projected 0% and 100% for the G-Value are:

g[0%]=(2Q1−Q2−Q2)/(Q2−Q1)=−2(Q2−Q1)/(Q2−Q1)=−2

g[100%]=(2Q3−Q2−Q2)/(Q3−Q2)=2(Q3−Q2)/(Q3−Q2)=+2

And their boundary H-Values are:

H[g[v]≦g]=1/(1+e^{-λ·g});

H-Value Lower Bound→H[g[0%]=1/(1+e^{-1.1·-2})=˜0.1

H-Value High Bound→H[g[100%]=1/(1+e^{-1.1·2})=˜0.9

Therefore:

G-Value High Bound→g[v]≦2→ok, g[v]>2 questionable-high-outlier

G-Value Low Bound→g[v]≧−2→ok, g[v]<−2 questionable-low-outlier

For H[g[0%]=1/(1+3²)=0.1(<0.1→Questionable outlier on Low-Side of distribution)
Note that the H-Value of 0.1 is comparable to a G-Value of −2
Both the H-Value of 0.1 and the G-Value of −2 represent the estimated 0 percentile of the distribution

H[g[100%]=1/(1+3⁻²)=0.9 (>0.9→Questionable outlier on High-Side of distribution)
Note that the H-Value of 0.9 is comparable to a G-Value of +2
Both the H-Value of 0.9 and the G-Value of 2 represent the estimated 100 percentile of the distribution

The present invention at 310 then calculates one value, termed the “Sum-H”—the overall score, to represent the outlier risk in the group of all the individual outlier probability estimates, the “H-Values”. The “Sum-H” calculation converts, for a set of “H-Value” probabilities hₜ, h₂, hᵢₜ, for example, into a single summary variable that represents the likelihood that one or more than one of the “H-Values” is an outlier. The “Sum-H” value, the overall “Fraud Risk Score”, is then the overall probability that one or more than one of the observation's “H-Values” is an outlier. This calculation isolates the higher probability variable values for an individual observation and gives them more emphasis in the calculation. These individual observation “Sum-H” scores can then be summed and aggregated at 315 to compare the relative performance, or fraud risk, among different segments or dimensions, such as geographies and across multiple provider specialties. The formula for the _{Σ}H_{φ,δ} Sum-H is:

Sum-H→_{Σ}H_{φ,δ}=[Σ_{t=1,k}ωₜ·Hₜ^{φ+δ}]/[Σ_{t=1,k}ωₜ·Hₜ^{φ}]

where _{Σ}H, Sum-H, is the summary probability estimate of all of the normalized score variable probability estimates for the variables for one observation, which is the “score” for this observation, wₜ is the weight for variable Hₜ, φ (Phi) is a power value of Hₜ, such as 1, 2, 3, 4, etc. and δ (Delta) is a power increment which can be an integer and/or decimal, such as 1, 1.2, 1.8, 2.1, 3.0, etc. The score, _{Σ}H, Sum-H, will have a high value, near 1.0, if any or all of the individual variable “H-Values” have high probability values near 1.0, thereby indicating that at least one, and perhaps more, of the variables for that observation have a high probability of being outliers.

The present invention also specifies the use of an historical medical claims table of procedures and diagnoses or calculated and published tables of same to determine conditional probabilities of the co-occurrence of medical procedures, given a specific medical diagnosis, across all healthcare industry types. The present invention then uses this conditional probability as a variable in the score model. The probability of a Procedure Code (PC) given a Diagnosis Code (DC) expressed as (P[PC|DC]) is the form of this probability. These conditional probabilities are derived from all the historical procedure and diagnosis claim records for a particular industry and geography gathered from past claims experience within the industry segment. This probability table accumulates the procedures used associated with a given diagnosis on the claim. The probability table is constructed using claim procedures as the columns, for example, and the claim diagnosis as the rows. To estimate these conditional probabilities, count the number of occurrences of the various reported procedure codes (PC's) for each specific diagnosis code (DC) throughout the history data file. Thus, for example if there are 287,874 occurrences of DC 4280 in the history file and PC 99213 occurs in 89,354 of them then P[PC 99213|DC 4280]=89,354/287,874=0.3104. In order to maintain a consistent trend that “higher number values indicate higher risk of fraud”, the compliment of the (P[PC|DC]) is used instead of the calculated probability of PC:DC. Therefore, the probability of PC 99213 NOT occurring with DC 4280 is 1−0.3104 or 0.6896.

The present invention calculates reason codes at 320 that reflect why the observation scored high based on the individual “H-Values”. The variable associated with the highest H-Value is the number one reason why the overall score indicated possible fraud and the variable with the second highest H-Value is the number 2 reason and the variable with the third highest H-Value is the number 3 reason and so on.

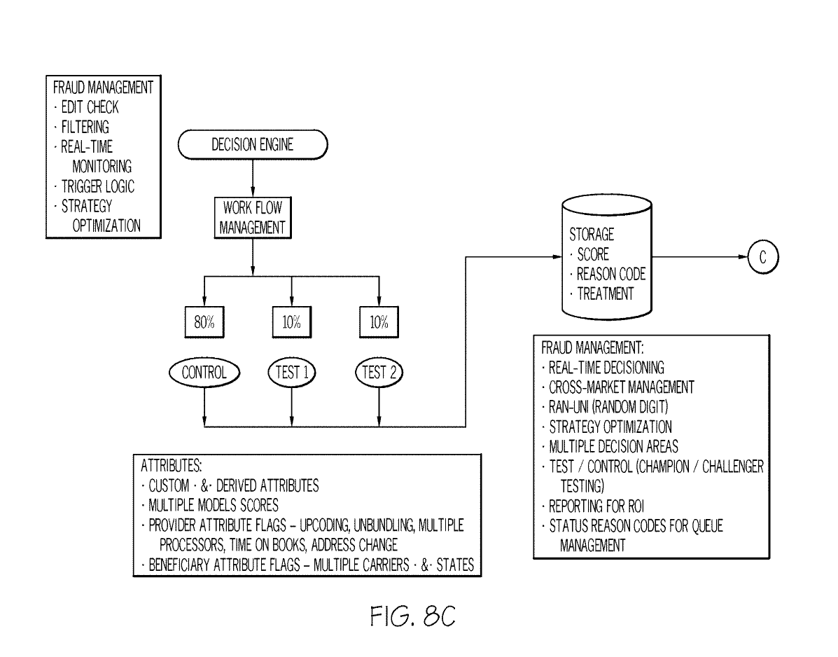

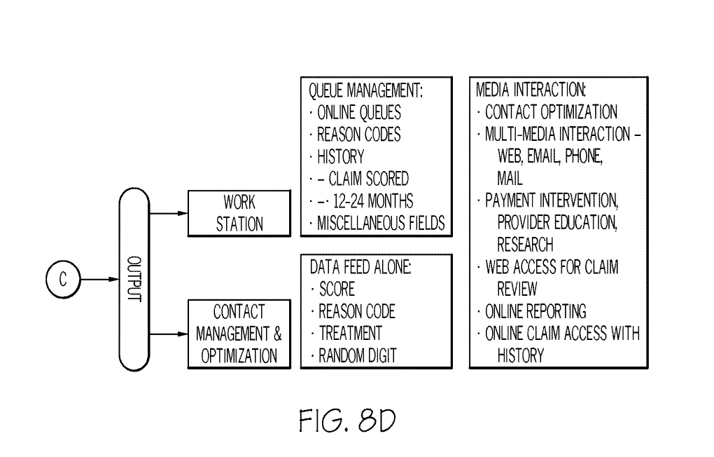

The overall process is shown in FIGS. 7 and 8. The patient or beneficiary 10 visits the provider's office and has a procedure 12 performed, and a claim is submitted at 14. The claim is submitted by the provider and passes through to the Government Payer, Private Payer, Clearing House or TPA, as is well known in this industry. Using an Application Programming Interface (API) 16, the claim data can be captured at 18. The claim data can be captured either before or after the claim is adjudicated. Real time scoring and monitoring is performed on the claim data at 20. The Fraud Risk Management design includes Workflow Management 22 to provide the capability to utilize principles of experimental design methodology to create empirical test and control strategies for comparing test and control models, criteria, actions and treatments. Claims are sorted and ranked within decision trees based upon user empirically derived criteria, such as score, specialty, claim dollar amount, illness burden, geography, etc. The information, along with the claim, is then displayed systematically so an investigations analyst can review. Monitoring the performance of each strategy treatment allows customers to optimize each of their strategies to prevent waste, fraud and abuse as well as adjust to new types and techniques of perpetrators. It provides the capability to cost-effectively queue and present only the highest-risk claims to analysts to research. The high risk transactions are then studied at 22 and a decision made at 24 on whether to pay, decline payment or research the claim further.

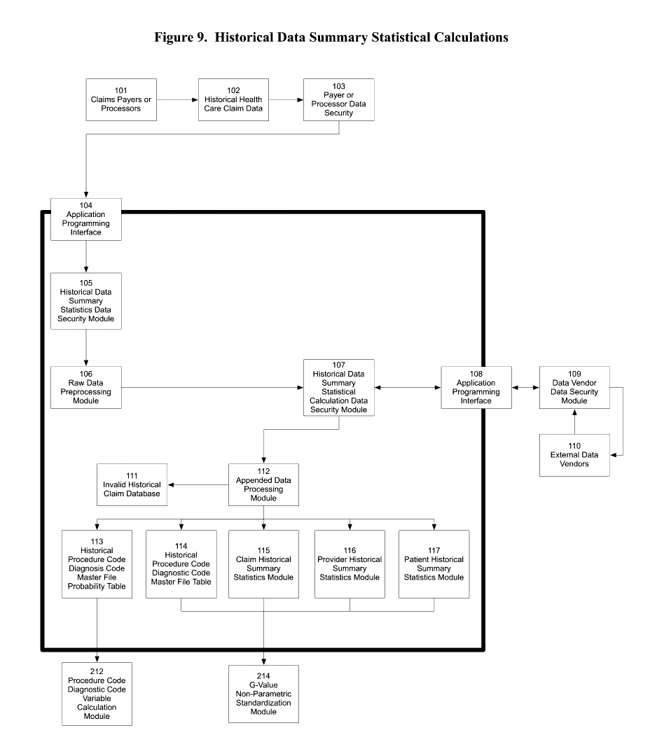

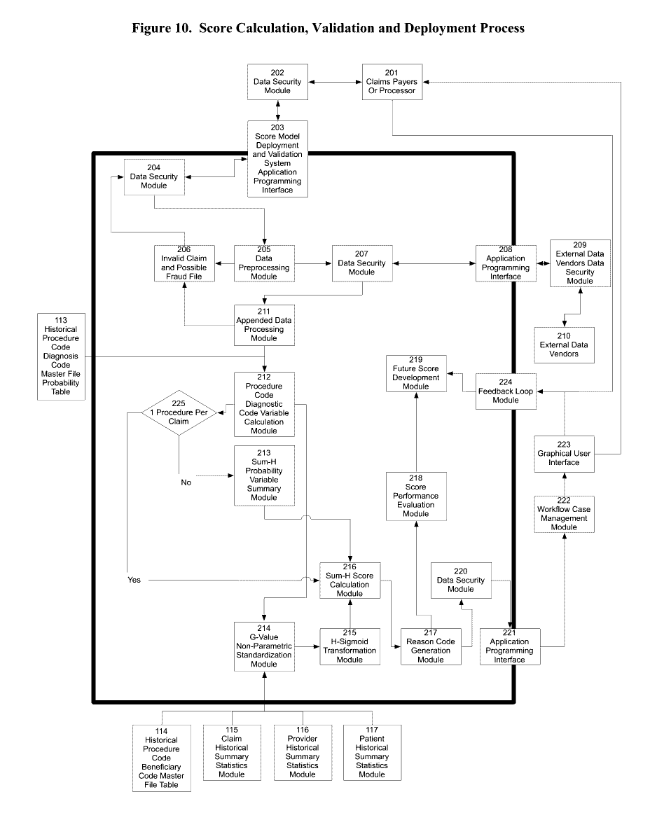

The inventive process is described in even more detail in FIGS. 9 and 10, below.

FIGS. 9 and 10 depict the preferred embodiments of the present invention for purposes of illustration. One skilled in the art will readily recognize from the following discussion that alternative embodiments of the structures and methods illustrated herein may be employed without departing from the principles of the invention described herein.

The fraud detection outlier scoring system requires a multi-phased development and implementation process. The first phase, development, creates the summary statistics based on historical claims data of relatively homogeneous peer groups of healthcare claims, providers and patients who either practice medicine or receive treatment in similar industry types, specialties and geographies. FIG. 9, documenting the Historical Data Summary Statistical Calculations, is an overview of the development phase architecture. This phase, defined as Phase I, uses previously processed claims from an historical file in order to calculate the normal, typical or expected behavior of a peer group of claims for patients or providers—defined as good behavior. This phase calculates summary statistics of historical performance of similar claims, providers, or patients, in similar specialties in similar geographies to establish normative peer group behavior values such as the median amount billed per patient, or the 75^{th} percentile of the number of patient claims over a period of time, one week, for example. The Historical Data Summary Statistical Calculations includes the general categories: Historical Claims from a previous time period supplied by single or multiple claims payers, data preprocessing to calculate summary statistics such as range, median and percentile values, access to external databases to obtain additional data (and/or link analysis), diagnosis code master file development to calculate prior probabilities for the procedure code/diagnosis code variable, and calculation of provider, patient and claim aggregate statistics segments or dimensions such as specialty groups and geographies. As described above in the summary, the phase I process is performed at regular intervals, such as yearly.

FIG. 10, documenting the Score Probability Calculation and Deployment Process, is an overview of the implementation phase architecture. This phase, defined as Phase II, scores current claims transactions, providers and patients to evaluate whether or not they appear to be similar or markedly different, defined as outliers, from the historical claims-based peer group. Phase II then calculates a score, represented as a probability of any characteristic associated with one observation in the data being an outlier, for a current claim, provider or patient as compared to the provider's peer group of claims or the patient's group of claims. The score compares an individual claim, provider, or patient's, characteristics on the current observation for a claim, or group of claims, such as a day, a week, a month or any other time-period trending characteristic, to the historical, accumulated behavior of the peer group for that provider's specialty and geography or the patient's peer group. The fraud detection outlier scoring models utilize a scoring implementation and deployment platform, with a GUI Fraud Risk Management queuing and display system in order to explain and validate why a fraud detection outlier score indicates fraud or abuse. It is also used to monitor and validate score performance. The Software as a Service (SaaS) score deployment platform design includes the following general categories:
1. Source of claim including claim payers and processors
2. Data Security
3. Application Programming Interface
4. Historical Claims Database Storage
5. Data Preprocessing
6. Database—Access to both Internal and External Data
7. Behavioral Scoring Engine
8. Scoring Process and Score Reason Generator
9. Variable Transformations and Score calculations indicating overall fraud risk
10. Workflow Decision Strategy Management
11. Fraud Risk Management which includes Queue and Case Management
12. Experimental Design Test and Control
13. Contact and Treatment Management Optimization
14. Graphical User Interface (GUI) Workstation
15. Workstation Reporting Dashboard for Measurements and Reporting
16. Actual Outcome Results Process (Feedback Loop)
17. Test, Validation and Performance Summary Module

In summary, the general mathematical sequence of data-preparation and score model development calculation steps expressed in FIG. 10 are as follows. For a reasonably large set of data, consisting of n-observations and k-variables:

1. Gather historical claim information. Process current claim transaction in real-time, or a batch of claims transactions summarized at the Claim, Provider or Patient level. Standardize the raw data variable values. This raw data transformation is the purpose of the non-parametric standardization formula (Raw data is here defined as the data in its original state as found on healthcare claims or as derived from those claims to create variables or as obtained from external data vendors. Examples include dollar amount of claim, number of claims submitted per day, etc.). This G-Transform uses the Modified Outlier Detection Technique developed to solve the problem of enlarged dispersion measures in Z-Score and IQR calculations. The Modified Outlier Detection Technique uses a non-parametric, ordinal measure (median, Q3), as the measure of dispersion to be used for centering, standardizing and scaling the data values in order to determine if an observation is an outlier. The Modified Outlier Detection Technique is used because the Z-Score is always negatively influenced in the presence of non-normal distributions and outliers. The IQR or Quartile Method is also negatively influenced as well. In illustration, consider the following for the Z-Score and IQR versus the Modified Outlier Detection Method proposed in this patent.

### Assume:

Z-Score>Z[score]=(x−mean)/(standard deviation)

Quartile Method>IQR[score]=(x−median)/(IQR/2)

In naturally positively and negatively skewed data the Z-Score and IQR measures of dispersion are always adversely affected. In positively skewed data, the following is always true.

Q2−Q1<Q3−Q2

Then

Q3+Q2−Q1<2Q3−Q2

Q3+Q2−Q1−Q2<2Q3−Q2−Q2

Q3−Q1<2(Q3−Q2)

(Q3−Q1)/2<Q3−Q2

Modified Outlier (High-Side)>G-Value[scoreHigh]=(x−median)/(Q3−Q2)

Modified Outlier (Low-Side)>G-Value[scoreLow]=(x−median)/(Q2−Q1)

Thus when positive skew is present, the Interquartile Method (Using Interquartile Range) denominator IQR/2 is always smaller than the Modified Outlier Technique (a more accurate estimate) for the same data. Therefore, the Interquartile Method will always cause more false-positives than the Modified Outlier Technique. When natural skew is present, the Modified Outlier Technique is more accurate because it reflects the more stable portion of the data.

The primary reason for the H[g] sigmoid transformation, calculating the H[g] probabilities, is to provide probability estimates for fraud detection outlier “scores”, or G-Values. Comparing actual raw Z-Scores with IQR-scores is misleading because they are derived from different distributional assumptions (Normality, symmetry, non-normality, etc). The most reasonable comparison of these statistics is probability estimates associated with each observation. The probabilities are normalized and comparable across segments or multiple dimensions, such as geographies or specialty groups.
The individual score model variable's raw data v-values are normalized by the nonparametric G-Transform formula of the Modified Outlier Detection Technique. The calculated standard score formula for each variable “G-Value” in the “score model” for each observation, using the Modified Outlier Detection Technique, is as follows:

G-Value→g[vₖ]=(vₖ−Medᵥ)/(β·Q3ᵥ−Medᵥ)

where Q3ᵥ−Medᵥ represents 25% of the distribution (75^{th} percentile minus the 50^{th} percentile). The 75^{th} percentile is used to detect outliers on the high end of the data distribution because the data has been processed so that the highest values in a distribution are the riskiest, and hence the objective is to find outlier observations on the high end of the data distribution. Beta, β, is a constant that allows the expansion or contraction of the g[v] equation denominator to reflect estimates of the criticality of performance of variable v. Therefore, Beta, β, is a weighting variable. If there is information available to make this variable more important, it can be given a weight greater than the default value, which is one (1.0). Conversely, if the variable is determined to be less important, it can be weighted by Beta, β, at less than the default value of one (1.0). A more detailed description of the development and low and high boundary values of the “G-Value” are as follows:
Using Q1, Q2, and Q3 the projected 0% and 100% points are established as the acceptance bounds, by

P[0%]=2·Q1−Q2; P[100%]=2·Q3−Q2

These bounds are in the dimensions of the metric, therefore they are scaled so that they are non-dimensional (facilitating comparisons and accumulations) by

high: G-Value→g[v]=(v−Q2)/(Q3−Q2);

low: G-Value→g[v]=(v−Q2)/(Q2−Q1)

Note that 0% and 100% boundaries are then g-scored as:

g[0%]=(2Q1−Q2−Q2)/(Q2−Q1)=−2(Q2−Q1)/(Q2−Q1)=−2

g[100%]=(2Q3−Q2−Q2)/(Q3−Q2)=2(Q3−Q2)/(Q3−Q2)=+2

And their boundary H-Values are:

H[g[v]≦g]=1/(1+e^{-λ·g});

H-Value Lower Bound→H[g[0%]=1/(1+e^{-1.1·-2})=˜0.1

H-Value High Bound→H[g[100%]=1/(1+e^{-1.1·2})=˜0.9

Therefore:

G-Value High Bound→g[v]≦2→ok, g[v]>2 questionable-high-outlier

G-Value Low Bound→g[v]>−2→ok, g[v]<−2 questionable-low-outlier

Although this technique applies to both the “High-Side of the distribution and the “Low-Side” of the distribution, the High-Side calculations are shown because the variables are scaled to reflect risky outliers as having High-Side values.
After calculating the g[x] values, convert them to H-Values, which are individual probability estimates for each variable for each observation. This variable is the probability estimate that the value associated with it is an outlier, and likely fraud or abuse. The calculation is a Cumulative Density Function (CDF) sigmoid calculation. (CDF is here defined as a formula that describes the probability distribution of a raw data variable). The H-Value individual variable probabilities convert the G-Value to a probability estimate to determine the degree of outlier-ness. Note that this probability is dimensionless (n-space), so it can be used for any number of dimensions, for example, specialty group, industry segment, or geography. The formula for the individual variable H-Value conversion is:

H-Value→H[g[x]g]=1/(1+e^{-λ·g})

where e is the mathematical constant e, Euler's constant, the base of natural logarithms, and Lambda λ is a scaling coefficient that equates the Q3 value equal g[v]=1 at the 75^{th} percentile. This Lambda λ value is =Ln [3] or ˜1.0986.
For the high-end of the distribution (the algebra's the same for the low-end) calculate an H-Value, which converts the G-Value to a probability using this sigmoid transformation:

H-Value→H[g[v]≦g]=1/(1+e^{-λ·g})

scale λ so that H[g=1]0.75

0.75=1/(1+e^{-λ})

e^{-λ}=1/3

λ=Ln [3]

and so

H-Value→H[g[v]≦g]=1/(1+3^{-g})

And their boundary H-Values for the low end and the high end of the distribution are:

H-Value Lower Bound→H[g[0%]=1/(1+3²)=0.1 (<0.1 questionable low outlier)

H-Value High Bound→H[g[100%]=1/(1+3⁻²)=0.9 (>0.9 questionable high outlier)

2. The actual score calculation step combines these “k” number of variable H-Values, the outlier probability estimate for each variable associated with a single observation, into a single “score” per observation to obtain the score value, _{Σ}H, termed “Sum-H”.
The formula for the _{Σ}H_{φ,δ} Sum-H is:

Sum-H→_{Σ}H_{φ,δ}=[Σ_{t=1,k}ωₜ·Hₜ^{φ+δ}]/[Σ_{t=1,k}ωₜ·Hₜ^{φ}]

where _{Σ}H, Sum-H, is the summary probability estimate of all of the normalized score variable probability estimates for the variables for one observation, which is the “score” for this observation, wₜ is the weight for variable Hₜ, φ (Phi) is a power value of Hₜ, such as 1, 2, 3, 4, etc. and δ (Delta) is a power increment which can be an integer and/or decimal, such as 1, 1.2, 1.8, 2.1, 3.0, etc. The score, _{Σ}H, Sum-H, will have a high value, near 1.0, if any or all of the individual variable “H-values” have high probability values near 1.0, thereby indicating that at least one, and perhaps more, of the variables for that observation have a high probability of being outliers or likely fraud or abuse. If there are 4 variables in a “Claim Score Model” for one observation and if the H-Value probabilities of being an outlier for each of the variables for a particular observation are 0.9, 0.1, 0.1, 0.1 and the Sum-H is 0.89. (φ (Phi)=2 and δ (Delta)=0.8 and ωₜ=1.0) Contrast this value, Sum-H of 0.89, with the arithmetic mean for the values (0.9, 0.1, 0.1, 0.1), which is 0.3. The Sum-H calculation will detect an outlier condition when the arithmetic mean does not. The high value of this Sum-H indicates that at least one of the four variables in this observation has a relatively high probability of being an outlier. Whereas, if the four variables for one observation have H-Values of 0.5, 0.5, 0.5, 0.5 the Sum-H would be 0.5, indicating that none of the variables associated with this observation have a high probability of being an outlier. These results are summarized in Table 7 below.

TABLE 7
Sum-H Total Score (φ (Phi) = 2 and δ (Delta) = .8 and ωₜ = 1.0)

| | X1 | X2 | X3 | X4 | Sum-H |
|---|---|---|---|---|---|
| Observation | H-Value | H-Value | H-Value | H-Value | Score |
| 1 | .9 | .1 | .1 | .1 | .87 |
| 2 | .5 | .5 | .5 | .5 | .50 |

The final step is to calculate score reasons that explain why this observation scored as it did by determining the individual variables that have the largest “H-Value”. These “H-Values” are ranked from highest absolute value to lowest. The highest value “H” variable is the corresponding number one reason why the score is as high as it is and so on down to the lowest “H-Value” variable.

Referring now to FIG. 9 as a perspective view of the technology, data system flow and system architecture of the Historical Data Summary Statistical Calculations there are potentially multiple sources of historical data housed at a healthcare Claim Payer or Processors Module 101 (data can also come from, or pass through, government agencies, such as Medicare, Medicaid and TRICARE, as well as private commercial enterprises such as Private Insurance Companies (Payers), Third Party Administrators, Claims Data Processors, Electronic Clearinghouses, Claims Integrity organizations that utilize edits or rules and Electronic Payment entities that process and pay claims to healthcare providers). The claim processor or payer(s) prepare for delivery historical healthcare claim data processed and paid at some time in the past, such as the previous year for example, Historical Healthcare Claim Data Module 102. The claim processor or payer(s) send the Historical Healthcare Claim Data from Module 102 to the Data Security Module 103 where it is encrypted. Data security is here defined as one part of overall site security, namely data encryption. Data encryption is the process of transforming data into a secret code by the use of an algorithm that makes it unintelligible to anyone who does not have access to a special password or key that enables the translation of the encrypted data to readable data. The historical claim data is then sent to the Application Programming Interface (API) Module 104. An API is here defined as an interaction between two or more computer systems that is implemented by a software program that enables the efficient transfer of data between the two systems. The API translates, standardizes or reformats the data according for timely and efficient data processing. The data is then sent via a secure transmission device, such as a dedicated fiber optic cable, to the Historical Data Summary Statistics Data Security Module 105 for un-encryption.

From the Historical Data Summary Statistics Data Security Module 105 the data is sent to the Raw Data Preprocessing Module 106 where the individual claim data fields are then checked for valid and missing values and duplicate claim submissions. The data is then encrypted in the Historical Data Summary Statistics External Data Security Module 107 and configured into the format specified by the Application Programming Interface 108 and sent via secure transmission device to an external data vendor's Data Vendor Data Security Module 109 for un-encryption. External Data Vendors Module 110 then append(s) additional data such as Unique Customer Pins/UID's (proprietary universal identification numbers), Social Security Death Master File, Credit Bureau scores and/or data and demographics, Identity Verification Scores and/or Data, Change of Address Files for Providers, including “pay to” address, or Patients/Beneficiaries, Previous provider or beneficiary fraud “Negative” (suppression) files or tags (such as fraud, provider sanction, provider discipline or provider licensure, etc.), Eligible Beneficiary Patient Lists and Approved Provider Payment Lists. The data is then encrypted in the Data Vendor Data Security Module 109 and sent back via the Application Programming Interface in Module 108 and then to the Historical Data Summary Statistics External Data Security Module 107 to the Appended Data Processing Module 112. If the external database information determines that the provider or patient is deemed to be deceased at the time of the claim or to not be eligible for service or to not be eligible to be reimbursed for services provided or is not a valid identity, at the time of the original claim date, the claim is tagged as “invalid historical claim” and stored in the Invalid Historical Claim Database 111. These claims are suppressed for claim payments and not used in calculating the summary descriptive statistical values for the fraud detection outlier score. They may be referred back to the original claim payer or processor and used in the future as an example of fraud. The valid claim data in the Appended Data Processing Module 112 is reviewed for valid or missing data and a preliminary statistical analysis is conducted summarizing the descriptive statistical characteristics of the data.

One copy of the data is then sent from the Appended Data Processing Module 112 to the Historical Procedure Code/Diagnosis Code Master File Probability Table in Module 113 to calculate the probability that the procedure codes listed on the claim are appropriate given the diagnosis code listed on the claim. The Procedure Code/Diagnosis Code Master File Table calculation is a process where the historical medical claim data file, segmented by industry type, is used to calculate a table of conditional probabilities for procedures billed given a diagnosis. This is based on prior claim history experience and the previous experience of all providers. This table of probabilities is termed the Diagnostic Code Master File (DCMF). The purpose of the Diagnostic Code Master File (DCMF) is to compute a probability-profile of claims that are submitted by providers. This historical table of conditional probabilities relates a specific procedure code, or group of procedure codes, to a specific diagnostic code (DC). The probability of a Procedure Code given a Diagnosis Code (P[PC|DC]) is the form of this probability. These conditional probabilities are derived from all the historical procedure and diagnosis claim records for a particular industry and geography gathered from past claims experience in the industry segment. This probability table accumulates the procedures used, associated with a given diagnosis on the claim.

The probability table is constructed using claim procedures as the columns, for example, and the claim diagnosis as the rows. To estimate these conditional probabilities, count the number of occurrences of the various reported procedure codes (PC's) for each specific diagnosis code (DC) throughout the history data file. Thus, for example if there are 287,874 occurrences of DC 4280 in the history file and PC 99213 occurs in 89,354 of them then P[PC 99213|DC 4280]=89,354/287,874=0.3104. In order to maintain a consistent trend that “higher number values indicate higher risk of fraud”, the compliment of the (P[PC|DC]) is used instead of the calculated probability of PC:DC. Therefore, the probability of PC 99213 NOT occurring with DC 4280 is 1-0.3104 or 0.6896. An example of a part of the DCMF is a Procedure Probability Table with counts converted to probabilities in the cells of the table is shown in Table 8.

TABLE 8
Probability PC:DC and Probability of PC′:DC

| Diagnosis | Procedure | | # | | 1- |
|---|---|---|---|---|---|
| Code | Code | HCPCS | Procedures | P[PC:DC] | (P[PC:DC]) |
| 4280 | 99213 | 99213 | 89,354 | 0.3104 | 0.6896 |
| CON- | PATIENT | | | | |
| GESTIVE | VISIT | | | | |
| HEART | | | | | |
| FAILURE | | | | | |
| 4280 | 71010 | 71010 | 71,356 | 0.2479 | 0.7521 |
| CON- | X-RAY | | | | |
| GESTIVE | CHEST | | | | |
| HEART | | | | | |
| FAILURE | | | | | |
| 4280 | 93010 | 93010 | 51,789 | 0.1799 | 0.8201 |
| CON- | ECG- | | | | |
| GESTIVE | REPORT | | | | |
| HEART | | | | | |
| FAILURE | | | | | |
| 4280 | G0001 | G0001 | 41,678 | 0.1448 | 0.8552 |
| CON- | DRAW | | | | |
| GESTIVE | BLOOD | | | | |
| HEART | | | | | |
| FAILURE | | | | | |
| 4280 | 93307 | 93307 | 33,654 | 0.1169 | 0.8831 |
| CON- | ECHO- | | | | |
| GESTIVE | CARDIO | | | | |
| HEART | EXAM | | | | |
| FAILURE | | | | | |
| 4280 | 77413 | 77413 | 43 | 0.0001 | 0.9999 |
| CON- | RADIA- | | | | |
| GESTIVE | TION | | | | |
| HEART | TREAT- | | | | |
| FAILURE | MENT | | | | |

Note that for every 100 Diagnoses of congestive Heart Failure, a Chest X-Ray related procedure PC 71010 occurs about 25 times (0.2479). Therefore, the probability of a Chest X-ray procedure occurring with a Congestive Heart Disease diagnosis is 0.2479. Or, conversely, the probability of a Chest X-Ray related procedure NOT occurring with Congestive Heart Disease diagnosis is 0.7521. On the other hand, the occurrence of a Radiation Treatment with a diagnosis of Congestive Heart Failure Disease is only about 1 procedure in 10,000 Congestive Heart Failure diagnoses. Therefore, the probability of a Radiation Treatment co-occurrence with Congestive Heart Failure is 0.0001 or the probability of a Radiation Treatment NOT occurring with Congestive Heart Failure is 0.9999. Note that this probability is dimensionless (n-space), so it can be used for any number of dimensions, for example, specialty, industry segment, or geography. This historical conditional probability table is then used to calculate the variable used in the current claim score model variable values for the “Inconsistency Coefficient” (IC) in Procedure Code Diagnostic Code Variable Calculation Module 212. These measures are used as fraud detection score model variables, and as used in this invention are measures of the degree of similarity and dissimilarity (Consistency/Inconsistency) of the type and number, expressed as a probability, of the procedures code given a particular diagnosis.

If there is a fee schedule available for this industry type, the fee schedule is used as the Historical Procedure Code Diagnosis Code Master File Table 114 and summary non-parametric statistical values, such as percentiles, are calculated from the fee schedule and output to the Historical Procedure Code Diagnostic Code Master File Table 114. The cost table is then used to calculate the variable used in the current claim score model variable values for the expected cost per procedure in variable G-Value Non-Parametric Standardization Module 214.

If there is no fee schedule available, another copy of the data is sent from the Appended Data Processing Module 112 to the Historical Procedure Code Diagnostic Code Master File Table 114 to calculate the summary non-parametric statistics, such as median and percentile values of the cost, or fee charged, for the procedure codes listed on the claim given the diagnosis code listed on the claim. The Procedure Code Master File Cost Table calculation is a process where the historical medical claim data file, segmented by industry type, is used to calculate the non-parametric statistics for the cost for procedures billed on a claim given a diagnosis based on prior claim history experience of all providers (This data may also be segmented by geography, such as urban/rural or by state, for example). This table of costs is termed the Historical Procedure Code Diagnostic Code Master File Table 114.

One part of the Cost Table is shown in Table 9 for Industry Type Physician, Specialty Orthopedics and Geography Georgia. Only the Median fees and 75^{th} percentile fees for this table cell are shown, however all vigintiles may also be calculated.

TABLE 9
Part of the Procedure Code Master File Cost Table
Procedure Code Cost Table

| Industry Type | Physician |
|---|---|
| Specialty | Orthopedics |
| Geography | Georgia |
| Procedure Code Text | Office Visit |
| Median Fee | $125 |
| 75th Percentile Fee | $160 |

This cost table is then used to calculate the expected cost for this procedure in G-Value Non-Parametric Standardization Module 214.

Another copy of claim data is sent from the Appended Data Processing Module 112 to the Claim Historical Summary Statistics Module 115 where the individual values of each claim are accumulated into claim score calculated variables by industry type, provider, patient, specialty and geography. Examples of individual claim variables include, for example, but are not limited to: fee amount submitted per claim, sum of all dollars submitted for reimbursement in a claim, number of procedures in a claim, number of modifiers in a claim, change over time for amount submitted per claim, number claims submitted in the last 30/60/90/360 days, total $ amount of claims submitted in the last 30/60/90/360 days, comparisons to 30/60/90/360 trends for amount per claim and sum of all dollars submitted in a claim, ratio of current values to historical periods compared to peer group, time between date of service and claim date, number of lines with a proper modifier, ratio of amount of effort required to treat the diagnosis compared to the amount billed on the claim.

Within the Claim Historical Summary Statistics Module 115, historical descriptive statistics are calculated for each variable for each claim by industry type, specialty and geography. Calculated historical summary descriptive statistics include measures such as the median and percentiles, including deciles, quartiles, quintiles or vigintiles. Examples of historical summary descriptive non-parametric statistics for a claim would include values such as median number of procedures per claim, median number of modifiers per claim, median fee charged per claim. An example of a part of the Claim Summary Statistics table to create one variable, Median number Procedures per claim in the last 30, 60, 90 or 360 days, is shown in Table 10.

TABLE 10
Part of Claim Summary Statistics Table
Claim Summary Statistics

| | |
|---|---|
| Industry Type | Physician |
| Specialty | Orthopedics |
| Geography | Georgia |
| Median # Procedures/Claim | 3.45 |
| 75th Percentile # Procedures/ | 5.85 |
| Claim | |

Only the Median number Procedures per Claim and 75^{th} percentile number Procedures per Claim for this table cell are shown, however all vigintiles, for example, may be calculated. Other individual claim variables are also calculated in this module. One variable, for example, is the ratio of the amount of effort used by the provider to cure the illness burden, as reflected by the claim procedures codes, compared to the seriousness of the patient illness, as reflected by the claim diagnosis code. Other claim variables include (but are not limited to) items such as, Fee amount submitted per claim, sum of all dollars submitted for reimbursement in a claim, number of procedures in a claim, number of modifiers in a claim, change over time for amount submitted per claim, number claims submitted in the last 30/60/90/360 days, total $ amount of claims submitted in the last 30/60/90/360 days, comparisons to 30/60/90/360 trends for amount per claim and sum of all dollars submitted in a claim, ratio of current values to historical periods compared to peer group, time between date of service and claim date, number of lines with a proper modifier.

The historical summary descriptive statistics for each variable in the score model are used by G-Value Non-Parametric Normalization Module 214 in order to calculate normalized variables related to the individual variables for the scoring model.

Another copy of the data is sent from the Appended Data Processing Module 112 to the Provider Historical Summary Statistics Module 116 where the individual values of each claim are accumulated into claim score variables by industry type, provider, specialty and geography. Examples of individual claim variables include (but are not limited to): amount submitted per claim, sum of all dollars submitted for reimbursement in a claim, number of patients seen in 30/60/90/360 days, total dollars billed in 30/60/90/360 days, number months since provider first started submitting claims, change over time for amount submitted per claim, comparisons to 30/60/90/360 trends for amount per claim and sum of all dollars submitted in a claim, ratio of current values to historical periods compared to peer group, time between date of service and claim date, number of lines with a proper modifier.

Within Provider Historical Summary Statistics Module 116, historical summary descriptive statistics are calculated for each variable for each Provider by industry type, specialty and geography. Calculated historical descriptive statistics include measures such as the median, range, minimum, maximum, and percentiles, including deciles, quartiles, quintiles and vigintiles for the Physician Specialty Group. In Table 11 below, for all Providers with Specialty Type “Orthopedics”, for the state of Georgia for amount submitted per claim is presented. Both median amount submitted per claim for all physicians and the 75^{th} percentile of amount submitted per office visit claim for all physicians in the orthopedics specialty group in the state of Georgia are presented. An example of one part of the Provider Summary Statistics Table for median fee per claim is shown in Table 11 (This variable may be calculated for the last 30, 60, 90 or 360 days).

TABLE 11
Part of Provider Summary Statistics Table
Provider Summary Statistics

| | |
|---|---|
| Industry Type | Physician |
| Specialty | Orthopedics |
| Geography | Georgia |
| Median Fee per Claim | $745.56 |
| 75th Percentile Fee per | $1,238.72 |
| Claim | |

Only the median fees and 75^{th} percentile fees for this table cell are shown, however all vigintiles, for example, may be calculated. The Provider Historical Summary Statistics Module 116 for all industry types, specialties and geographies are then used by the G-Value Non-Parametric Standardization Module 214 to create normalized variables for the scoring model.

Another copy of the data is sent from the Appended Data Processing Module 112 to the Patient Historical Summary Statistics Module 117. The historical summary descriptive statistics are calculated for the individual values of the claim and are accumulated for each claim score variable by industry type, patient, provider, specialty and geography for all Patients who received a treatment (or supposedly received). An example of this type of aggregation would be all claims filed by a patient in Specialty Type “Orthopedics”, in the state of Georgia for number of office visits in last 12 months 12 would for example be 30, 60, 90 or 360 days), median distance traveled to see the Provider, etc. An example of one part of the Patient Summary Statistics Table is shown in Table 12.

TABLE 12
Part of Patient Summary Statistics Table
Patient Summary Statistics

| | |
|---|---|
| Industry Type | Physician |
| Specialty | Orthopedics |
| Geography | Georgia |
| Median # Office Visits in 12 | 2.4 |
| Months | |
| 75th Percentile # Office Visits in 12 | 5.7 |
| Months | |

Only the Median Visits and 75^{th} percentile Visits for this table cell are shown, however all vigintiles, for example, may be calculated. The Patient Historical Summary Statistics 117 for all industry types, specialties and geographies is then used by the G-Value Non-Parametric Standardization Module 214 to create normalized variables.

Referring now to FIG. 10 as a perspective view of the technology, data system flow and system architecture of the Score Calculation, Validation and Deployment Process there is shown a source of current healthcare claim data sent from Healthcare Claim Payers or Claims Processor Module 201 (data can also come from, or pass through, government agencies, such as Medicare, Medicaid and TRICARE, as well as private commercial enterprises such as Private Insurance Companies, Third Party Administrators, Claims Data Processors, Electronic Clearinghouses, Claims Integrity organizations that utilize edits or rules and Electronic Payment entities that process and pay claims to healthcare providers) for scoring the current claim or batch of claims aggregated to the Provider or Patient/Beneficiary level. The claims can be sent in real time individually, as they are received for payment processing, or in batch mode such as at end of day after accumulating all claims received during one business day. Real time is here defined as processing a transaction individually as it is received. Batch mode is here defined as an accumulation of transactions stored in a file and processed all at once, periodically, such as at the end of the business day. Claim payer(s) or processors send the claim data to the Claim Payer/Processor Data Security Module 202 where it is encrypted.

The data is then sent via a secure transmission device to the Score Model Deployment and Validation System Application Programming Interface Module 203 and then to the Data Security Module 204 within the scoring deployment system for un-encryption. Each individual claim data field is then checked for valid and missing values and is reviewed for duplicate submissions in the Data Preprocessing Module 205. Duplicate and invalid claims are sent to the Invalid Claim and Possible Fraud File 206 for further review or sent back to the claim payer for correction or deletion. The remaining claims are then sent to the Internal Data Security Module 207 and configured into the format specified by the External Application Programming Interface 208 and sent via secure transmission device to Data Security Module 209 for un-encryption. Supplemental data is appended by External Data Vendors 210 such as Unique Customer Pins/UID's (proprietary universal identification numbers) Social Security Death Master File, Credit Bureau scores and/or data and demographics, Identity Verification Scores and/or Data, Change of Address Files for Providers or Patients/Beneficiaries Previous provider or beneficiary fraud “Negative” (suppression) files, Eligible Patient and Beneficiary Lists and Approved Provider Lists. The claim data is then sent to the External Data Vendors Data Security Module 209 for encryption and on to the External Application Programming Interface 208 for formatting and sent to the Internal Data Security Module 207 for un-encryption. The claims are then sent to the Appended Data Processing Module 211, which separates valid and invalid claims. If the external database information (or link analysis) reveals that the patient or provider is deemed to be inappropriate, such as deceased at the time of the claim or to not be eligible for service or not eligible to be reimbursed for services provided or to be a false identity, the claim is tagged as an inappropriate claim or possible fraud and sent to the Invalid Claim and Possible Fraud File 206 for further review and disposition.

One copy of the individual valid claims are sent from the Appended Data Processing Module 211 to the Procedure Code/Diagnostic Code Variable Calculation Module 212 to create a single score model variable that measures the likelihood of a procedure being used with a diagnosis based on the concept of consistency/inconsistency by calculating the likelihood that a claim's Procedure Code, or Codes, are appropriate to accompany the Diagnostic Code listed on the claim. The consistency/inconsistency concept is used to create these variables in the following manner. To calculate the likelihood that a claim's Procedure Code, or codes, is appropriate to accompany the claim's Diagnostic Code, the system accesses the already constructed table, the Historical Procedure Code Diagnosis Code Master File Probability Table 113, and compares the current claim procedure codes, given a diagnosis, to the historical performance of a large number of claims processed previously.

The Procedure Code/Diagnostic Code Variable Calculation Module 212 calculates the probability for one procedure code or for each of many procedure codes on a claim, given the diagnosis code, in the following manner. This process compares the historical table of conditional probabilities to the current claim procedure codes and the diagnostic code to estimate the likelihood that procedure codes (PC) currently being processed are likely to be performed given the diagnosis code (DC). For example, if the current claim being processed has 4 procedure codes associated with 1 diagnostic code and the Historical Procedure Code Diagnosis Code Master File Probability Table 113 shows that each of those procedure codes has a high historical probability of being associated with that particular diagnostic code, then it is highly likely that they “belong” together. These individual, conditional probabilities linking treatment-procedure to diagnosis should generally and consistently be fairly large if the procedure-diagnosis relationship is legitimate since a procedure performed should be strongly related to the condition-diagnosis it is treating. If this is not the case, if the treatment and the diagnosis are not related based on historical experience, then the conditional probability in the corresponding table cell will be small. For example, if the 4 procedure codes in the current claim, when compared to the same 4 procedure codes in the Historical Procedure Code Diagnosis Code Master File Probability Table 113, each have a high probability, for example 0.5 or higher, of being associated with the claim's diagnostic code, it is likely that procedures in this current claim are “consistent” with the claim diagnosis and the current claim procedures and diagnosis “belong” together. Once the values of the conditional probabilities for the appropriate cell in the Historical Procedure Code Diagnosis Code Master File Probability Table 113 are selected, there is one additional step to be performed in the Procedure Code/Diagnostic Code Variable Calculation Module 212. In order to preserve the concept of “high values represent high likelihood of being an outlier”, rather than use the conditional probability found in the corresponding cell of the Historical Procedure Code Diagnosis Code Master File Probability Table 113, the probability that a procedure is used given a diagnosis (p[P|D]), the present invention uses the compliment of the conditional probability of the procedure given the diagnosis (p[P|D]) which is the probability the procedure will not be used given the diagnosis. In this way, the high value is consistent with all other measures of fraud risk in the invention, where a high value means high-risk of being an outlier. This means that the “inconsistent” state is a high probability value for claims containing one or more outliers. For example, if a procedure in the current claim is found to have an historical probability of 0.8 of being associated with the current claim diagnosis, then that procedure has a 1−0.8 or, 0.2 probability of not being associated with the current claim diagnosis. Conversely, of the procedure has a 0.05 probability of being associated with the current claim diagnosis, then it has a 1−0.05 or, 0.95 probability of not being associated with the current claim diagnosis. If there is only one procedure code, the single probability of not being associated with the diagnosis for this claim the single probability value is termed the “Inconsistency Coefficient” (IC) and is output as one variable to the Procedure Code Decision Module 225. Inconsistency Coefficient is here defined as a single, scalar probability value that measures the likelihood that the one procedure code probability or any one of the multiple conditional probabilities of a procedure code occurring given a diagnosis code is not consistent with the historical prior probabilities as calculated in the Historical Procedure Code Diagnosis Code Master File Probability Table 113. The claim is sent from the Procedure Code Diagnostic Code Variable Calculation Module 212 to the Procedure Code Decision Module 225.

The Procedure Code Decision Module 225 determines if there are multiple procedures on the claim, the vector of probabilities associated with each PC/DC combination created in this Procedure Code/Diagnostic Code Variable Calculation Module 212, or if there is a single procedure code on the claim. If there are multiple procedure codes on the claim, then this vector of probabilities is output to the Sum-H Probability Variable Summary Module 213 in order to calculate a single measure of the risk of an outlier occurring in the vector of procedure probabilities. This single measure is termed the Inconsistency Coefficient and will be included in the score model as a single variable.

If there is a single procedure on the claim, then the Inconsistency Coefficient is sent from the Procedure Code Decision Module 225 to the Sum-H Score Calculation Module 216.

The Sum-H Probability Variable Summary Module 213 utilizes the Sum-H calculation, which is a generalized procedure that calculates one value to represent the overall values of a group of numbers. For the Inconsistency Coefficient, for example, the Sum-H Probability Variable Summary Module 213 calculates, for a set of k Probabilities p1, p2, . . . , pk, the likelihood of a Procedure Code (PC) not accompanying a Diagnosis Code (p[P′|D]) and converts this vector of k probabilities into a single generalized summary variable that represents the overall risk of PC not occurring given the Diagnosis Code. The Sum-H, that calculates the Inconsistency Coefficient, is defined for control-coefficients φ and δ, as follows:

Sum-H[P]=(Σ_{t=1,k}Pₜ^{φ+δ})(Σ_{t=1,k}Pₜ^{φ}); 0≦P≦1, −∞<φ,δ<∞

The Inconsistency Coefficient (IC) value is then sent to the Sum-H Score Calculation Module 216 as the one value representing the probability that one or more of the Procedure Codes is not consistent with the Diagnostic Code on the Claim.

One copy of the individual valid current claim or batch of claims is also sent from the Appended Data Processing Module 211 to the G-Value Non-Parametric Standardization Module 214 in order to create claim level variables for the score model. In order to perform this calculation the G-Value Non-Parametric Standardization Module 214 needs both the current claim or batch of claims from the Appended Data Processing Module 211 and a copy of each individual valid claim statistic sent from the Historical Procedure Code Diagnosis Code Master File Table in Module 114, Claim Historical Summary Statistics Module 115, Provider Historical Summary Statistics Module 116 and Patient Historical Summary Statistics Module 117. The G-Value Non-Parametric Standardization Module 214 converts raw data individual variable information into non-parametric values. When using the raw data from the claim, plus the statistics about the claim data from the Historical Claim Summary Descriptive Statistics file modules, the G-Value Non-Parametric Standardization Module 214 creates G-Values for the scoring model. The individual claim variables are matched to historical summary claim behavior patterns to calculate the current individual claim's deviation from the historical behavior pattern of a peer group of claims. These individual and summary evaluations are non-parametric, value transformations of each variable related to the individual claim.

In order to create Expected Cost variables for the score model, one copy of each individual claim is sent from the Historical Procedure Code Diagnostic Code Master File Table in Module 114 to the G-Value Non-Parametric Standardization Module 214. The G-Value Non-Parametric Normalization Module 214 creates normalized variables by matching the corresponding variable's information from module 114 variable parameters to calculate the current individual claim's deviation from the historical values for the same procedure. These deviation evaluations are non-parametric, normalized value transformations of each variable related to the individual claim. The expected cost per claim is calculated as follows. We define the Expected Cost per Procedure EC$/P for each diagnosis code based on the conditional probability of the associated procedure codes:

EC$/P=(Σ_{t=1,k}p[PCₜ|DC]·C$ₜ)(Σ_{t=1,k}p[PCₜ|DC])

where k is the number of procedure codes related to that specific diagnosis code, and C$ is the standard cost for that procedure from Historical Procedure Code Diagnostic Code Master File Table 114. Thus EC$/P is a probability-weighted expected cost for a single procedure based on all the appropriate procedures for that diagnosis code. The normalized values are calculated as follows:

Medᵥ=median EC$/P value at that level

Q3ᵥ=third quartile v at that level (The Q3ᵥ can be any vigintile above the median—Note that the higher the vigintile value, the smaller the value of the calculated value of g[vₖ]).

Recall, an example of the Medᵥ and Q3ᵥ values accessed from the Historical Provider Summary Descriptive Statistics Module 116 and are shown from Table 13.

TABLE 13
Expected Cost Example
Expected Cost Per Procedure Given Diagnosis Summary Statistics

| Industry Type | Physician |
|---|---|
| Specialty | Orthopedics |
| Geography | Georgia |
| Median Fee per Claim Given Diagnosis Arthroscopic | $876.96 |
| Shoulder Repair | |
| 75th Percentile Fee per Claim | $1,438.82 |

Therefore, for variable “v”, number Median Fee/Claim, in order to calculate the non-parametric “standard-score” EC$/P for that variable, for provider k on the current claim summary variable, EC$/P, the calculated standard score formula is:

g[vₖ]=(vₖ−Medᵥ)/β·Q3ᵥ−Medᵥ)

where Q3ᵥ−Medᵥ represents 25% of the distribution (75^{th} percentile minus the 50^{th} percentile). Note that the third quartile is used here as an example. Other percentile values could be used. It is noted that the higher the percentile, such as 80th or 85^{th}, the lower will be the Non-parametric Score. Where β is a constant that allows the expansion or contraction of the g[v] equation denominator to reflect estimates of the criticality of performance, variable v. When there is no discriminating sense of criticality, then the default value for β is 1 (This can change with experience or other a priori information). Note that, in general, g[vₖ] is dimensionless (v/v), and that the following are true:

If vₖ>β·Q3ᵥ then g[vₖ]>1

If vₖ=β·Q3ᵥ then g[vₖ]=1

If Medᵥ≦vₖ<β·Q3ᵥ then 0≦g[vₖ]<1

If vₖ<Medᵥ then g[vₖ]<0

All of the non-parametric standard score variables created in the G-Value Non-Parametric Standardization Module 214, are then sent to the H-Sigmoid Transformation Module, 215. The purpose of the H-Sigmoid Transformation Module, 215 is to transform the raw, non-parametric normalized value of each variable in the fraud detection score model to an estimate of the probability that this value likely fraud or abuse.

In order to create normalized variables for the individual claim, the process begins by accessing the claim data for the variables related to the claim from the Historical Claim Summary Descriptive Statistics Module 115 for any variable “v”. The normalized values calculated in G-Value Non-Parametric Standardization Module 214 for any variable “v” are as follows. The real, positive variable “v”, which for example is a dollar-value, or a counting such as amount submitted per claim, sum of all dollars submitted for reimbursement in a claim, time between date of service and claim date, number of lines with a proper modifier on a claim, number of procedures per claim, etc.

Medᵥ=median v value at that level

Q3ᵥ=third quartile v at that level (The Q3ᵥ can be any vigintile above the median—Note that the higher the vigintile value, the smaller the value of the calculated value of g[vₖ] and therefore, the less likely to be considered an outlier).

Recall, an example of the Medᵥ and Q3ᵥ values accessed from Historical Claim Summary Descriptive Statistics file 115 are shown in Table 14.

TABLE 14
Part of Claim Summary Statistics Table
Claim Summary Statistics

| | |
|---|---|
| Industry Type | Physician |
| Specialty | Orthopedics |
| Geography | Georgia |
| Median # Procedures/Claim | 3.45 |
| 75th Percentile # Procedures/ | 5.85 |
| Claim | |

Therefore, for variable “v”, number Procedures/Claim, in order to create the non-parametric “standard-score” for “v” claim variable, on the current single claim vₖ, the calculated standard score formula is:

g[vₖ]=(vₖ−Medᵥ)/(β·Q3ᵥ−Medᵥ)

where Q3ᵥ−Medᵥ represents 25% of the distribution (75^{th} percentile minus the 50^{th} percentile). Note that the third quartile is used here as an example. Other percentile values could be used. It is noted that the higher the percentile, such as 80th or 85^{th}, the lower will be the non-parametric normalized score. Beta, β, is a constant that allows the expansion or contraction of the g[v] equation denominator to reflect estimates of the criticality of performance, variable v. If the variable is considered more important, it can be given a higher weight, β value, and if it is deemed to be less important, it can be given a lower weight. When there is no discriminating sense of criticality, then the default value for β is 1 (This can change with experience or other a priori information).

Note that, in general, g[vₖ] is dimensionless (v/v), and that the following are true:

If vₖ>β·Q3ᵥ then g[vₖ]>1

If vₖ=β·Q3ᵥ then g[vₖ]=1

If Medᵥ≦vₖ<β·Q3ᵥ then 0≦g[vₖ]<1

If vₖ<Medᵥ then g[vₖ]<0

As an example, if the number of procedures for the current claim under review is “5” then the calculated g[vₖ] value for that variable for the current claim is: (5−3.45)/(1*5.85−3.45) omitting the β multiplication by 1.0 from the formula yields (5−3.45)/(5.85−3.45)=(1.55)/(2.44)=0.646. If the number of procedures for the current claim under review is “16” then the calculated g[vₖ] for that variable for the current claim is: (16−3.45)/(5.85−3.45)=(12.55)/(2.44)=5.23. Note that if 4.0, or greater, is considered the threshold value for classification as an outlier, the value in the first example, 0.646 (Representing “5 Procedures per claim”) would not be considered an outlier. However, the second example of 5.23 (Representing 16 Procedures per Claim) is +5.23 and would be considered an outlier.

In order to create Provider Level variables for the score model, one copy of each summarized batch of claims per Provider is sent from the Historical Provider Summary Descriptive Statistics file in Module 116 to the G-Value Non-Parametric Standardization Module 214. The G-Value Non-Parametric Standardization Module 214 is a claim processing calculation where current, score model summary normalized variables are created by matching the corresponding variable's information from Historical Provider Summary Descriptive Statistics file in Module 116 variable parameters to the current summary behavior pattern to calculate the current individual provider's claim's deviation from the historical behavior pattern of a peer group of providers in the current claim provider's specialty, geography. These individual and summary evaluations are non-parametric, normalized value transformations of each variable related to the individual claim or batch of claims. The normalized values are calculated as follows. The real, positive variable “v”, which for example is a dollar-value or a counting of variables such as amount submitted per claim, sum of all dollars submitted for reimbursement in a claim, number of patients seen in 30/60/90/360 days, total dollars billed in 30/60/90/360 days, change over time for amount submitted per claim, comparisons to 30/60/90/360 trends for amount per claim and sum of all dollars submitted in a claim, ratio of current values to historical periods compared to peer group, etc.

The analysis begins by accessing the data for the variables related to the claim from the Historical Provider Summary Descriptive Statistics Module 116 for variable “v”.

Medᵥ=median v value at that level

Q3ᵥ=third quartile v at that level (The Q3ᵥ can be any vigintile above the median—Note that the higher the vigintile value, the smaller the value of the calculated value of g[vₖ]).

Recall, an example of the Medᵥ and Q3ᵥ values accessed from the Historical Provider Summary Descriptive Statistics Module 116 and are shown from Table 15.

TABLE 15
Part of the Historical Provider Summary Descriptive Statistics
Provider Summary Statistics

| | |
|---|---|
| Industry Type | Physician |
| Specialty | Orthopedics |
| Geography | Georgia |
| Median Fee per Claim | $745.56 |
| 75th Percentile Fee per | $1,238.72 |
| Claim | |

Therefore, for variable “v”, number Median Fee per Claim, in order to calculate the non-parametric “standard-score” the v for that variable, for provider k on the current claim summary variable, vₖ, the calculated standard score formula is:

g[vₖ]=(vₖ−Medᵥ)/(β·Q3ᵥ−Medᵥ)

where Q3ᵥ−Medᵥ represents 25% of the distribution (75^{th} percentile minus the 50^{th} percentile). Note that the third quartile is used here as an example. Other percentile values could be used. It is noted that the higher the percentile, such as 80th or 85^{th}, the lower will be the Non-parametric Normalized Score. Beta, β, is a constant that allow us to expand or contract the g[v] equation denominator to reflect estimates of the criticality of performance, variable v. When there is no discriminating sense of criticality, then the default value for β is 1 (This can change with experience or other a priori information). Note that, in general, g[vₖ] is dimensionless (v/v), and that the following are true:

If vₖ>β·Q3ᵥ then g[vₖ]>1

If vₖ=β·Q3ᵥ then g[vₖ]=1

If Medᵥ≦vₖ<β·Q3ᵥ then 0≦g[vₖ]<1

If vₖ<Medᵥ then g[vₖ]<0

As an example, if the Median Fee per Claim for the batch of Provider Claims currently being reviewed is “$956.80” then the calculated g[vₖ] value for that variable for the current claim is: ($956.80−$745.56)/(1*$1,238.72−$745.56) omitting the β multiplication by 1.0 yields ($956.80−$745.56)/($1,238.72−$745.56)=(211.24)/(493.16)=0.428. If the Median Fee per Claim for the current batch of Provider claims being reviewed is “$2,916.78” then the calculated g[vₖ] for that variable for the current claim is: (“$2,916.78−$745.56)/($1,238.72−$745.56)=(12.55)/(2.44)=4.403. Note that if 4.0, or greater, is considered the threshold value for classification as an outlier, the value in the first example, 0.428 (Representing the “Median Fee of $956.80 per claim”) would not be considered an outlier. However, the second example of 4.403 (Representing the “Median Fee of $2,916.78 per Claim”) would be considered an outlier, and likely fraud or abuse.

In order to create Patient Level variables for the score model, one copy of each summarized batch of claims per Patient is sent from the Historical Summary Patient Descriptive Statistics file in Module 117 to the G-Value Non-Parametric Standardization Module 214. The G-Value Non-Parametric Standardization Module 214 is a claim processing calculation where current, patient claim summary normalized variables are created by matching the correspond variable's information from Historical Patient Summary Descriptive Statistics file in Module 117 variable parameters to the current claim summary behavior pattern to calculate the current individual patient batch of claim's deviation from the historical behavior pattern of a peer group of provider's patients in the current claim provider's specialty, geography. These individual and summary evaluations are non-parametric, normalized value transformations of each variable related to the individual claim or batch of claims. The normalized values are calculated as follows. The real, positive variable “v”, which for example is a dollar-value, or a counting such as: number of office visits in last 12 months (12 would for example be 30, 60, 90 or 360 days, Median distance traveled to see the Provider, etc.

The analysis begins by accessing the data for the variables related to the claim from the Historical Patient Summary Descriptive Statistics file 117 for variable “v”.

Medᵥ=median v value at that level

Q3ᵥ=third quartile v at that level (The Q3ᵥ can be any vigintile above the median—Note that the higher the vigintile value, the smaller the value of the calculated value of g[vₖ]).

Recall, an example of the Medᵥ and Q3ᵥ values accessed can be shown from Table 16.

TABLE 16
Part of Patient Summary Statistics Table
Patient Summary Statistics

| | |
|---|---|
| Industry Type | Physician |
| Specialty | Orthopedics |
| Geography | Georgia |
| Median # Office Visits in 12 | 2.4 |
| Months | |
| 75th Percentile # Office Visits in 12 | 5.7 |
| Months | |

Therefore, for variable “v”, “Median number Office Visits in Last 12 Months”, in order to “standard-score” (This is a non-parametric standard score) the v for that variable, for provider k on the current claim summary variable, vₖ, the calculated standard score formula is:

g[vₖ]=(vₖ−Medᵥ)/(β·Q3ᵥ−Medᵥ)

where Q3ᵥ−Medᵥ represents 25% of the distribution (75^{th} percentile minus the 50^{th} percentile). Note that the third quartile is used here as an example. Other percentile values could be used. It is noted that the higher the percentile, such as 80th or 85^{th}, the lower will be the non-parametric normalized score and the less likely it will be to detect an observation as an outlier. The β is a constant that allows expansion or contraction of the g[v] equation denominator to reflect estimates of the criticality of performance, variable v. When there is no discriminating sense of criticality, then the default value for β is 1 (This can change with experience or other a priori information). Note that, in general, g[vₖ] is dimensionless (v/v), and that the following are true:

If vₖ>β·Q3ᵥ then g[vₖ]>1

If vₖ=β·Q3ᵥ then g[vₖ]=1

If Medᵥ≦vₖ<β·Q3ᵥ then 0≦g[vₖ]<1

If vₖ<Medᵥ then g[vₖ]<0

As an example, if the Median number Patient Office Visits in Last 12 Months for the batch of Patient Claims currently being reviewed is “3.5” then the calculated g[vₖ] value for that variable for the current claim is: (3.5−2.4)/(1*5.7−2.4) omitting the β multiplication by 1.0 yields (3.5−2.4)/(1*5.7−2.4)=(1.1)/(3.3)=0.333.

If the number Patient Office Visits in Last 12 Months for the batch of Patient claims for the batch of claims currently being reviewed is “17.5” then the calculated g[vₖ] for that variable for the current claim is: (17.5−2.4)/(5.7−2.4)=(15.1)/(3.3)=4.58. Note that if 4.0, or greater, is considered the threshold value for classification as an outlier, the value in the first example, 0.333 (Representing the “Median number Patient Office Visits in Last 12 Months” for the batch of Patient Claims currently being reviewed) would not be considered an outlier. However, the second example of 4.58 (Representing the “Median number Patient Office Visits in Last 12 Months” for the batch of Patient Claims currently being reviewed) would be considered an outlier, and likely fraud or abuse.

The H-Value Sigmoid Transformation Module 215 converts the G-Value non-parametric normalized variables into estimates of the likelihood of being an outlier. This is done because the G-Value non-parametric normalized variables have some undesirable properties in a scoring model when used as they are in standard form. The G-Values are centered on zero, for example, so their positive and negative additive properties have the effect of canceling each other. This canceling effect makes them undesirable, as they exist in raw form, to their use in multiple variable models. If, in a 5 variable fraud outlier scoring model, as an example, one variable has a value of 8 and the other four variables have a value of −2, their sum is zero. Weighting each variable value by the highest negatively signed number, such as adding +2, to each variable's value, is not an adequate solution because the results are not directly comparable between individual observations in the data. For example, if, in the prior illustration, each variable was given a weight of +2, then the result would be a total of “10”. However, it is not clear if that observation is better or worse than another observation with three variables with values of +4, +3, +3 and two others with a “0” standard score. The sum for this observation is a total of “10” as well. Also, the result is not comparable across observations and it does not monotonically rank the relative risk of all the observations. This deficiency makes it more difficult to manage the score and evaluate its performance.

It is important to have a single measure of likelihood or probability of observing a large but legitimate value for each variable that will be a part of the scoring model. Therefore, the H-Sigmoid Transformation Module 215 converts the G-Values in G-Value Non-Parametric Standardization Module 214 to a sigmoid-shaped distribution that approximates a traditional cumulative density function (CDF) according to the following formula:

H[g[v]≦g]=1/(1+e^{-λ·g}); −∞<g[v]<∞, 0<H<1.

where e is the mathematical constant “e”, Euler's number, and it is the base of natural logarithms. Lambda, λ, is a scaling coefficient that equates the Q3 value (50% of the H-distribution above the median) to g[v]=1. Thus:

0.75=1/(1+e^{-λ})

λ=−Ln [1/3]=Ln [3]≈1.1

where Ln is the natural logarithm

And so the H-transform of g[v] becomes for each variable:

H[g[vk]≦g]=1/(1+e^{-Ln [3]·g})=1/(1+e^{-1.1·g})

This H-Value provides a probability estimate that the raw data value for this observation is an outlier. All variables and their corresponding H-Values are then sent from the H-Value Sigmoid Transformation Module 215 to the Sum-H Score Calculation Module 216. At this point there is a collection of n-different H-Value structures for each of the “n” variables in the fraud detection score model. Each variable measures a different characteristic of the individual claim, or batch of claims, and the Provider and the Patient. These variable values, H-Values, that are probability estimates of being an outlier, can then be aggregated into a single value, _{Σ}H or Sum-H. The Sum-H, which was developed for this patent, uses an appropriate φ power (as an example, in the range −1≦φ≦4) plus the appropriate δ power increment (as an example, in the range 1≦δ≦4). Note that neither φ nor δ need to be integers. For k observations of H-Values the Sum-H is found from:

Sum-H→_{Σ}H_{φ,δ}=Sum-H[H]=(Σ_{t=1,k}wₜHₜ^{φ+δ})/(Σ_{t=1,k}wₜHₜ^{φ});

0≦H≦1, −∞<φ<∞, 0<δ

where Sum-H is the probability estimate of the normalized score variable value, wₜ is the weight for variable Hₜ (which is “1” if not designated otherwise), φ is the power of this versatile Sum-H function, and δ is a power increment, which for this study initially is set at 1. In this application all the w weights, wₜ, are also initially set at 1, although as the model is implemented and tested they can be adjusted to enhance the model's discriminating ability based on the perceived importance of the variables. The selected powers φ and increment δ determine the type of emphasis for the probability values calculated for the data and the area of focus in the associated distribution, as follows.
>>φ->−∞ provides a data minimum emphasis
>>φ->1 provides a higher-power value with more emphasis on higher-valued outliers
>>φ->∞ provides a data maximum emphasis
where φ can be any real value. This φ function provides the analyst the ability to tune the _{Σ}H computation as desired; in particular, this focusing ability provided by φ ensures that the formula can be used to concentrate on the type of outlier of concern, which in this invention is the high outlier. This Sum-H function is used to obtain one value, a score, which represents an estimate of the overall risk that the current observation contains at least one variable that is an outlier. If the computed _{Σ}H, the score, is more than the limiting boundary value for determining if there are an unacceptable number or threshold value of outliers, the observation is considered an outlier and flagged for further review as a possible fraud or abuse.

Geometrically this _{Σ}H can be viewed as the ratio of the lengths of two vectors in a k-dimensional coordinate system, each vector proceeding from the origin to the point defined in k-space by the sum of the powers (φ, φ+δ) of the individual H-Values. As an example assume that φ=1.5 and δ=1, and we have a set of “k” individual H-Value variable probabilities (Pseudo-probability that the individual variable is an outlier). As a possible strategy for analyzing such a set of scores we look at both the summary, Sum-H (_{Σ}H) value and the largest individual H-Value among the k variable individual outlier probabilities. Below are some possibilities for these two values and what they might imply about the set of scores.
1. If both _{Σ}H and Hₘₐₓ are relatively small (perhaps <0.8) it can be assumed that there is an apparently valid set of scores.
2. If _{Σ}H is small but Hₘₐₓ is large (perhaps >0.94) it can be assumed that there are one or more outliers.
3. If is relatively large (perhaps >0.98) it can be assumed that many of the variables in the model are outliers.

The individual _{Σ}H score value and the individual H-Values corresponding to each variable are then sent from the H-Sigmoid Transformation Module 216 to the Score Reason Generator Module 217 to calculate score reasons for why an observation score as it did. The Score Reason Generator Module 217 is used to explain the most important variables that cause the score to be highest for an individual observation. It selects the variable with the highest H-Value and lists that variable as the number 1 reason why the observation scored high. It then selects the variable with the next highest H-Value and lists that variable as the number 2 reason why the observation scored high, and so on.

One copy of the scored observations is sent from the Score Reason Generator Module 217 to the Score Performance Evaluation Module 218. In the Score Performance Module, the scored distributions and individual observations are examined to verify that the model performs as expected. Observations are ranked, by score, and individual claims are examined to ensure that the reasons for scoring match the information on the claim, provider or patient. The Score Performance Evaluation Module details how to improve the performance of the fraud detection score model given future experience with scored transactions and actual performance on those transactions with regard to fraud and not fraud. This process uses the Bayesian posterior probability results of the model for the H-Values of the model variables and H_{Σ} are

p[V|H]=p[valid claim|acceptable-H-Value]

p[V′|H]=1−p[V|H]

p[V|H′]=p[valid-claim|unacceptable-H-Value]

p[V′|H′]=1−p[V|H]

To determine their values we need the prior conditional and marginal probabilities

p[H|V] p[H|V′] p[H]

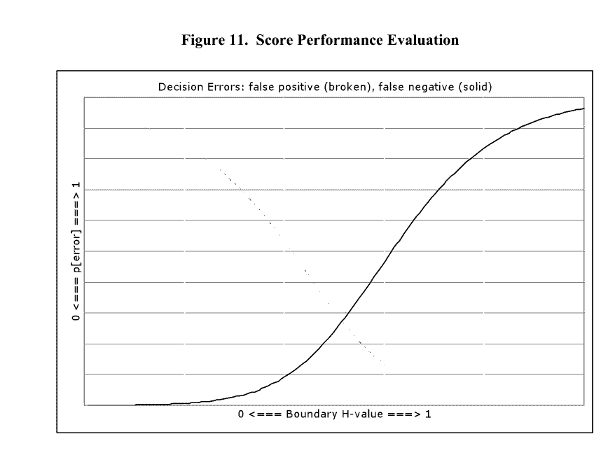

These last two conditionals are represented by distributions obtained from the Feedback Loop of actual claim outcomes, one for the valid claims and one for the invalid claims, and p[V] is a single value for the current version of the Feedback Loop. These values can be determined directly from summarizing the data obtained from actual results, based on the valid/invalid determinations. The results would be presented in the form of two relationships as shown in FIG. 11—the probability of misclassifying a valid claim (broken line→false-positive) and the probability of misclassifying an invalid claim (solid line→false-negative), based on the selected critical H_{critical} value. The decision rule assumes that a claim is valid unless indicated to be invalid and is stated as “Assume claim valid, then if H>H-boundary assign as invalid”.

For clarification, if one of the vertical lines depicts H_{critical}, then the height of the solid-curve intersecting that line is the probability of a false-negative (assuming valid claim is invalid) and the height of the broken-line curve intersecting that same line is the probability of a false-positive (assuming invalid claim is valid). Note these two errors are equal in magnitude where the curves intersect. Clearly as H_{critical} moves horizontally to reduce one type-error the other value increases appropriately. Here then is the value of the weighted Sum-H, when we compute H_{Σ}, since we can vary the individual weights of the “n” performance variable's H values to attempt to tune the model to a more desirable decision-error profile.

The data is then sent from the Score Performance Evaluation Module 218 to be stored in the Future Score Development Module 219. This module stores the data and the actual claim outcomes, whether it turned out to be a fraud or not a fraud. This information can be used in the future to build a new fraud model to enhance fraud detection capabilities.

Another copy of the claim is sent from the Score Reason Generator Module 217 to the Data Security Module 220 for encryption. From the Data Security Module 220 the data is sent to the Application Programming Interface Module 221 to be formatted. From the Application Programming Interface Module 221 the data is sent to the Workflow Case Management Module 222. Workflow Case Management Module 222 provides Workflow Decision Strategy Management, Fraud Risk Management which includes Queue and Case Management, Experimental Design Test and Control, Contact and Treatment Management Optimization, Graphical User Interface (GUI) Workstation and Workstation Reporting Dashboard for Measurements and Reporting for efficiently interacting with constituents (providers and patients/beneficiaries) through multiple touch points such as phone, web, email and mail. It also provides the capability to test different treatments or actions randomly on populations within the healthcare value chain to assess the difference between fraud detection models, treatments or actions, as well as provide the ability to measure ROI on experimental design. The claims are organized in tables and displayed for review by fraud analysts on the Graphical User Interface in Module 223. Using the GUI, the claim payer fraud analysts determine the appropriate actions to be taken to resolve the potential fraudulent request for payment. After the final action and when the claim is determined to be fraudulent or not fraudulent, a copy of the claim is sent to the Feedback Loop Module 224. The Feedback Loop Module 224 provides the actual outcome information on the final disposition of the claim, provider or patient as fraud or not fraud, back to the original raw data record. The actual outcome either reinforces the original fraud score probability estimate that the claim was fraud or not fraud or it countermands the original estimate and proves it to have been wrong. In either case, this information is used for future fraud detection score model development to enhance the performance of the score model. From the Feedback Loop Module 224 the data is stored in the Future Score Model Development Module 219 for use in future score model developments using model development procedures, which may include supervised, if there is a known outcome for the dependent variable or there exists an appropriate unbiased sample size. Otherwise, part or all of the fraud detection models may be developed utilizing an unsupervised model development method.

The advantages of the present invention include, without limitation:

1. The present invention avoids the rigorous assumptions of parametric statistics and its score is not distorted by the very existence of the objects it is trying to detect, namely outliers. It uses a special adaptation of nonparametric statistics to convert raw data variable values into normalized values that are then converted to probability estimates of the likelihood of being an outlier. These outlier probability estimates, which are directly comparable to one another and rank risk in an orderly monotonic fashion, are then used as variables in the Fraud detection outlier model. The non-parametric statistical tool developed for this patent, the “Modified Outlier Detection Technique”, is a robust statistical method, which avoids the restrictive and limiting assumptions of parametric statistics. This non-parametric statistical technique is not distorted by outliers and asymmetric non-normal distributions and is therefore robust, stable, accurate and reliable detector of outliers, and ultimately fraud or abuse. The “Modified Outlier Technique” calculates, for the “High-Side” or risky side of the data distribution, the difference between the Median and the third quartile, (75^{th} percentile) as the measure of dispersion to normalize the outlier calculation by using the formula (distance between an observation's value and the Median) divided by (the difference between the 75^{th} percentile and the Median) in order to limit inaccuracies introduced by broader dispersion measures such as the inter-quartile range and the standard deviation. Since the major objective of the present invention is to identify outliers, achieve a high detection rate, avoid an abundance of false-positives and not tolerate excessive false-negatives, the issue of skew-distortion must not be “assumed away” whether parametric or non-parametric statistical methods are used. Both the Z-Score and Tukey's Quartile methods are unpredictable as to their validity for diverse, non-normal, outlier ridden data.
The present invention addresses this problem by development of a “Modified Outlier Detection Technique”. The Modified Outlier Detection Technique calculates a value for each variable in the score that is the normalized distance from the median of the distribution to the 75^{th} percentile, instead of the IQR. This enhancement of the IQR method is termed the “Modified Outlier Detection Technique”.
2. This patent specifies the procedure for the conversion of the normalized variables created as part of this patent, the G-Values, into a cumulative density function (CDF) type format, labeled “H-Values”. To accomplish this transformation, the G-Values are converted into a CDF format via the H-transform, where λ provides the scaling that matches the empirical data for that variable to the distribution (i.e., g=1 equates to Q3 of H). In essence then the scaled H is an estimate of the unknown CDF for that individual variable, and so represents a conservative, relative probability estimate of the outlier-state of that variable. These H-Value relative probabilities can be examined and interpreted individually, and also can be combined in weighted format into a single summary Sum-H “Total Score” value.
3. The use of an overall probability that any of the variable's “H-Values” in the model is an outlier. This one summary value, termed “Sum-H” is the “Score”. The present invention calculates, scores and stores claim, provider and patient characteristics using this one summary variable, Sum-H, for each claim, each provider and each patient. Each of these scores is a probability estimate derived from the weighted H-Value, and is expressed as the probability that any one of the individual variables for each observation is an outlier, or likely fraud or abuse. The present invention uses this overall risk that of any of the score model variables has a high probability being an outlier to rank claims, providers and patients from highest risk score to lowest risk score in order to enable claims payers to process and review potential fraudulent and abusive transactions systematically, efficiently and effectively. The Overall Total Score can be used for comparisons of model performance and individual observations score across specialty types, industry types and geographies. The single number, which is an overall estimate of the likelihood that any one or more of the variables are outliers, expressed as a fraud detection score. This fraud detection score monotonically ranks fraud risk. This ranking enables claims to be reviewed based on their overall fraud risk in order of importance so business analyst resources can be allocated most effectively.
4. The calculation of reason codes that reflect why the observation scored high based on the individual “H-Values”. The variable associated with the highest H-Value is the number one reason and the variable with the second highest H-Value is the number 2 reason and so on. The Score Reason calculated based on the variables in the score, is one component of the score validation system. These Score Reasons are based on the probability of the individual variable being an outlier and they alert the review process as to the reason why a claim was “tagged” as a potentially risky “outlier”, and likely fraud or abuse. This Score Reason process enables the fraud detection score to be validated and its performance to be more easily monitored.
5. The use of historical observed or published data to calculate prior conditional probabilities of the likelihood of a particular procedure co-occurring given a specific diagnosis, termed the Sum-H, to represent that overall risk with one number.
6. These flagged confirmed fraud accounts are periodically used as feedback, created through the feedback loop, into new models to enhance both the predictability of the model. Flagged accounts that are either fraud or not fraud can also be used in future fraud detection models to enhance fraud detection performance.

In broad embodiment, the present invention is a method of creating variables that describe the behavior of healthcare providers and the claims they submit for re-imbursement to healthcare payers and of healthcare patients. These variables are then combined into a scoring model to predict the likelihood of unusual patterns of behavior by healthcare providers, claims and patients and explain why that behavior is unusual. Once the variables are created they are combined into one number, a score, which summarizes the characteristics of the claim submitted by a healthcare provider. The score values range from zero to one with higher values indicating higher risk and lower values indicating lower risk of being a “negative” outlier, or potential fraud or abuse. Therefore, the highest score values are likely to be high probability of fraud, abuse or over-servicing by the individual claim, healthcare provider or patient that is currently being evaluated. By examining the individual variables that make up the score components, the system is able to give reasons why this particular transaction or healthcare provider or patient had a high score. These reasons help the healthcare payer to focus review efforts on the claims, providers or patients and individual characteristics that contribute to the unusual behavior patterns.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below (e.g. claim 3 may be taken as alternatively dependent from claim 2; claim 4 may be taken as alternatively dependent on claim 2, or on claim 3; claim 6 may be taken as alternatively dependent from claim 5; etc.).

This completes the description of the preferred and alternate embodiments of the invention. Those skilled in the art may recognize other equivalents to the specific embodiment described herein which equivalents are intended to be encompassed by the claims attached hereto.

What is claimed is:

1. A computer implemented method for encrypted transmission of historical healthcare claim data using an application programming interface between two or more computer systems and for utilizing said historical healthcare claim data to improve fraud or abuse or waste or over-utilization detection in the healthcare industry utilizing a modified outlier non-parametric detection technique that limits inaccuracies of inter-quartile range and standard deviation techniques, the computer implemented method comprising:
receiving, at a historical healthcare claim data module, the historical healthcare claim data;
transforming, at the historical healthcare claim data module, the historical healthcare claim data into a secret code by use of an encryption algorithm;
sending the transformed historical healthcare claim data to the application programming interface;
standardizing at the application programming interface, the transformed historical healthcare claim data;
sending the transformed and standardized historical healthcare claim data to a historical summary statistics data security module for unencrypting;
sending copies of transformed and standardized historical healthcare claim data to a historical procedure diagnostic module, a claim summary statistics module, a historical provider statistics module, a historical patient statistics module;
receiving, at the historical procedure diagnostic module, a first median of a medical procedure cost and a first vigintile above the first median based on a medical industry type, a medical specialty, and a geography;
receiving, at the claim summary statistics module, a second median of procedures per one claim and a second vigintile above the second median, based on the medical industry type, the medical specialty, and the geography;
receiving, at the historical provider statistics module, a third median of a fee per the one claim and a third vigintile above the third median, based on the medical industry type, the medical specialty, and the geography;
receiving, at the historical patient statistics module, a fourth median of patients office visits and a fourth vigintile above the fourth median based on the medical industry type, the medical specialty, and the geography;
receiving, from a user, a first current variable of the procedure cost;
receiving, from the user, a second current variable of the procedures per the one claim;
receiving, from the user, a third current variable of the fee per the one claim;
receiving, from the user a fourth current variable of the patient office visits;
calculating, by a non-parametric standardization module executed by one or more processors and using the modified outlier non-parametric technique, one sided distribution statistic of raw outlier estimates for each of the first, the second, the third and the fourth variables by dividing:
a first difference between the first, the second, the third and the fourth current variables and their corresponding the first, the second, the third, the fourth medians, to
a second difference between the first, the second, the third and the fourth vigintiles and their corresponding the first, the second, the third, the fourth medians;
converting, by sigmoid transformation module executed by the one or more processors, the raw outlier estimates for each of the first, the second, the third and the fourth variables to probability estimates for each of the first, the second, the third and the fourth variables by approximating an Euler based cumulative density function;
weighting and power incrementing the probability estimates for each of the first, the second, the third and the fourth variables according to a predetermined level of importance for each of the first, the second, the third and the fourth variables;
summing the weighted and power incremented probability estimates of the first, the second, the third and the fourth variables to calculate a summed score;
comparing the summed score to a boundary value, and when the summed score is more than the boundary value, flagging the claim as fraud or abuse or waste or over-utilization,
improving, via a score performance evaluation module executed by the one or more processors and a feedback loop, fraud or abuse or waste or over-utilization detection by using Bayesian posterior probability results of the probability estimates for each of the first, the second, the third and the fourth variables, wherein the Bayesian posterior probability results were further derived from prior conditional and marginal probabilities, and
sending the flagged claim to a workflow decision strategy management device which utilizes a graphical user interface to present an investigator with the flagged claim, prioritized by the summed score and a largest dollar amount.

2. The computer implemented method of claim 1 further including the step of inputting a claim to the score performance evaluation module in real-time.

3. The computer implemented method of claim 2 wherein the score performance evaluation module is run on a server connected to the internet, and the claim is transmitted to the server electronically.

4. The computer implemented method of claim 1 including the step of inputting a batch of claims to the score performance evaluation module.

5. The computer implemented method of claim 4 wherein the score performance evaluation module is run on a server, and the batch of claims are transmitted to the server.

6. The computer implemented method of claim 1 further including the step of optimizing the score performance evaluation module periodically, to determine a set of variables for the. first, second, third and fourth variables.

7. The computer implemented method of claim 6 wherein the step of optimizing may use principal components analysis or other correlation analysis to determine which variables are highly correlated to one another;
further including the step of building new uncorrelated dimensions, referred to as factors, and
selecting at least one variable from each factor for inclusion in the score performance evaluation module.

8. The computer implemented method of claim 1 wherein the formula for dividing the first differences by the second differences is:
G-Value→g=(vₖ−Medᵥ)/(2*(β·Q3ᵥ−Medᵥ))
and further wherein the formula calculates a one sided distribution statistic of raw outlier estimates, and further wherein “g” is the calculated value for vₖ which is the “kth” observation of data variable “v”, such as variables for the dollar amount of a claim or the number of claims, Medᵥ=Median value of all of the observations for the data variable “v”, β=A weight value, that are assigned to give more, or less, weight to the individual variable, and Q3ᵥ=The third quartile of variable v.

9. The computer implemented method of claim 8 wherein the formula, converting by sigmoid transformation, the raw outlier estimates into probability estimates by approximating an Euler based cumulative density function, and for weighting and power incrementing the probability estimates:
H-Value→H≦g]=1/(1+e^{-λ·g})
wherein e is Euler's constant, λ=Ln, where Ln=Natural logarithm, β is the value that determines the “width” of the distribution in the “g” formula.

10. The computer implemented method of claim 1 wherein the formula for calculating the summed score is:
Sum-H→_{Σ}H_{φ,δ}=/
wherein Hₜ is one of the score model “H-Values”, ωₜ is the weight for variable Hₜ, Phi, φ, and Delta, δ, are power values of Hₜ.

11. The computer implemented method of claim 9 further including the step of determining reason codes which reflect why an observation scored high based on individual H-Values.

12. The computer implemented method of claim 9 further including the step of:
calculating reason codes that reflect why an observation scored high based on individual H-Values.

13. The computer implemented method of claim 1, wherein the score performance evaluation module corrects for a dispersion and Interquartile Range inaccuracies resulting from non-normal, skewed and bimodal distributions and a presence of outliers in the underlying data.

14. The computer implemented method of claim 9, wherein the summed score of the one claim receives is used to determine whether the one claim is paid, declined or researched.

15. The computer implemented method of claim 14, wherein the claim is captured from a provider at a pre-adjudication stage.

16. The computer implemented method of claim 14, wherein the claim is captured from a provider at a post-adjudication stage.

17. The computer implemented method of claim 1 including a step of using a procedure probability table to determine a probability from the probability estimates that a particular procedure is not occurring, given a predetermined diagnosis code.

18. The computer implemented method of claim 1 wherein the score performance evaluation module includes a plurality of empirically derived and statistically valid model scores generated by multi-dimensional statistical algorithms and probabilistic predictive models that identify the providers, the healthcare merchants, the beneficiaries or the claims as potentially fraud, abuse, waste or overutilization.

19. The computer implemented method of claim 18 wherein the workflow decision strategy management device systematically receives records from the score performance evaluation module and routes the healthcare merchants, the claims and the beneficiaries to investigators for review based upon their probability score.

20. The computer implemented method of claim 19 wherein real-time triggers are used to activate intelligence capabilities, combined with predictive scoring models, provider cost and waste indexes, to take action on the providers, the healthcare merchants, the claims and the beneficiaries when predefined risk score thresholds are exceeded for suspect payments or providers.

21. The computer implemented method of claim 9 wherein the summed score provides a probability estimate that any variable in the data is an outlier and wherein the summed score ranks the likelihood that any individual observation is an outlier, and likely fraud or abuse or waste or overutilization, and further wherein the reason codes explain why the observation scored high based on the individual “H-Values”.

22. The computer implemented method of claim 1 wherein the feedback loop dynamically “feeds back” outcomes of each record or transaction that is investigated, and wherein the feedback loop provides the actual outcome information on the final disposition of the claim, the provider, the-patient, or the healthcare merchant as fraud or not fraud, back to an original raw data record.

23. A system for encrypted transmission of historical healthcare claim data using an application programming interface between two or more computer systems and for utilizing said historical healthcare claim data to improve fraud or abuse or waste or over-utilization detection in the healthcare industry utilizing a modified outlier non-parametric detection technique that limits inaccuracies of inter-quartile range and standard deviation techniques, the system comprising:
a historical healthcare claim data module for receiving the historical healthcare claim data;
the historical healthcare claim data module transforming the historical healthcare claim data into a secret code by use of an encryption algorithm;
the transformed historical healthcare claim data being sent to the application programming interface;
the application programming interface transforming the transformed historical healthcare claim data;
the transformed and standardized historical healthcare claim data being sent to a historical summary statistics data security module for unencrypting;
copies of the transformed and standardized historical healthcare claim data being sent to a historical procedure diagnostic module, a claim summary statistics module, a historical provider statistics module, a historical patient statistics module;
the historical procedure diagnostic module executed by one or more processors to receive a first median of a medical procedure cost and a first vigintile above the first median based on a medical industry type, a medical specialty, and a geography;
the claim summary statistics module executed by the one or more processors to receive a second median of procedures per one claim and a second vigintile above the second median, based on the medical industry type, the medical specialty, and the geography;
the historical provider statistics module executed by the one or more processors to receive a third median of a fee per the one claim and a third vigintile above the third median, based on the medical industry type, the medical specialty, and the geography;
the historical patient statistics module executed by the one or more processors to receive a fourth median of patients office visits and a fourth vigintile above the fourth median based on the medical industry type, the medical specialty, and the geography;
the historical procedure diagnostic module also receiving a first current variable of the procedure cost from a user;
the claim summary statistics module also receiving a second current variable of the procedures per the one claim from the user;
the historical provider statistics module also receiving a third current variable of the fee per the one claim from the user;
the historical patient statistics module also receiving a fourth current variable of the patient office visits from the user;
a non-parametric standardization module executed by the one or more processors to calculate using the modified outlier non-parametric technique, one sided distribution statistic of raw outlier estimates for each of the first, the second, the third and the fourth variables by dividing:
a first difference between the first, the second, the third and the fourth current variables and their corresponding the first, the second, the third, the fourth medians, to
a second difference between the first, the second, the third and the fourth vigintiles and their corresponding the first, the second, the third, the fourth medians;
a sigmoid transformation module executed by the one or more processors to convert the raw outlier estimates for each of the first, the second, the third and the fourth variables to probability estimates for each of the first, the second, the third and the fourth variables by approximating an Euler based cumulative density function;
further weighting and power incrementing the probability estimates for each of the first, the second, the third and the fourth variables according to a predetermined level of importance for each of the first, the second, the third and the fourth variables;
further summing the weighted and power incremented probability estimates of the first, the second, the third and the fourth variables to calculate a summed score;
further comparing the summed score to a boundary value, and when the summed score is more than the boundary value, flagging the claim as fraud or abuse or waste or over-utilization, and
a score performance evaluation module executed by the one or more processors and a feedback loop to improve via, fraud or abuse or waste or over-utilization detection by using Bayesian posterior probability results of the probability estimates for each of the first, the second, the third and the fourth variables, wherein the Bayesian posterior probability results were further derived from prior conditional and marginal probabilities, and
sending the flagged claim to a workflow decision strategy management device which utilizes a graphical user interface to present an investigator with the flagged claim, prioritized by the summed score and a largest dollar amount.

24. The system of claim 23 wherein the formula for dividing the first differences by the second differences is:
G-Value→g=(vₖ−Medᵥ)/(2*(β·Q3ᵥ−Medᵥ))
and further wherein the formula calculates a one sided distribution statistic of raw outlier estimates, and wherein the formula, and further wherein “g” is the calculated value for vₖ which is the “kth” observation of data variable “v”, Medᵥ=Median value of all of the observations for the data variable “v”, β=A weight value, that are assigned to give more, or less, weight to the individual variable, and Q3ᵥ=The third quartile of variable v.

25. The system of claim 23 wherein the formula for, converting by sigmoid transformation, the raw outlier estimates into probability estimates by approximating an Euler based cumulative density function, and weighting and power incrementing is:
H-Value→H≦g]=1/(1+e^{-λ·g})
wherein e is Euler's constant, λ=Ln, where Ln=Natural logarithm, β is the value that determines the “width” of the distribution in the “g” formula.

26. The system of claim 23 wherein the formula for calculating the summed score is:
Sum-H→_{Σ}H_{φ,δ}=/
wherein Hₜ is one of the score model “H-Values”, ωₜ is the weight for variable Hₜ, Phi, φ, and Delta, δ, are power values of Hₜ.

27. The system of claim 23 further including the step of inputting a claim to the score performance evaluation module in real-time.

28. The system of claim 27 wherein the score performance evaluation module is run on a server electronically, and the claim is transmitted to the server electronically.

29. The system of claim 23 including the step of inputting a batch of claims to the score performance evaluation module.

30. The system of claim 29 wherein the score performance evaluation module is run on a server, and the batch of claims are transmitted electronically to the server.

31. The system of claim 23 further including the step of optimizing the score performance evaluation module periodically, to determine a set of variables.

32. The system of claim 30 wherein the step of optimizing uses principal components analysis or other correlation analysis to determine which variables are highly correlated to one another;
further including the step of building new uncorrelated dimensions, referred to as factors, and
selecting at least one variable from each factor for inclusion in the score performance evaluation module.

33. The system of claim 25 further including the step of determining reason codes which reflect why an observation scored high based on individual H-Values.

34. The system of claim 25 further including the step of:
calculating reason codes that reflect why an observation scored high based on individual H-Values.

35. The system of claim 23, wherein the score performance evaluation module corrects for a dispersion and Interquartile Range inaccuracies resulting from non-normal, skewed and bimodal distributions and a presence of outliers in the underlying data.

36. The system of claim 27, wherein the summed score of the one claim receives is used to determine whether the one claim is paid, declined or researched.

37. The system of claim 36, wherein the claim is captured from a provider at a pre-adjudication stage.

38. The system of claim 36, wherein the claim is captured from a provider at a post-adjudication stage.

39. The system of claim 23 further including a step of using a procedure probability table to determine a probability from the probability estimates that a particular procedure is not occurring, given a predetermined diagnosis code.

40. A non-transitory computer readable storage medium for encrypted transmission of historical healthcare claim data using an application programming interface between two or more computer systems and for utilizing said historical healthcare claim data to improve fraud or abuse or waste or over-utilization detection in the healthcare industry utilizing a modified outlier non-parametric detection technique that limits inaccuracies of inter-quartile range and standard deviation techniques, on which is recorded computer executable instructions that, when executed by one or more processors, cause the one or more processors to execute the steps of a method comprising:
receiving, at a historical healthcare claim data module, the historical healthcare claim data;
transforming, at the historical healthcare claim data module, the historical healthcare claim data into a secret code by use of an encryption algorithm;
sending the transformed historical healthcare claim data to the application programming interface;
standardizing at the application programming interface, the transformed historical healthcare claim data;
sending the transformed and standardized historical healthcare claim data to a historical summary statistics data security module for unencrypting;
sending copies of transformed and standardized historical healthcare claim data to a historical procedure diagnostic module, a claim summary statistics module, a historical provider statistics module, a historical patient statistics module;
receiving, at the historical procedure diagnostic module, a first median of a medical procedure cost and a first vigintile above the first median based on a medical industry type, a medical specialty, and a geography;
receiving, at the claim summary statistics module, a second median of procedures per one claim and a second vigintile above the second median, based on the medical industry type, the medical specialty, and the geography;
receiving, at the historical provider statistics module, a third median of a fee per the one claim and a third vigintile above the third median, based on the medical industry type, the medical specialty, and the geography;
receiving, at the historical patient statistics module, a fourth median of patients office visits and a fourth vigintile above the fourth median based on the medical industry type, the medical specialty, and the geography;
receiving, from a user, a first current variable of the procedure cost;
receiving, from the user, a second current variable of the procedures per the one claim;
receiving, from the user, a third current variable of the fee per the one claim;
receiving, from the user a fourth current variable of the patient office visits;
calculating, by a non-parametric standardization module executed by one or more processors and using the modified outlier non-parametric technique, one sided distribution statistic of raw outlier estimates for each of the first, the second, the third and the fourth variables by dividing:
a first difference between the first, the second, the third and the fourth current variables and their corresponding the first, the second, the third, the fourth medians, to
a second difference between the first, the second, the third and the fourth vigintiles and their corresponding the first, the second, the third, the fourth medians;
converting, by sigmoid transformation module executed by the one or more processors, the raw outlier estimates for each of the first, the second, the third and the fourth variables to probability estimates for each of the first, the second, the third and the fourth variables by approximating an Euler based cumulative density function;
weighting and power incrementing the probability estimates for each of the first, the second, the third and the fourth variables according to a predetermined level of importance for each of the first, the second, the third and the fourth variables;
summing the weighted and power incremented probability estimates of the first, the second, the third and the fourth variables to calculate a summed score;
comparing the summed score to a boundary value, and when the summed score is more than the boundary value, flagging the claim as fraud or abuse or waste or over-utilization, and
improving, via a score performance evaluation module executed by the one or more processors and a feedback loop, fraud, abuse or waste or over-utilization detection by using Bayesian posterior probability results of the probability estimates for each of the first, the second, the third and the fourth variables, wherein the Bayesian posterior probability results were further derived from prior conditional and marginal probabilities, and
sending the flagged claim to a workflow decision strategy management device which utilizes a graphical user interface to present an investigator with the flagged claim, prioritized by the summed score and a largest dollar amount.

41. A method of detecting outliers for detecting fraud, abuse or waste/over-utilization in the healthcare industry, the method comprising:
a) inputting historical claims data;
b) developing scoring variables from the historical claims data;
c) developing claim, provider and patient statistical behavior patterns by specialty group, provider geography and patient geography and demographics based on the historical healthcare claims data and other external data sources and external scores, and/or link analysis;
d) inputting at least one claim, or components of the claim, for scoring;
e) combining the scoring variables into a fraud, abuse or waste/over-utilization detection scoring model by calculating G-Values, H-Values and Sum-H Values;
f) determining a score for the at least one claim, using the fraud, abuse or waste/over-utilization detection scoring model which determines the likelihood that the at least one claim constitutes a fraud, waste or abuse risk.

42. A method of detecting outliers for detecting fraud, abuse or waste/over-utilization in the health care industry, on a large set of data, consisting of n-observations and k-variables, the method comprising:
gathering historical claims data;
computing the median and percentiles (Q3 third quartile, or some other percentile greater than the 50th) for the n-observations for each of the k-variables using the historical claims;
processing a transaction in order to score it;
standardizing the raw data variable values using non-parametric measures such as the median and 75^{th} percentile;
centering and scaling the data values using non-parametric, ordinal measures (median, and percentiles) rather than parametric, interval measures (mean, standard deviation), using the formula:
g=(vk−Medv)/(2*β·Q3v−Medv)
where Q3v−Medv represents 25% of the distribution (75th percentile minus the 50th percentile), Beta, β, is a constant that allows the expansion or contraction of the g equation denominator to reflect estimates of the criticality of the performance of any variable, variable v;
converting these g values into an individual Cumulative Density Function (CDF) sigmoid format H-value for each variable using the formula:
H≦g]=1/(1+e^{-λ·g})
where e is the mathematical constant e, the base of natural logarithms, and λ is a scaling coefficient that equates the Q3 value (50% of the H-distribution above the median) to g=1;
combining these k number of variable H-values into a single score per observation to obtain the score value, ΣH:
ΣH_{φ,δ}=/
where ΣH is the summary probability estimate of all of the standardized score variable probability estimates, ωt is the weight for variable Ht, φ is a power value of Ht, and δ is a power increment, and
calculating score reasons by determining the individual variables that have the largest H value, ranked from highest absolute value to lowest absolute value.
